(19) United States
(12) Patent Application Publication
(10) Pub. No.: US 2026/0326574 A1
(43) Pub. Date: Oct. 22, 2026

(54) ENERGY SYSTEMS FOR SUPPLYING POWER TO PRIMARY AND AUXILIARY LOADS

(71) Applicants: Saleh ZIAIEINEJAD, Foothill Ranch, CA (US); Mikhail SLEPCHENKOV, Foothill Ranch, CA (US); Roozbeh NADERI, Foothill Ranch, CA (US); TAE Technologies, Inc., Foothill Ranch, CA (US)

(72) Inventors: Saleh ZIAIEINEJAD, Foothill Ranch, CA (US); Mikhail SLEPCHENKOV, Foothill Ranch, CA (US); Roozbeh NADERI, Foothill Ranch, CA (US)

(21) Appl. No.: 19/491,485

(22) PCT Filed: Jun. 7, 2024
(86) PCT No.: PCT/US2024/032924

§ 371 Date: Dec. 9, 2025

Related U.S. Application Data
(60) Provisional application No. 63/472,215, filed on Jun. 9, 2023.

(51) Int. Cl. B60L 15/00; H02J 7/50

(52) U.S. Cl. CPC B60L 15/007; H02J 7/575; B60L 2210/10; B60L 2210/30; H02J 2207/20

(57) ABSTRACT

Example embodiments of systems, devices, and methods are provided herein for energy systems configured to provide power to AC and DC loads. The system can include multiple array segments configured to output AC signals for powering the AC loads and a supplemental signal conversion device configured to convert the AC signals to DC signals for powering the DC loads.

### CROSS-REFERENCE TO RELATED APPLICATIONS

This application is an International Application which claims priority to U.S. Provisional Patent Application No. 63/472,215, filed Jun. 9, 2023, which is hereby incorporated by reference herein in its entirety for all purposes.

### FIELD

The subject matter described herein relates generally to systems, devices, and methods that facilitate the interconnection and control of modules in module-based energy systems to provide power to primary and auxiliary loads.

### BACKGROUND

Energy systems having multiple energy sources or sinks are commonplace in many industries. One example is the automobile industry. Today's automotive technology, as evolved over the past century, is characterized, amongst many things, by an interplay of motors, mechanical elements, and electronics. These are the key components that impact vehicle performance and driver experience. Motors are of the combustion or electric type and in almost all cases the rotational energy from the motor is delivered via a set of highly sophisticated mechanical elements, such as clutches, transmissions, differentials, drive shafts, torque tubes, couplers, etc. These parts control to a large degree torque conversion and power distribution to the wheels and define the performance of the car and road handling.

An electric vehicle (EV) includes various electrical systems that are related to the drivetrain including, among others, the battery pack, the charger, and motor control. High-voltage battery packs are typically organized in a serial chain of lower voltage battery modules. Each such module further includes a set of serially connected individual cells and a simple embedded battery management system (BMS) to regulate basic cell related characteristics, such as state of charge and voltage. Electronics with more sophisticated capabilities or some form of smart interconnectedness are absent. As a consequence, any monitoring or control function is handled by a separate system, which, if at all present elsewhere in the car, lacks the ability to monitor individual cell health, state of charge, temperature, and other performance impacting metrics. There is also no ability to meaningfully adjust power draw per individual cell in any form. Some of the major consequences are: (1) the weakest cell constrains the overall performance of the entire battery pack, (2) failure of any cell or module may lead to a need for replacement of the entire pack and/or loss of operation of the EV until the cell or module is repaired or replaced, (3) battery reliability and safety are considerably reduced, (4) battery life is limited, (5) thermal management is difficult, (6) battery packs always operate below maximum capabilities, (7) sudden inrush of regenerative braking derived electric power cannot be readily stored in the batteries and requires dissipation via a dump resistor.

Charging circuits for EVs are typically realized in separate on-board systems. They stage power coming from outside the EV in the form of an AC signal or a DC signal, convert it to DC and feed it to the battery pack. Charging systems monitor voltage and current and typically supply a steady constant feed. Given the design of the battery packs and typical charging circuits, there is little ability to tailor charging flows to individual battery modules based on cell health, performance characteristics, temperature, etc. Charging cycles are also typically long as the charging systems and battery packs lack the circuitry to allow for pulsed charging or other techniques that would optimize the charge transfer or total charge achievable.

Conventional controls contain DC to DC conversion stages to adjust battery pack voltage levels to the bus voltage of the EV's electrical system. Motors, in turn, are then driven by simple two-level multiphase converters that provide the required AC signal(s) to the electric motor. Each motor is traditionally controlled by a separate controller, which drives the motor in a three-phase design. Dual motor EVs would require two controllers, while EVs using four motors would require four individual controllers. The conventional controller design also lacks the ability to drive next-generation motors, such as switch reluctance motors (SRM), characterized by higher numbers of pole pieces. Adaptation would require higher phase designs, making the systems more complex and ultimately fail to address electric noise and driving performance, such as high torque ripple and acoustic noise.

Many of these deficiencies apply not only to automobiles but other motor driven vehicles, and also to stationary applications to a significant extent. For these and other reasons, needs exist for improved systems, devices, and methods for energy systems for mobile and stationary applications.

### SUMMARY

Example embodiments of systems, devices, and methods are provided herein for module-based energy systems configured to provide power to primary and auxiliary loads. Each module can include an energy source and switch circuitry that selectively couples the energy source to other modules in the system for generating power or for receiving and storing power from a charge source. The energy systems can be arranged in single phase and multiphase topologies with multiple interconnected arrays.

The energy system can be arranged to provide multiphase power to primary AC loads, such as motors of EVs, and DC power to auxiliary loads, such as an on-board electrical network of an EV or an HVAC system of an EV. The energy system can include one or more arrays of modules for each phase and, when multiple arrays are used for each phase, the arrays for each phase can be coupled together at a common point. For example, each array can include a phase port and a neutral port across which the AC voltage signal is generated. The neutral port of each array for a phase can be coupled together and the phase ports can be coupled to one or more AC loads.

For one or more three-phase loads, the energy system can include three array segments, one for each phase. Each segment can include two or more arrays that are each configured to generate and output a single-phase AC signal having the same phase. The arrays in each segment can be coupled together at a common point. In some implementations, the common point can be the neutral ports of the arrays, while in some embodiments, the phase port of an array of a segment can be coupled to the neutral port of another array of the segment. In some implementations, an array can be divided into two sub-arrays and the two sub-arrays can be referred to as a segment. Each three-phase load can be coupled to a phase port of an array of each segment to receive three-phase power.

The energy system can also include a supplemental signal conversion device (SSCD) that is configured to provide power to auxiliary loads, e.g., auxiliary DC loads. The SSCD can be configured to receive an AC signal from the arrays of modules, convert the AC signal to a DC signal, and regulate the DC signal for the auxiliary loads.

The SSCD can also be configured to balance one or more operating characteristics of the modules of the arrays, the arrays themselves, and/or groups of arrays. For example, the SSCD can be controlled in various ways to selectively obtain power from arrays or groups of arrays for use in supplying the auxiliary loads to balance one or more operating characteristics of the modules, arrays, and/or groups.

In a particular example, an EV can include one or more primary AC motor loads and one or more auxiliary DC loads. The EV can also include an energy system that includes a segment of arrays for each phase of the AC motors and an SSCD configured to receive power from the segments of arrays and generate and provide DC power to the auxiliary loads.

The segments of arrays can be arranged in a module pack such that the pack is readily connectable to different arrangements of loads. For example, the module pack can be configured such that it is readily connectable to a motor of a single-motor EV or to both motors of a two-motor EV without modifying the module pack, or with minimal modification. This simplifies the manufacturing of the module pack and the overall energy system, while also enabling module packs to be swapped between different EVs and/or different types of EVs.

Other systems, devices, methods, features and advantages of the subject matter described herein will be apparent to one with skill in the art upon examination of the following figures and detailed description. It is intended that all such additional systems, methods, features and advantages be included within this description, and be within the scope of the subject matter described herein. In no way should the features of the example embodiments be construed as limiting the appended claims, absent express recitation of those features in the claims.

### BRIEF DESCRIPTION OF FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes, and other detailed attributes may be illustrated schematically rather than literally or precisely.

FIGS. 1A-1C are block diagrams depicting example embodiments of a modular energy system.

FIGS. 1D-1E are block diagrams depicting example embodiments of control devices for an energy system.

FIGS. 1F-1G are block diagrams depicting example embodiments of modular energy systems coupled with a load and a charge source.

FIGS. 2A-2B are block diagrams depicting example embodiments of a module and control system within an energy system.

FIG. 2C is a block diagram depicting an example embodiment of a physical configuration of a module.

FIG. 2D is a block diagram depicting an example embodiment of a physical configuration of a modular energy system.

FIGS. 3A-3C are block diagrams depicting example embodiments of modules having various electrical configurations.

FIGS. 4A-4F are schematic views depicting example embodiments of energy sources.

FIGS. 5A-5C are schematic views depicting example embodiments of energy buffers.

FIGS. 6A-6C are schematic views depicting example embodiments of converters.

FIGS. 7A-7E are block diagrams depicting example embodiments of modular energy systems having various topologies.

FIG. 8A is a plot depicting an example output voltage of a module.

FIG. 8B is a plot depicting an example multilevel output voltage of an array of modules.

FIG. 8C is a plot depicting an example reference signal and carrier signals usable in a pulse width modulation control technique.

FIG. 8D is a plot depicting example reference signals and carrier signals usable in a pulse width modulation control technique.

FIG. 8E is a plot depicting example switch signals generated according to a pulse width modulation control technique.

FIG. 8F as a plot depicting an example multilevel output voltage generated by superposition of output voltages from an array of modules under a pulse width modulation control technique.

FIGS. 9A-9B are block diagrams depicting example embodiments of controllers for a modular energy system.

FIG. 10 is a block diagram depicting an example embodiment of a multiphase modular energy system having interconnection module.

FIG. 11 is a block diagram of an example embodiment of a modular energy system having a module pack and a supplemental signal conversion device.

FIGS. 12A-12E are block diagrams of example embodiments of module packs.

FIGS. 13A-13C are block diagrams of example embodiments of modular energy systems having a module pack and a SSCD for providing power to primary and auxiliary loads.

FIG. 13D is a block diagram of an example embodiment of a SSCD for providing power to auxiliary loads.

FIG. 13E is a diagram that shows example embodiments of connectors for coupling module packs with SSCDs.

FIG. 13F is a diagram of an example equivalent rectifier circuit during single motor control.

FIG. 13G is a diagram of an example equivalent module pack configuration during single motor control.

FIG. 13H is a diagram of an example control scheme for single motor control.

FIG. 13I is a diagram of an example equivalent rectifier circuit during two-motor control.

FIG. 13J is a diagram of an example equivalent module pack configuration during two-motor control.

FIG. 13K is a diagram of an example control scheme for two-motor control.

FIG. 13L is a diagram of an example equivalent rectifier circuit during charging in single motor embodiments.

FIG. 13M is a diagram of an example equivalent module pack configuration during charging in single motor embodiments.

FIG. 13N is a diagram of an example equivalent rectifier circuit during charging in two-motor embodiments.

FIG. 13O is a diagram of an example equivalent module pack configuration during charging in two-motor embodiments.

FIGS. 14A-14B are block diagrams of example embodiments of modular energy systems having a module pack and a SSCD for providing power to primary and auxiliary loads.

FIG. 14C is a block diagram of an example embodiment of a SSCD for providing power to auxiliary loads.

FIG. 14D is a diagram of an example equivalent rectifier circuit during single motor control.

FIG. 14E is a diagram of an example equivalent module pack configuration during single motor control.

FIG. 14F is a diagram of an example control scheme for single motor control.

FIG. 14G is a diagram of an example equivalent rectifier circuit during two-motor control.

FIG. 14H is a diagram of an example equivalent module pack configuration during two-motor control.

FIG. 14I is a diagram of an example control scheme for two-motor control.

FIG. 14J is a diagram of an example equivalent rectifier circuit during charging in single motor and two-motor embodiments.

FIG. 14K is a diagram of an example equivalent module pack configuration during charging in single motor and two-motor embodiments.

FIGS. 15A-15B are block diagrams of example embodiments of modular energy systems having a module pack and a SSCD for providing power to primary and auxiliary loads.

FIG. 15C is a block diagram of an example embodiment of a SSCD for providing power to auxiliary loads.

FIG. 15D is a diagram of an example equivalent rectifier circuit during single motor control.

FIG. 15E is a diagram of an example equivalent module pack configuration during single motor control.

FIG. 15F is a diagram of an example control scheme for single motor control.

FIG. 15G is a diagram of an example equivalent rectifier circuit during two-motor control.

FIG. 15H is a diagram of an example equivalent module pack configuration during two-motor control.

FIG. 15I is a diagram of an example control scheme for two-motor control.

FIG. 15J is a diagram of an example equivalent rectifier circuit during charging in single motor and two-motor embodiments.

FIG. 15K is a diagram of an example equivalent module pack configuration during charging in single motor and two-motor embodiments.

FIG. 16 is a flow diagram depicting an example embodiment of a method for providing power to primary and auxiliary loads.

FIGS. 17A-17C are equivalent module pack configurations during charging and discharging.

FIGS. 18A-18C are block diagrams of example embodiments of modular energy systems having a module pack and a supplemental signal conversion device.

### DETAILED DESCRIPTION

Before the present subject matter is described in detail, it is to be understood that this disclosure is not limited to the particular embodiments described, as such may, of course, vary. The terminology used herein is for the purpose of describing particular embodiments only, and is not intended to be limiting, since the scope of the present disclosure will be limited only by the appended claims.

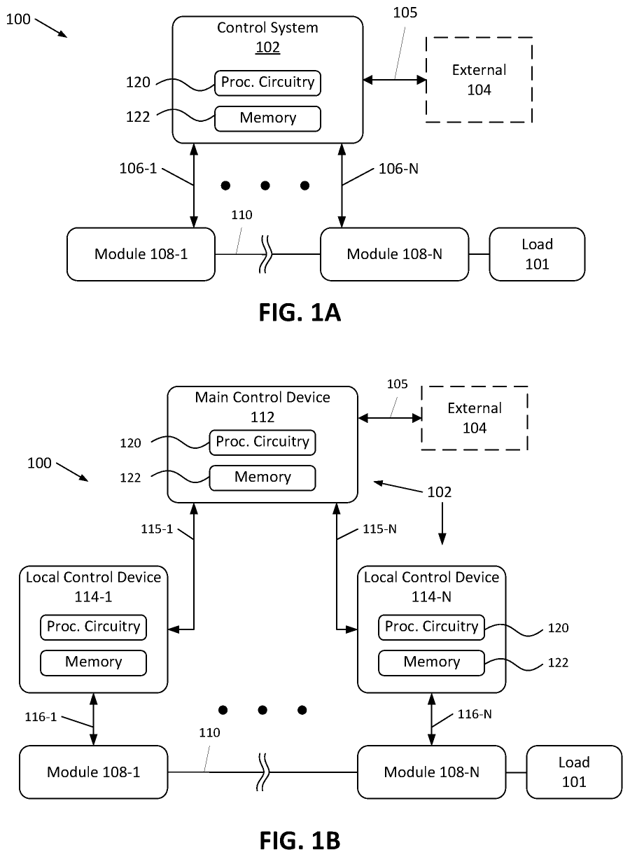

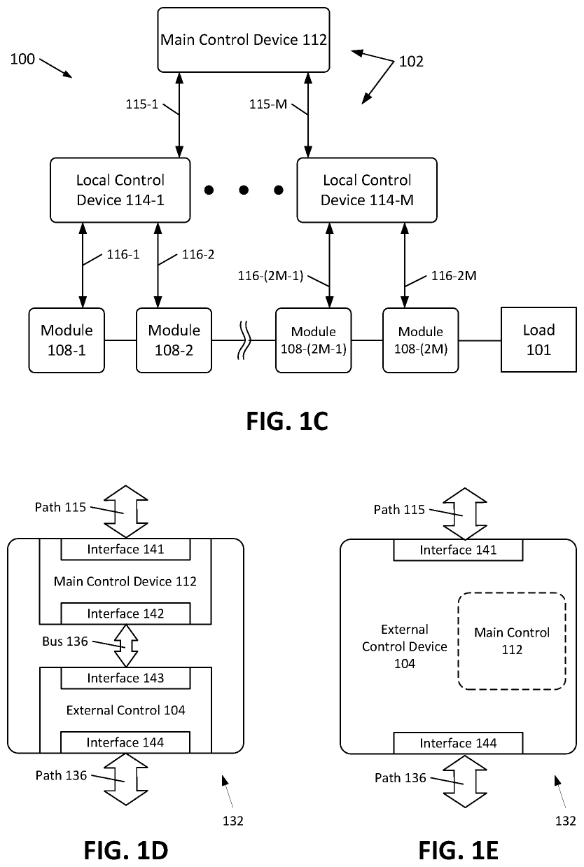

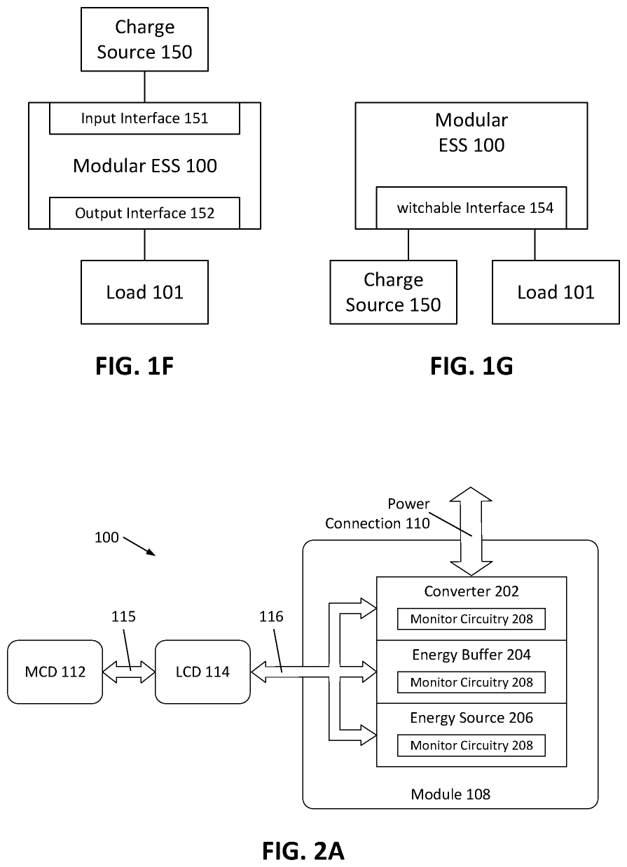

Before describing the example embodiments pertaining to modular energy systems that provide power to primary and auxiliary loads, it is first useful to describe these underlying systems in greater detail. With reference to FIGS. 1A through 10F, the following sections describe various applications in which embodiments of the modular energy systems can be implemented, embodiments of control systems or devices for the modular energy systems, configurations of the modular energy system embodiments with respect to charging sources and loads, embodiments of individual modules, embodiments of topologies for the arrangement of the modules within the systems, embodiments of control methodologies, embodiments of balancing operating characteristics of modules within the systems, and embodiments of the use of interconnection modules.

### Examples of Applications

Stationary applications are those in which the modular energy system is located in a fixed location during use, although it may be capable of being transported to alternative locations when not in use. The module-based energy system resides in a static location while providing electrical energy for consumption by one or more other entities, or storing or buffering energy for later consumption. Examples of stationary applications in which the embodiments disclosed herein can be used include, but are not limited to: energy systems for use by or within one or more residential structures or locales, energy systems for use by or within one or more industrial structures or locales, energy systems for use by or within one or more commercial structures or locales, energy systems for use by or within one or more governmental structures or locales (including both military and non-military uses), energy systems for charging the mobile applications described below (e.g., a charge source or a charging station), and systems that convert solar power, wind, geothermal energy, fossil fuels, or nuclear reactions into electricity for storage. Stationary applications often supply loads such as grids and microgrids, motors, and data centers. A stationary energy system can be used in either a storage or non-storage role.

Mobile applications, sometimes referred to as traction applications, are generally ones where a module-based energy system is located on or within an entity, and stores and provides electrical energy for conversion into motive force by a motor to move or assist in moving that entity. Examples of mobile entities with which the embodiments disclosed herein can be used include, but are not limited to, electric and/or hybrid entities that move over or under land, over or under sea, above and out of contact with land or sea (e.g., flying or hovering in the air), or through outer space. Examples of mobile entities with which the embodiments disclosed herein can be used include, but are not limited to, vehicles, trains, trams, ships, vessels, aircraft, and spacecraft. Examples of mobile vehicles with which the embodiments disclosed herein can be used include, but are not limited to, those having only one wheel or track, those having only two-wheels or tracks, those having only three wheels or tracks, those having only four wheels or tracks, and those having five or more wheels or tracks. Examples of mobile entities with which the embodiments disclosed herein can be used include, but are not limited to, a car, a bus, a truck, a motorcycle, a scooter, a bicycle, an industrial vehicle, a mining vehicle, a flying vehicle (e.g., a plane, a helicopter, a drone, etc.), a maritime vessel (e.g., commercial shipping vessels, ships, yachts, boats or other watercraft), a submarine, a locomotive or rail-based vehicle (e.g., a train, a tram, etc.), a military vehicle, a spacecraft, and a satellite.

In describing embodiments herein, reference may be made to a particular stationary application (e.g., grid, micro-grid, data centers, cloud computing environments) or mobile application (e.g., an electric car). Such references are made for ease of explanation and do not mean that a particular embodiment is limited for use to only that particular mobile or stationary application. Embodiments of systems providing power to a motor can be used in both mobile and stationary applications. While certain configurations may be more suitable to some applications over others, all example embodiments disclosed herein are capable of use in both mobile and stationary applications unless otherwise noted.

### Module-based Energy System Examples

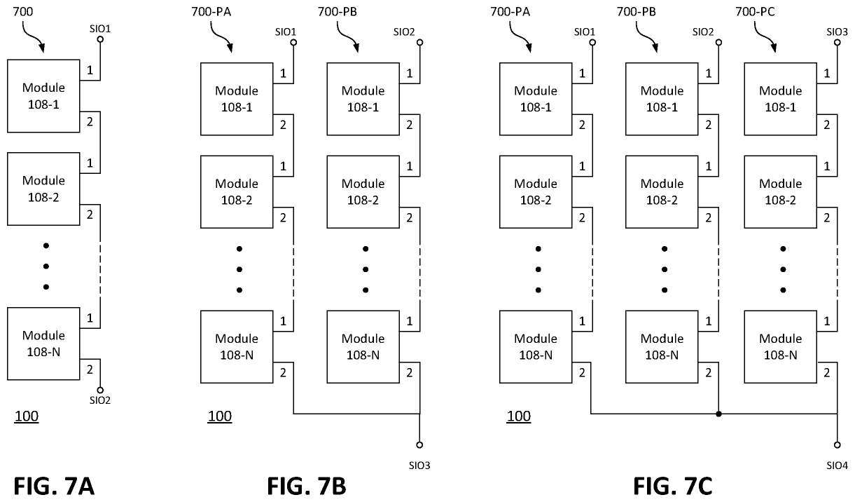

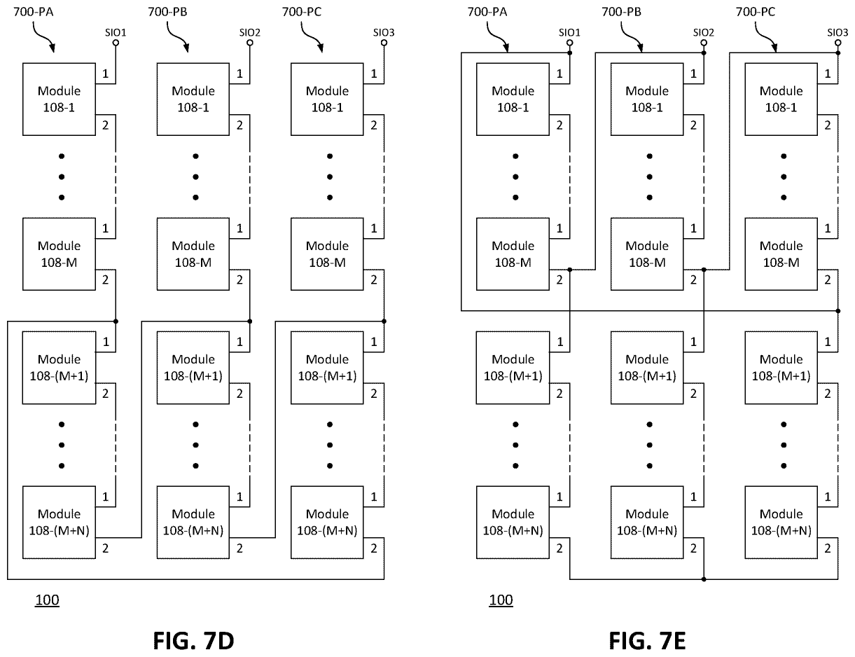

FIG. 1A is a block diagram that depicts an example embodiment of a module-based energy system 100. Here, system 100 includes control system 102 communicatively coupled with N converter-source modules 108-1 through 108-N, over communication paths or links 106-1 through 106-N, respectively. Modules 108 are configured to store energy and output the energy as needed to a load 101 (or other modules 108). In these embodiments, any number of two or more modules 108 can be used (e.g., N is greater than or equal to two). Modules 108 can be connected to each other in a variety of manners as will be described in more detail with respect to FIGS. 7A-7E. For ease of illustration, in FIGS. 1A-1C, modules 108 are shown connected in series, or as a one-dimensional array, where the Nth module is coupled to load 101.

System 100 is configured to supply power to load 101. Load 101 can be any type of load such as a motor or a grid. System 100 is also configured to store power received from a charge source. FIG. 1F is a block diagram depicting an example embodiment of system 100 with a power input interface 151 for receiving power from a charge source 150 and a power output interface for outputting power to load 101. In this embodiment system 100 can receive and store power over interface 151 at the same time as outputting power over interface 152. FIG. 1G is a block diagram depicting another example embodiment of system 100 with a switchable interface 154. In this embodiment, system 100 can select, or be instructed to select, between receiving power from charge source 150 and outputting power to load 101. System 100 can be configured to supply multiple loads 101, including both primary and auxiliary loads, and/or receive power from multiple charge sources 150 (e.g., a utility-operated power grid and a local renewable energy source (e.g., solar)). Charge source 150 can be an AC charge source that provides an AC charge signal or a DC charge source that provides a DC charge signal. For example, when system 100 is part of an EV, charge source 150 can be an AC charging station or a DC charging station, e.g., a DC fast charging station.

FIG. 1B depicts another example embodiment of system 100. Here, control system 102 is implemented as a main control device (MCD) 112 communicatively coupled with N different local control devices (LCDs) 114-1 through 114-N over communication paths or links 115-1 through 115-N, respectively. Each LCD 114-1 through 114-N is communicatively coupled with one module 108-1 through 108-N over communication paths or links 116-1 through 116-N, respectively, such that there is a 1:1 relationship between LCDs 114 and modules 108.

FIG. 1C depicts another example embodiment of system 100. Here, MCD 112 is communicatively coupled with M different LCDs 114-1 to 114-M over communication paths or links 115-1 to 115-M, respectively. Each LCD 114 can be coupled with and control two or more modules 108. In the example shown here, each LCD 114 is communicatively coupled with two modules 108, such that M LCDs 114-1 to 114-M are coupled with 2M modules 108-1 through 108-2M over communication paths or links 116-1 to 116-2M, respectively.

Control system 102 can be configured as a single device (e.g., FIG. 1A) for the entire system 100 or can be distributed across or implemented as multiple devices (e.g., FIGS. 1B-1C). In some embodiments, control system 102 can be distributed between LCDs 114 associated with the modules 108, such that no MCD 112 is necessary and can be omitted from system 100.

Control system 102 can be configured to execute control using software (instructions stored in memory that are executable by processing circuitry), hardware, or a combination thereof. The one or more devices of control system 102 can each include processing circuitry 120 and memory 122 as shown here. Example implementations of processing circuitry and memory are described further below.

Control system 102 can have a communicative interface for communicating with devices 104 external to system 100 over a communication link or path 105. For example, control system 102 (e.g., MCD 112) can output data or information about system 100 to another control device 104 (e.g., the Electronic Control Unit (ECU) or Motor Control Unit (MCU) of a vehicle in a mobile application, grid controller in a stationary application, etc.).

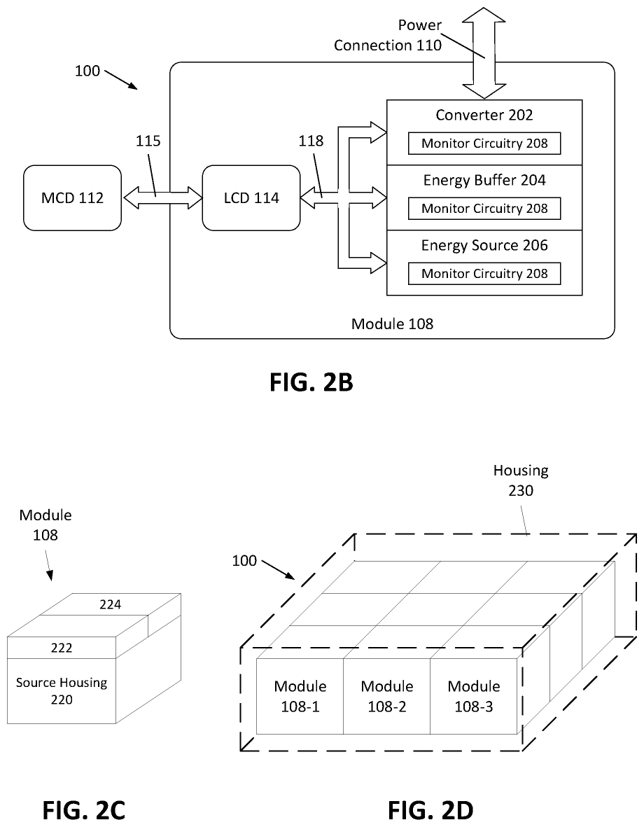

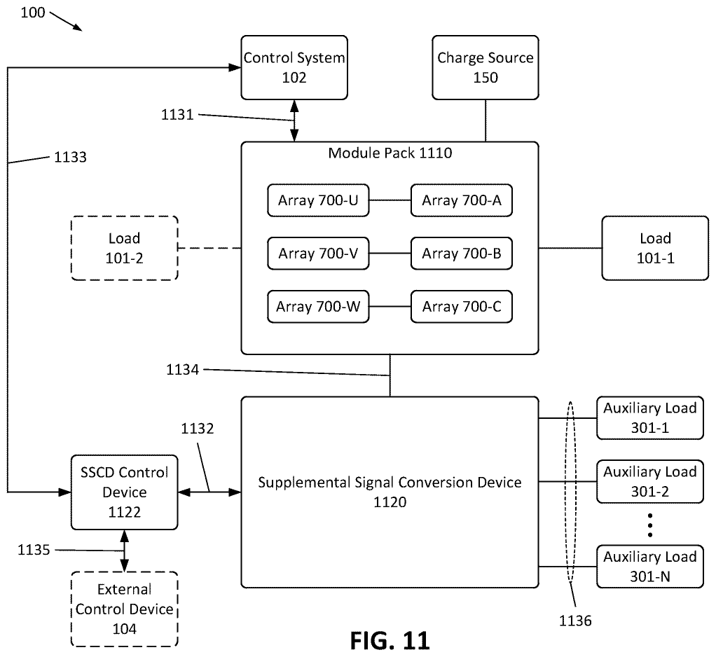

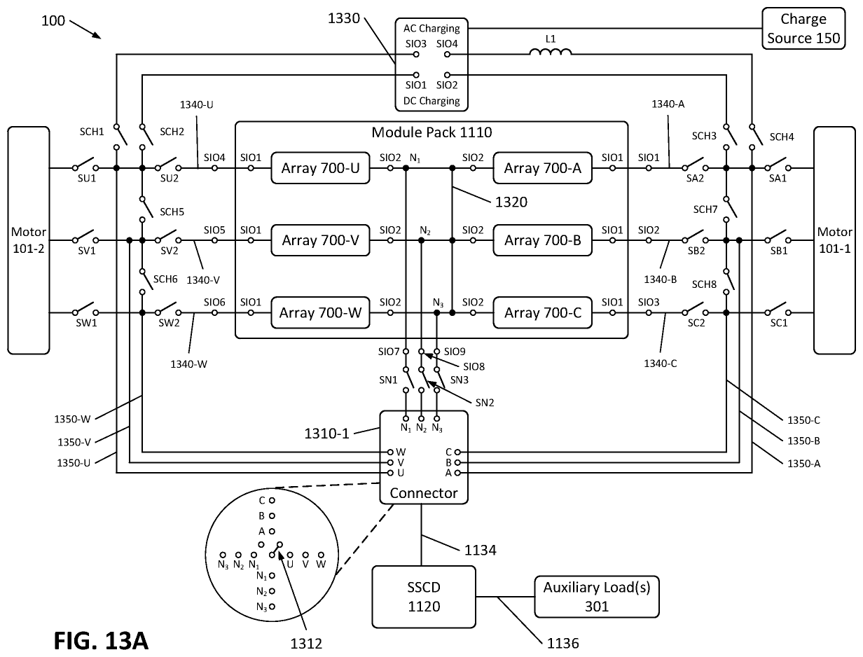

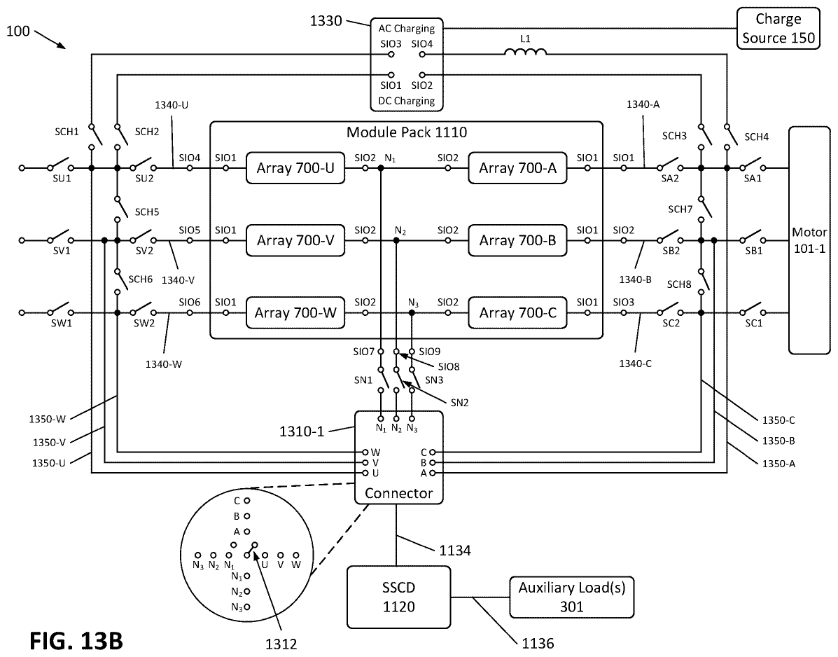

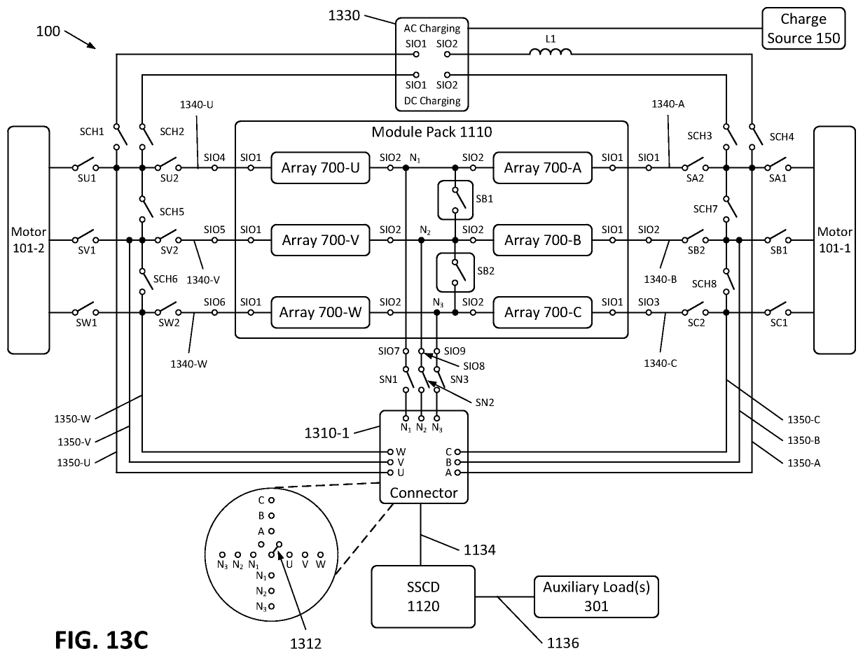

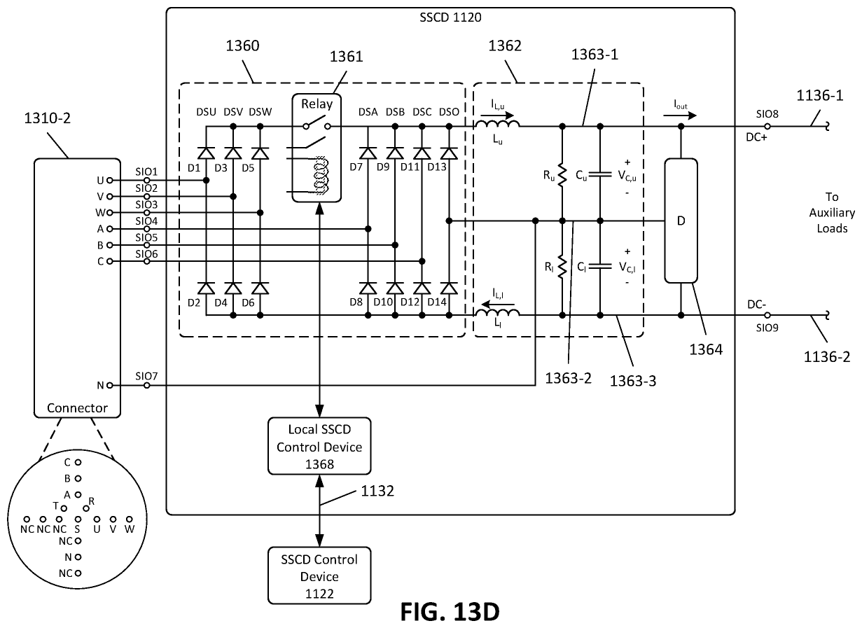

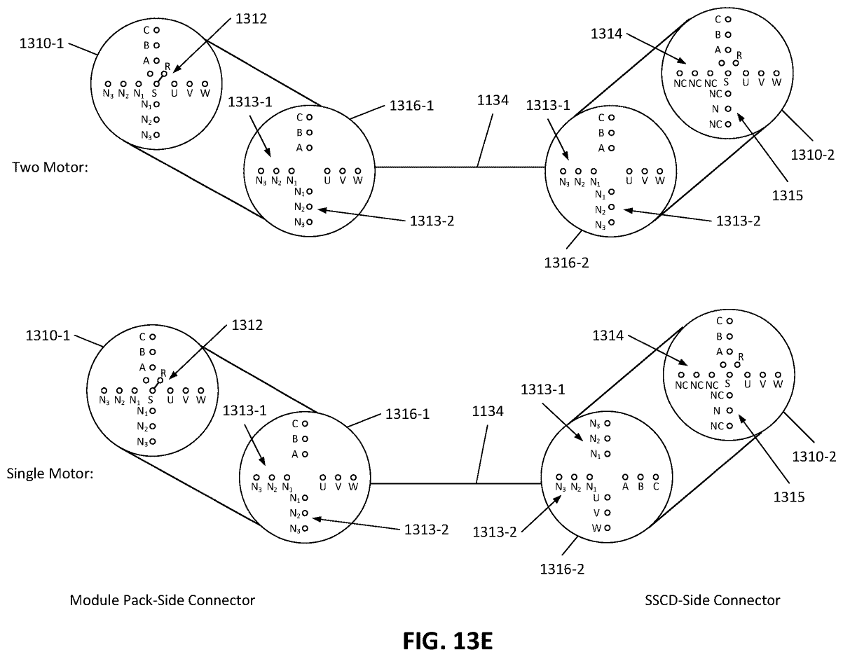

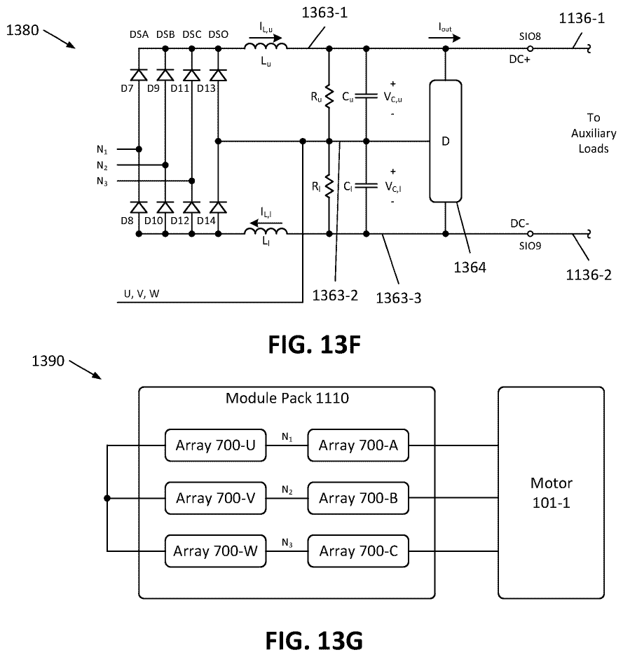

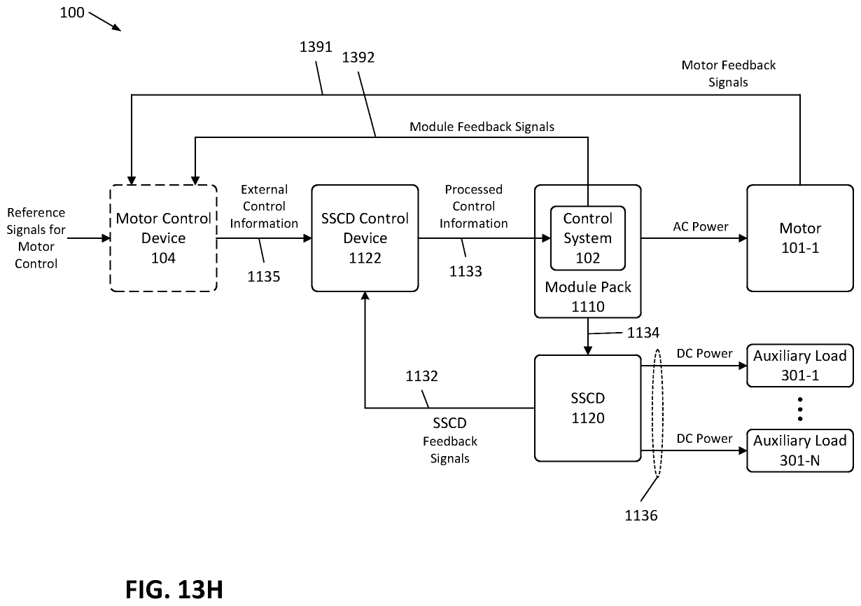

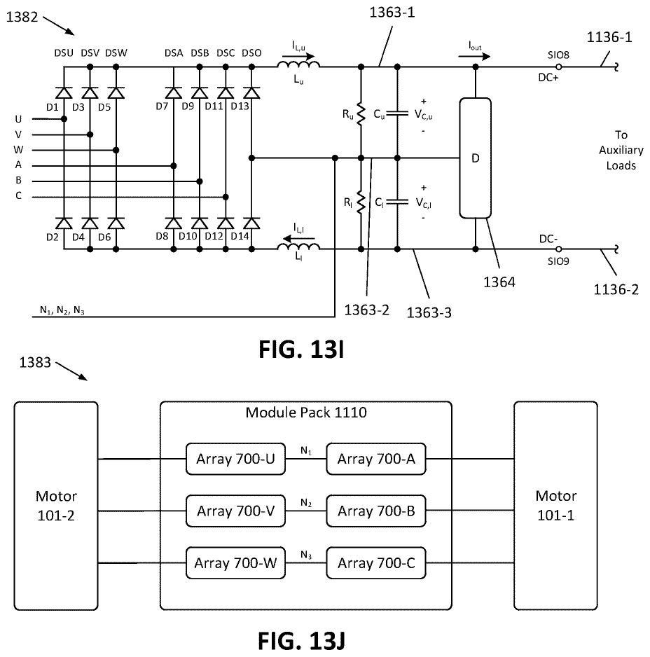

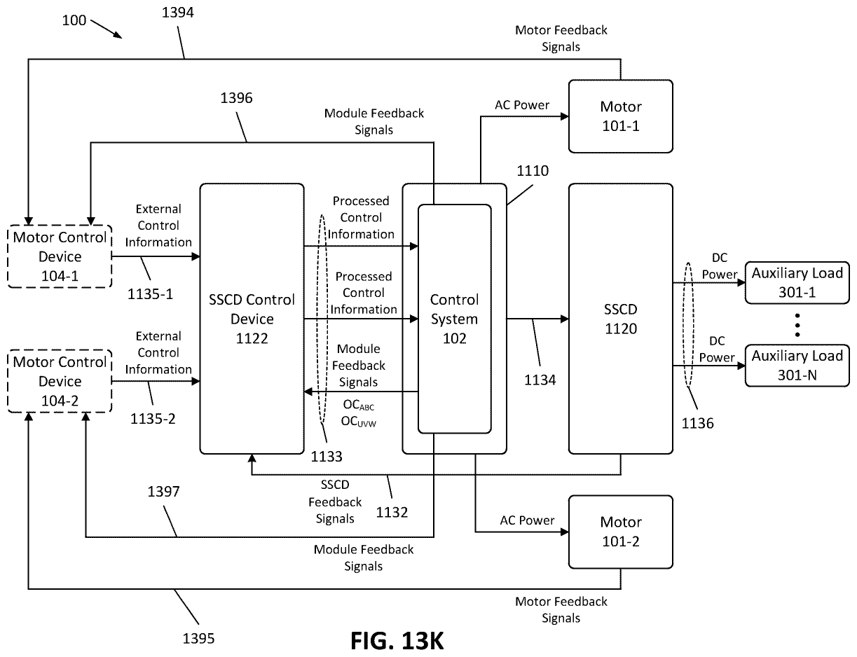

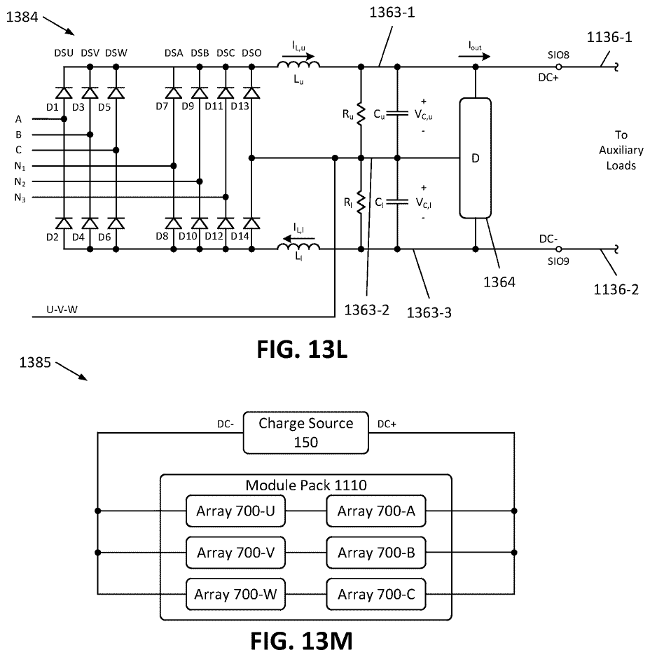

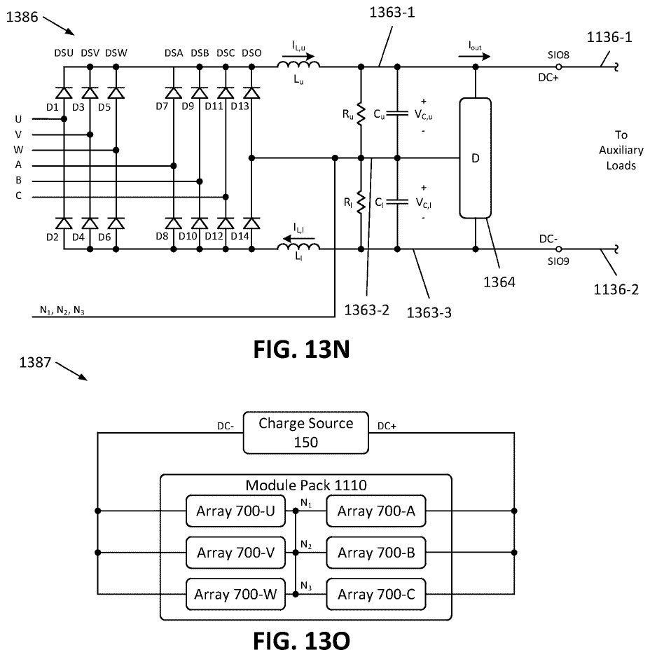

Communication paths or links 105, 106, 115, 116, and communication paths or links described below such as communication paths or links 118 of FIGS. 2B, 1131, 1132, 1133, and 1135 of FIGS. 11, 1391 and 1392 of FIG. 13H, and 1394-1397 of FIG. 13K can each be wired (e.g., electrical, optical) or wireless communication paths that communicate data or information bidirectionally, in parallel or series fashion. Data can be communicated in a standardized (e.g., IEEE, ANSI) or custom (e.g., proprietary) format. In automotive applications, communication paths 115 can be configured to communicate according to FlexRay or CAN protocols. Communication paths 106, 115, 116, and 118 can also provide wired power to directly supply the operating power for system 102 from one or more modules 108. For example, the operating power for each LCD 114 can be supplied only by the one or more modules 108 to which that LCD 114 is connected and the operating power for MCD 112 can be supplied indirectly from one or more of modules 108 (e.g., such as through a car's power network).

Control system 102 is configured to control one or more modules 108 based on status information received from the same or different one or more of modules 108. Control can also be based on one or more other factors, such as requirements of load 101. Controllable aspects include, but are not limited to, one or more of voltage, current, phase, and/or output power of each module 108.

Status information of every module 108 in system 100 can be communicated to control system 102, which can independently control every module 108-1 . . . 108-N. Other variations are possible. For example, a particular module 108 (or subset of modules 108) can be controlled based on status information of that particular module 108 (or subset), based on status information of a different module 108 that is not that particular module 108 (or subset), based on status information of all modules 108 other than that particular module 108 (or subset), based on status information of that particular module 108 (or subset) and status information of at least one other module 108 that is not that particular module 108 (or subset), or based on status information of all modules 108 in system 100.

The status information can be information about one or more aspects, characteristics, or parameters of each module 108. Types of status information include, but are not limited to, the following aspects of a module 108 or one or more components thereof (e.g., energy source, energy buffer, converter, monitor circuitry): State of Charge (SOC) (e.g., the level of charge of an energy source relative to its capacity, such as a fraction or percent) of the one or more energy sources of the module, State of Health (SOH) (e.g., a figure of merit of the condition of an energy source compared to its ideal conditions) of the one or more energy sources of the module, temperature of the one or more energy sources or other components of the module, capacity of the one or more energy sources of the module, voltage of the one or more energy sources and/or other components of the module, current of the one or more energy sources and/or other components of the module, State of Power (SOP) (e.g., the available power limitation of the energy source during discharge and/or charge), State of Energy (SOE) (e.g., the present level of available energy of an energy source relative to the maximum available energy of the source), and/or the presence of absence of a fault in any one or more of the components of the module. These aspects of modules 108 can also be referred to as operating characteristics of modules 108.

LCDs 114 can be configured to receive the status information from each module 108, or determine the status information from monitored signals or data received from or within each module 108, and communicate that information to MCD 112. In some embodiments, each LCD 114 can communicate raw collected data to MCD 112, which then algorithmically determines the status information on the basis of that raw data. MCD 112 can then use the status information of modules 108 to make control determinations accordingly. The determinations may take the form of instructions, commands, or other information (such as a modulation index described herein) that can be utilized by LCDs 114 to either maintain or adjust the operation of each module 108.

For example, MCD 112 may receive status information and assess that information to determine a difference between at least one module 108 (e.g., a component thereof) and at least one or more other modules 108 (e.g., comparable components thereof). For example, MCD 112 may determine that a particular module 108 is operating with one of the following conditions as compared to one or more other modules 108: with a relatively lower or higher SOC, with a relatively lower or higher SOH, with a relatively lower or higher capacity, with a relatively lower or higher voltage, with a relatively lower or higher current, with a relatively lower or higher temperature, or with or without a fault. In such examples, MCD 112 can output module control information that causes the relevant aspect (e.g., output voltage, current, power, temperature) of that particular module 108 to be reduced or increased (depending on the condition). In this manner, the utilization of an outlier module 108 (e.g., operating with a relatively lower SOC or higher temperature), can be reduced so as to cause the relevant parameter of that module 108 (e.g., SOC or temperature) to converge towards that of one or more other modules 108.

The determination of whether to adjust the operation of a particular module 108 can be made by comparison of the status information to predetermined thresholds, limits, or conditions, and not necessarily by comparison to statuses of other modules 108. The predetermined thresholds, limits, or conditions can be static thresholds, limits, or conditions, such as those set by the manufacturer that do not change during use. The predetermined thresholds, limits, or conditions can be dynamic thresholds, limits, or conditions, that are permitted to change, or that do change, during use. For example, MCD 112 can adjust the operation of a module 108 if the status information for that module 108 indicates it to be operating in violation (e.g., above or below) of a predetermined threshold or limit, or outside of a predetermined range of acceptable operating conditions. Similarly, MCD 112 can adjust the operation of a module 108 if the status information for that module 108 indicates the presence of an actual or potential fault (e.g., an alarm, or warning) or indicates the absence or removal of an actual or potential fault. Examples of a fault include, but are not limited to, an actual failure of a component, a potential failure of a component, a short circuit or other excessive current condition, an open circuit, an excessive voltage condition, a failure to receive a communication, the receipt of corrupted data, and the like. Depending on the type and severity of the fault, the faulty module's utilization can be decreased to avoid damaging the module, or the module's utilization can be ceased altogether. For example, if a fault occurs in a given module, then MCD 112 or LCD 114 can cause that module to enter a bypass state as described herein.

MCD 112 can control modules 108 within system 100 to achieve or converge towards a desired target. The target can be, for example, operation of all modules 108 at the same or similar levels with respect to each other, or within predetermined thresholds, limits, or conditions. This process is also referred to as balancing or seeking to achieve balance in the operation or operating characteristics of modules 108. The term “balance” as used herein does not require absolute equality between modules 108 or components thereof, but rather is used in a broad sense to convey that operation of system 100 can be used to actively reduce disparities in operation (or operative state) between modules 108 that would otherwise exist.

MCD 112 can communicate module control information to LCD 114 for the purpose of controlling the modules 108 associated with the LCD 114. The control information can be, e.g., a modulation index and a reference signal as described herein, a modulated reference signal, or otherwise. Each LCD 114 can use (e.g., receive and process) the module control information to generate switch signals that control operation of one or more components (e.g., a converter) within the associated module(s) 108. In some embodiments, MCD 112 generates the switch signals directly and outputs them to LCD 114, which relays the switch signals to the intended module component.

All or a portion of control system 102 can be combined with a system external control device 104 that controls one or more other aspects of the mobile or stationary application. When integrated in this shared or common control device (or subsystem), control of system 100 can be implemented in any desired fashion, such as one or more software applications executed by processing circuitry of the shared device, with hardware of the shared device, or a combination thereof. Non-exhaustive examples of external control devices 104 include: a vehicular ECU or MCU having control capability for one or more other vehicular functions (e.g., motor control, driver interface control, traction control, etc.); a grid or micro-grid controller having responsibility for one or more other power management functions, e.g., load interfacing, load power requirement forecasting, transmission and switching, interface with charge sources (e.g., diesel, solar, wind), charge source power forecasting, back up source monitoring, asset dispatch, etc., and a data center control subsystem (e.g., environmental control, network control, backup control, etc.).

FIGS. 1D and 1E are block diagrams depicting example embodiments of a shared or common control device (or system) 132 in which control system 102 can be implemented. In FIG. 1D, common control device 132 includes main control device 112 and external control device 104. Main control device 112 includes an interface 141 for communication with LCDs 114 over path 115, as well as an interface 142 for communication with external control device 104 over internal communication bus 136. External control device 104 includes an interface 143 for communication with main control device 112 over bus 136, and an interface 144 for communication with other entities (e.g., components of the vehicle or grid) of the overall application over communication path 136. In some embodiments, common control device 132 can be integrated as a common housing or package with devices 112 and 104 implemented as discrete integrated circuit (IC) chips or packages contained therein.

In FIG. 1E, external control device 104 acts as common control device 132, with the main control functionality implemented as a component within device 104. This component 112 can be or include software or other program instructions stored and/or hardcoded within memory of device 104 and executed by processing circuitry thereof. The component can also contain dedicated hardware. The component can be a self-contained module or core, with one or more internal hardware and/or software interfaces (e.g., application program interface (API)) for communication with the operating software of external control device 104. External control device 104 can manage communication with LCDs 114 over interface 141 and other devices over interface 144. In various embodiments, device 104/132 can be integrated as a single IC chip, can be integrated into multiple IC chips in a single package, or integrated as multiple semiconductor packages within a common housing.

In the embodiments of FIGS. 1D and 1E, the main control functionality of system 102 is shared in common device 132, however, other divisions of shared control are permitted. For example, part of the main control functionality can be distributed between common device 132 and a dedicated MCD 112. In another example, both the main control functionality and at least part of the local control functionality can be implemented in common device 132 (e.g., with the remaining local control functionality implemented in LCDs 114). In some embodiments, all of control system 102 is implemented in common device (or subsystem) 132. In some embodiments, local control functionality is implemented within a device shared with another component of each module 108, such as a Battery Management System (BMS).

### Examples of Modules Within Cascaded Energy Systems

Module 108 can include one or more energy sources and a power electronics converter and, if desired, an energy buffer. FIGS. 2A-2B are block diagrams depicting additional example embodiments of system 100 with module 108 having a power converter 202, an energy buffer 204, and an energy source 206. Converter 202 can be a voltage converter or a current converter. The embodiments are described herein with reference to voltage converters, although the embodiments are not limited to such. Converter 202 can be configured to convert a direct current (DC) signal from energy source 206 into an alternating current (AC) signal and output it over power connection 110 (e.g., an inverter). Converter 202 can also receive an AC or DC signal over connection 110 and apply it to energy source 206 with either polarity in a continuous or pulsed form. Converter 202 can be or include an arrangement of switches (e.g., power transistors) such as a half bridge of full bridge (H-bridge). In some embodiments, converter 202 includes only switches and the converter (and the module as a whole) does not include a transformer.

Converter 202 can also (or alternatively) be configured to perform AC to DC conversion (e.g., a rectifier) such as to charge a DC energy source from an AC source, DC to DC conversion, and/or AC to AC conversion (e.g., in combination with an AC-DC converter). In some embodiments, such as to perform AC-AC conversion, converter 202 can include a transformer, either alone or in combination with one or more power semiconductors (e.g., switches, diodes, thyristors, and the like). In other embodiments, such as those where weight and cost are significant factors, converter 202 can be configured to perform the conversions with only power switches, power diodes, or other semiconductor devices and without a transformer.

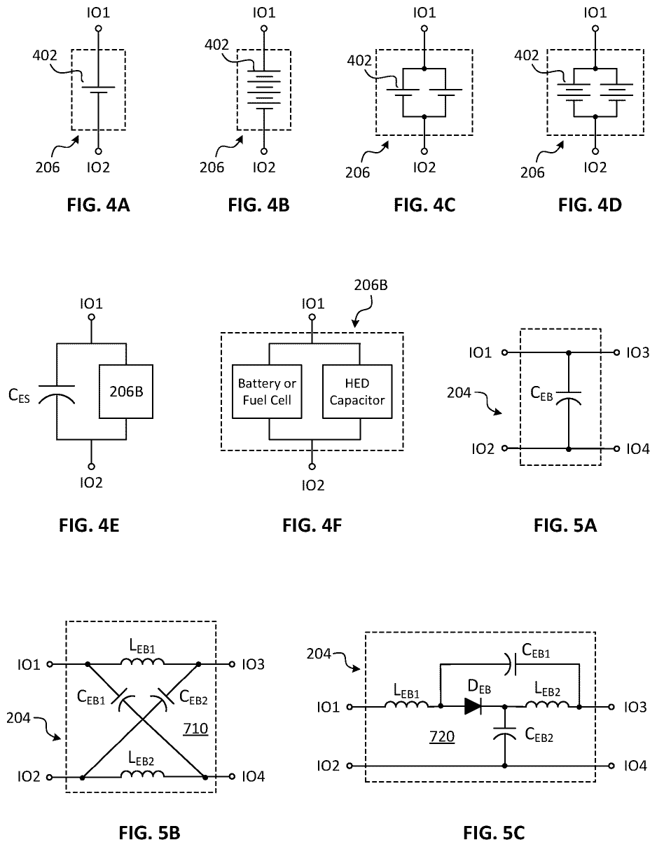

Energy source 206 is preferably a robust energy storage device capable of outputting direct current and having an energy density suitable for energy storage applications for electrically powered devices. Energy source 206 can be an electrochemical battery, such as a single battery cell or multiple battery cells connected together in a battery module or array, or any combination thereof. FIGS. 4A-4D are schematic diagrams depicting example embodiments of energy source 206 configured as a single battery cell 402 (FIG. 4A), a battery module with a series connection of multiple (e.g., four) cells 402 (FIG. 4B), a battery module with a parallel connection of single cells 402 (FIG. 4C), and a battery module with a parallel connection with legs having two cells 402 each (FIG. 4D). A non-exhaustive list of examples of battery types is set forth elsewhere herein.

Energy source 206 can also be a high energy density (HED) capacitor, such as an ultracapacitor or supercapacitor. An HED capacitor can be configured as a double-layer capacitor (electrostatic charge storage), pseudocapacitor (electrochemical charge storage), hybrid capacitor (electrostatic and electrochemical), or otherwise, as opposed to a solid dielectric type of a typical electrolytic capacitor. The HED capacitor can have an energy density of 10 to 100 times (or higher) that of an electrolytic capacitor, in addition to a higher capacity. For example, HED capacitors can have a specific energy greater than 1.0 watt-hour per kilogram (Wh/kg), and a capacitance greater than 10-100 farads (F). As with the batteries described with respect to FIGS. 4A-4D, energy source 206 can be configured as a single HED capacitor or multiple HED capacitors connected together in an array (e.g., series, parallel, or a combination thereof).

Energy source 206 can also be a fuel cell. The fuel cell can be a single fuel cell, multiple fuel cells connected in series or parallel, or a fuel cell module. Examples of fuel cell types include proton-exchange membrane fuel cells (PEMFC), phosphoric acid fuel cells (PAFC), solid acid fuel cells, alkaline fuel cells, high temperature fuel cells, solid oxide fuel cells, molten electrolyte fuel cells, and others. As with the batteries described with respect to FIGS. 4A-4D, energy source 206 can be configured as a single fuel cell or multiple fuel cells connected together in an array (e.g., series, parallel, or a combination thereof). The aforementioned examples of source classes (e.g., batteries, capacitors, and fuel cells) and types (e.g., chemistries and/or structural configurations within each class) are not intended to form an exhaustive list, and those of ordinary skill in the art will recognize other variants that fall within the scope of the present subject matter.

Energy buffer 204 can dampen or filter fluctuations in current across the DC line or link (e.g., +V_{DCL} and −V_{DCL} as described below), to assist in maintaining stability in the DC link voltage. These fluctuations can be relatively low (e.g., kilohertz) or high (e.g., megahertz) frequency fluctuations or harmonics caused by the switching of converter 202, or other transients. These fluctuations can be absorbed by buffer 204 instead of being passed to source 206 or to ports IO3 and IO4 of converter 202.

Power connection 110 is a connection for transferring energy or power to, from and through module 108. Module 108 can output energy from energy source 206 to power connection 110, where it can be transferred to other modules of the system or to a load. Module 108 can also receive energy from other modules 108 or a charging source (DC charger, single phase charger, multi-phase charger). Signals can also be passed through module 108 bypassing energy source 206. The routing of energy or power into and out of module 108 is performed by converter 202 under the control of LCD 114 (or another entity of system 102).

In the embodiment of FIG. 2A, LCD 114 is implemented as a component separate from module 108 (e.g., not within a shared module housing) and is connected to and capable of communication with converter 202 via communication path 116. In the embodiment of FIG. 2B, LCD 114 is included as a component of module 108 and is connected to and capable of communication with converter 202 via internal communication path 118 (e.g., a shared bus or discrete connections). LCD 114 can also be capable of receiving signals from, and transmitting signals to, energy buffer 204 and/or energy source 206 over paths 116 or 118.

Module 108 can also include monitor circuitry 208 configured to monitor (e.g., collect, sense, measure, and/or determine) one or more aspects of module 108 and/or the components thereof, such as voltage, current, temperature, or other operating parameters that constitute status information (or can be used to determine status information by, e.g., LCD 114). A main function of the status information is to describe the state of the one or more energy sources 206 of the module 108 to enable determinations as to how much to utilize the energy source in comparison to other sources in system 100, although status information describing the state of other components (e.g., voltage, temperature, and/or presence of a fault in buffer 204, temperature and/or presence of a fault in converter 202, presence of a fault elsewhere in module 108, etc.) can be used in the utilization determination as well. Monitor circuitry 208 can include one or more sensors, shunts, dividers, fault detectors, Coulomb counters, controllers, or other hardware and/or software configured to monitor such aspects. Monitor circuitry 208 can be separate from the various components 202, 204, and 206, or can be integrated with each component 202, 204, and 206 (as shown in FIGS. 2A-2B), or any combination thereof. In some embodiments, monitor circuitry 208 can be part of or shared with a Battery Management System (BMS) for a battery energy source 204. Discrete circuitry is not needed to monitor each type of status information, as more than one type of status information can be monitored with a single circuit or device, or otherwise algorithmically determined without the need for additional circuits.

LCD 114 can receive status information (or raw data) about the module components over communication paths 116, 118. LCD 114 can also transmit information to module components over paths 116, 118. Paths 116 and 118 can include diagnostics, measurement, protection, and control signal lines. The transmitted information can be control signals for one or more module components. The control signals can be switch signals for converter 202 and/or one or more signals that request the status information from module components. For example, LCD 114 can cause the status information to be transmitted over paths 116, 118 by requesting the status information directly, or by applying a stimulus (e.g., voltage) to cause the status information to be generated, in some cases in combination with switch signals that place converter 202 in a particular state.

The physical configuration or layout of module 108 can take various forms. In some embodiments, module 108 can include a common housing in which all module components, e.g., converter 202, buffer 204, and source 206, are housed, along with other optional components such as an integrated LCD 114. In other embodiments, the various components can be separated in discrete housings that are secured together. FIG. 2C is a block diagram depicting an example embodiment of a module 108 having a first housing 220 that holds an energy source 206 of the module and accompanying electronics such as monitor circuitry, a second housing 222 that holds module electronics such as converter 202, energy buffer 204, and other accompany electronics such as monitor circuitry, and a third housing 224 that holds LCD 114 (not shown) for the module 108. In alternative embodiments, the module electronics and LCD 114 can be housed within the same single housing. In still other embodiments, the module electronics, LCD 114, and energy source(s) can be housed within the same single housing for the module 108. Electrical connections between the various module components can proceed through the housings 220, 222, 224 and can be exposed on any of the housing exteriors for connection with other devices such as other modules 108 or MCD 112.

Modules 108 of system 100 can be physically arranged with respect to each other in various configurations that depend on the needs of the application and the number of loads. For example, in a stationary application where system 100 provides power for a microgrid, modules 108 can be placed in one or more racks or other frameworks. Such configurations may be suitable for larger mobile applications as well, such as maritime vessels. Alternatively, modules 108 can be secured together and located within a common housing, referred to as a pack. A rack or a pack may have its own dedicated cooling system shared across all modules. Pack configurations are useful for smaller mobile applications such as electric cars. System 100 can be implemented with one or more racks (e.g., for parallel supply to a microgrid) or one or more packs (e.g., serving different motors of the vehicle), or combination thereof. FIG. 2D is a block diagram depicting an example embodiment of system 100 configured as a pack with nine modules 108 electrically and physically coupled together within a common housing 230.

Examples of these and further configurations are described in Int'l. Appl. No. PCT/US20/25366, filed Mar. 27, 2020 and titled Module-Based Energy Systems Capable of Cascaded and Interconnected Configurations, and Methods Related Thereto, which is incorporated by reference herein in its entirety for all purposes.

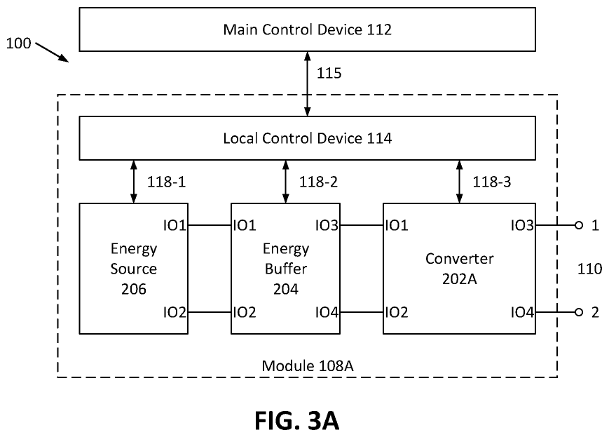

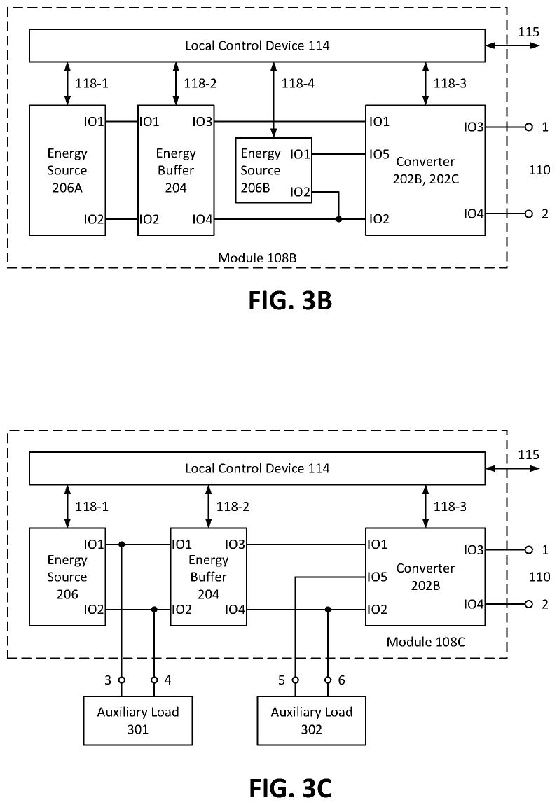

FIGS. 3A-3C are block diagrams depicting example embodiments of modules 108 having various electrical configurations. These embodiments are described as having one LCD 114 per module 108, with the LCD 114 housed within the associated module, but can be configured otherwise as described herein. FIG. 3A depicts a first example configuration of a module 108A within system 100. Module 108A includes energy source 206, energy buffer 204, and converter 202A. Each component has power connection ports (e.g., terminals, connectors) into which power can be input and/or from which power can be output, referred to herein as IO ports. Such ports can also be referred to as input ports or output ports depending on the context.

Energy source 206 can be configured as any of the energy source types described herein (e.g., a battery as described with respect to FIGS. 4A-4D, an HED capacitor, a fuel cell, or otherwise). Ports IO1 and IO2 of energy source 206 can be connected to ports IO1 and IO2, respectively, of energy buffer 204. Energy buffer 204 can be configured to buffer or filter high and low frequency energy pulsations arriving at buffer 204 through converter 202, which can otherwise degrade the performance of module 108. The topology and components for buffer 204 are selected to accommodate the maximum permissible amplitude of these high frequency voltage pulsations. Several (non-exhaustive) example embodiments of energy buffer 204 are depicted in the schematic diagrams of FIGS. 5A-5C. In FIG. 5A, buffer 204 is an electrolytic and/or film capacitor C_{EB}; in FIG. 5B, buffer 204 is a Z-source network 710, formed by two inductors L_{EB1} and L_{EB2} and two electrolytic and/or film capacitors C_{EB1} and C_{EB2}; and in FIG. 5C, buffer 204 is a quasi Z-source network 720, formed by two inductors L_{EB1} and L_{EB2}, two electrolytic and/or film capacitors C_{EB1} and C_{EB2}, and a diode D_{EB}.

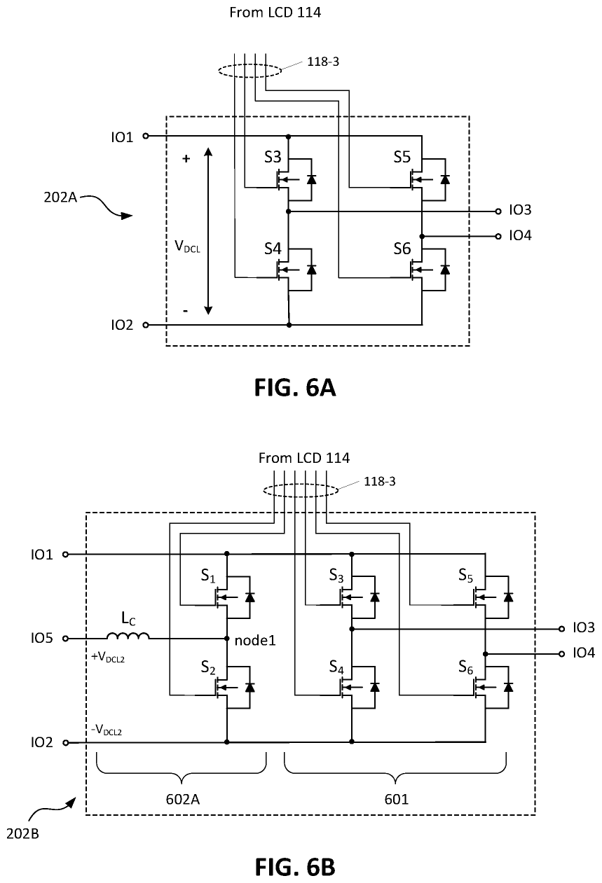

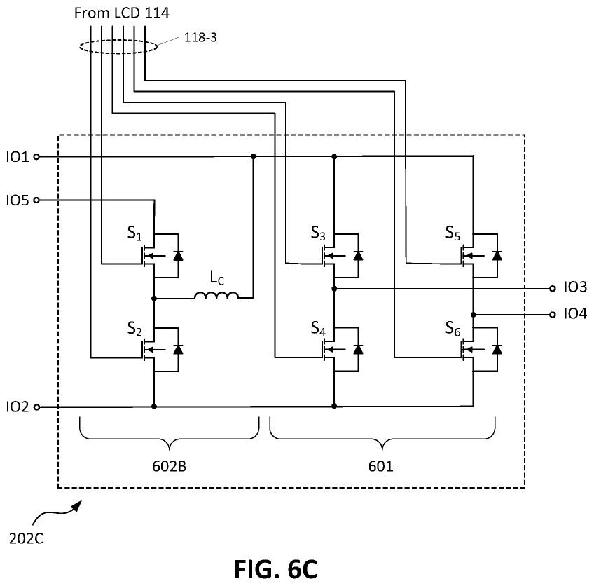

Ports IO3 and IO4 of energy buffer 204 can be connected to ports IO1 and IO2, respectively, of converter 202A, which can be configured as any of the power converter types described herein. FIG. 6A is a schematic diagram depicting an example embodiment of converter 202A configured as a DC-AC converter that can receive a DC voltage at ports IO1 and IO2 and switch to generate pulses at ports IO3 and IO4. Converter 202A can include multiple switches, and here converter 202A includes four switches S3, S4, S5, and S6, arranged in a full bridge configuration. Control system 102 or LCD 114 can independently control each switch via control input lines 118-3 to each gate.

The switches can be any suitable switch type, such as power semiconductors like the metal-oxide-semiconductor field-effect transistors (MOSFETs) shown here, insulated gate bipolar transistors (IGBTs), or gallium nitride (GaN) transistors. Semiconductor switches can operate at relatively high switching frequencies, thereby permitting converter 202 to be operated in pulse-width modulated (PWM) mode if desired, and to respond to control commands within a relatively short interval of time. This can provide a high tolerance for output voltage regulation and fast dynamic behavior in transient modes.

In this embodiment, a DC line voltage V_{DCL} can be applied to converter 202 between ports IO1 and IO2. By connecting V_{DCL} to ports IO3 and IO4 by different combinations of switches S3, S4, S5, S6, converter 202 can generate three different voltage outputs at ports IO3 and IO4: +V_{DCL}, 0, and −V_{DCL}. A switch signal provided to each switch controls whether the switch is on (closed) or off (open). To obtain +V_{DCL}, switches S3 and S6 are turned on while S4 and S5 are turned off, whereas −V_{DCL} can be obtained by turning on switches S4 and S5 and turning off S3 and S6. The output voltage can be set to zero (including near zero) or a reference voltage by turning on S3 and S5 with S4 and S6 off, or by turning on S4 and S6 with S3 and S5 off. These voltages can be output from module 108 over power connection 110. Ports IO3 and IO4 of converter 202 can be connected to (or form) module IO ports 1 and 2 of power connection 110, so as to generate the output voltage for use with output voltages from other modules 108.

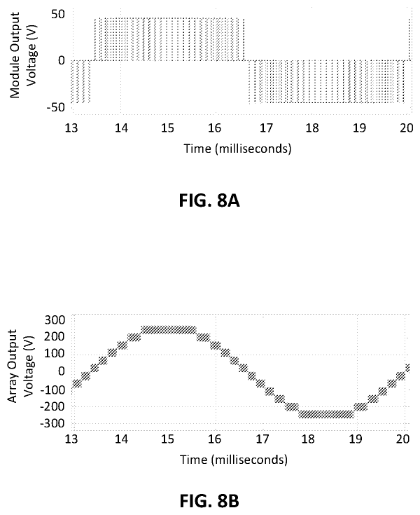

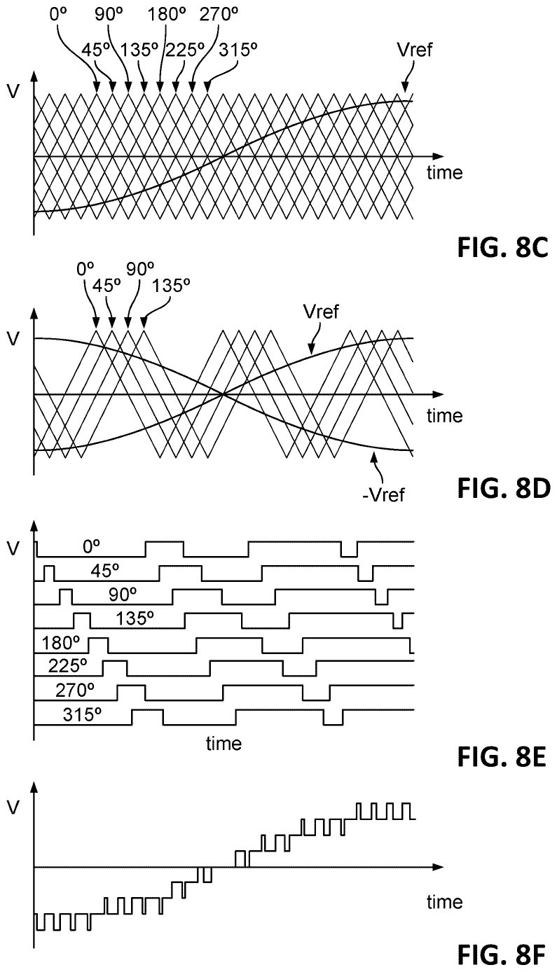

The control or switch signals for the embodiments of converter 202 described herein can be generated in different ways depending on the control technique utilized by system 100 to generate the output voltage of converter 202. In some embodiments, the control technique is a PWM technique such as space vector pulse-width modulation (SVPWM) or sinusoidal pulse-width modulation (SPWM), or variations thereof. FIG. 8A is a graph of voltage versus time depicting an example of an output voltage waveform 802 of converter 202. For ease of description, the embodiments herein will be described in the context of a PWM control technique, although the embodiments are not limited to such. Other classes of techniques can be used. One alternative class is based on hysteresis, examples of which are described in Int'l Publ. Nos. WO 2018/231810A1, WO 2018/232403A1, and WO 2019/183553A1, which are incorporated by reference herein for all purposes.

Each module 108 can be configured with multiple energy sources 206 (e.g., two, three, four, or more). Each energy source 206 of module 108 can be controllable (switchable) to supply power to connection 110 (or receive power from a charge source) independent of the other sources 206 of the module. For example, all sources 206 can output power to connection 110 (or be charged) at the same time, or only one (or a subset) of sources 206 can supply power (or be charged) at any one time. In some embodiments, the sources 206 of the module can exchange energy between them, e.g., one source 206 can charge another source 206. Each of the sources 206 can be configured as any energy source described herein (e.g., battery, HED capacitor, fuel cell). Each of the sources 206 can be the same class (e.g., each can be a battery, each can be an HED capacitor, or each can be a fuel cell), or a different class (e.g., a first source can be a battery and a second source can be an HED capacitor or fuel cell, or a first source can be an HED capacitor and a second source can be a fuel cell).

FIG. 3B is a block diagram depicting an example embodiment of a module 108B in a dual energy source configuration with a primary energy source 206A and a secondary energy source 206B. Ports IO1 and IO2 of primary source 202A can be connected to ports IO1 and IO2 of energy buffer 204. Module 108B includes a converter 202B having an additional IO port. Ports IO3 and IO4 of buffer 204 can be connected ports IO1 and IO2, respectively, of converter 202B. Ports IO1 and IO2 of secondary source 206B can be connected to ports IO5 and IO2, respectively, of converter 202B (also connected to port IO4 of buffer 204).

In this example embodiment of module 108B, primary energy source 202A, along with the other modules 108 of system 100, supplies the average power needed by the load. Secondary source 202B can serve the function of assisting energy source 202 by providing additional power at load power peaks, or absorbing excess power, or otherwise.

As mentioned both primary source 206A and secondary source 206B can be utilized simultaneously or at separate times depending on the switch state of converter 202B. If primary energy source 206A and secondary energy source 206B are utilized at the same time, an electrolytic and/or a film capacitor (C_{ES}) can be placed in parallel with source 206B, as depicted in FIG. 4E, to act as an energy buffer for the source 206B; or energy source 206B can be configured to utilize an HED capacitor in parallel with another energy source (e.g., a battery or fuel cell) as depicted in FIG. 4F.

FIGS. 6B and 6C are schematic views depicting example embodiments of converters 202B and 202C, respectively. Converter 202B includes switch circuitry portions 601 and 602A. Portion 601 includes switches S3 through S6 configured as a full bridge in a similar manner to converter 202A, and is configured to selectively couple IO1 and IO2 to either of IO3 and IO4, thereby changing the output voltages of module 108B. Portion 602A includes switches S1 and S2 configured as a half bridge and coupled between ports IO1 and IO2. A coupling inductor L_{C} is connected between port IO5 and a nodel present between switches S1 and S2 such that switch portion 602A is a bidirectional converter that can regulate (boost or buck) voltage (or inversely current). Switch portion 602A can generate two different voltages at nodel, which are +V_{DCL2} and 0, referenced to port IO2, which can be at virtual zero potential. The current drawn from or input to energy source 202B can be controlled by regulating the voltage on coupling inductor L_{C}, using, for example, a pulse-width modulation technique or a hysteresis control method for commutating switches S1 and S2. Other techniques can also be used.

Converter 202C differs from that of 202B as switch portion 602B includes switches S1 and S2 configured as a half bridge and coupled between ports IO5 and IO2. A coupling inductor L_{C} is connected between port IO1 and a nodel is present between switches S1 and S2 such that switch portion 602B is configured to regulate voltage.

Control system 102 or LCD 114 can independently control each switch of converters 202B and 202C via control input lines 118-3 to each gate. In these embodiments and that of FIG. 6A, LCD 114 (not MCD 112) generates the switching signals for the converter switches. Alternatively, MCD 112 can generate the switching signals, which can be communicated directly to the switches, or relayed by LCD 114. In some embodiments, driver circuitry for generating the switching signals can be present in or associated with MCD 112 and/or LCD 114.

The aforementioned zero voltage configuration for converter 202 (turning on S3 and S5 with S4 and S6 off, or turning on S4 and S6 with S3 and S5 off) can also be referred to as a bypass state for the given module. This bypass state can be entered if a fault is detected in the given module, or if a system fault is detected warranting the shut-off of more than one (or all modules) in an array or system. A fault in the module can be detected by LCD 114 and the control switching signals for converter 202 can be set to engage the bypass state without intervention by MCD 112. Alternatively, fault information for a given module can be communicated by LCD 114 to MCD 112, and MCD 112 can then make a determination whether to engage the bypass state, and if so, can communicate instructions to engage the bypass state to the LCD 114 associated with the module having the fault, at which point LCD 114 can output switching signals to cause engagement of the bypass state.

In embodiments where a module 108 includes three or more energy sources 206, converters 202B and 202C can be scaled accordingly such that each additional energy source 206B is coupled to an additional IO port leading to an additional switch circuitry portion 602A or 602B, depending on the needs of the particular source. For example, a dual source converter 202 can include both switch portions 202A and 202B.

Modules 108 with multiple energy sources 206 are capable of performing additional functions such as energy sharing between sources 206, energy capture from within the application (e.g., regenerative braking), charging of the primary source by the secondary source even while the overall system is in a state of discharge, and active filtering of the module output. The active filtering function can also be performed by modules having a typical electrolytic capacitor instead of a secondary energy source. Examples of these functions are described in more detail in Int'l. Appl. No. PCT/US20/25366, filed Mar. 27, 2020, and titled Module-Based Energy Systems Capable of Cascaded and Interconnected Configurations, and Methods Related Thereto, and Int'l. Publ. No. WO 2019/183553, filed Mar. 22, 2019, and titled Systems and Methods for Power Management and Control, both of which are incorporated by reference herein in their entireties for all purposes.

Each module 108 can be configured to supply one or more auxiliary loads with its one or more energy sources 206. Auxiliary loads are loads that require lower power ratings than the primary load 101. Examples of auxiliary loads can be, for example, an on-board electrical network of an EV, including but not limited to HVAC system, heater system, and DC/DC converters of an EV. The load of system 100 can be, for example, one of the phases of the EV motor or electrical grid. This embodiment can allow a complete decoupling between the electrical characteristics (terminal voltage and current) of the energy source and those of the loads.

FIG. 3C is a block diagram depicting an example embodiment of a module 108C configured to supply power to a first auxiliary load 301 and a second auxiliary load 302, where module 108C includes an energy source 206, energy buffer 204, and converter 202B coupled together in a manner similar to that of FIG. 3B. First auxiliary load 301 requires a voltage equivalent to that supplied from source 206. Load 301 is coupled to IO ports 3 and 4 of module 108C, which are in turn coupled to ports IO1 and IO2 of source 206. Source 206 can output power to both power connection 110 and load 301. Second auxiliary load 302 requires a constant voltage lower than that of source 206. Load 302 is coupled to IO ports 5 and 6 of module 108C, which are coupled to ports IO5 and IO2, respectively, of converter 202B. Converter 202B can include switch portion 602 having coupling inductor Lc coupled to port IO5 (FIG. 6B). Energy supplied by source 206 can be supplied to load 302 through switch portion 602 of converter 202B. It is assumed that load 302 has an input capacitor (a capacitor can be added to module 108C if not), so switches S1 and S2 can be commutated to regulate the voltage on and current through coupling inductor Lc and thus produce a stable constant voltage for load 302. This regulation can step down the voltage of source 206 to the lower magnitude voltage required by load 302.

Module 108C can thus be configured to supply one or more first auxiliary loads in the manner described with respect to load 301, with the one or more first loads coupled to IO ports 3 and 4. Module 108C can also be configured to supply one or more second auxiliary loads in the manner described with respect to load 302. If multiple second auxiliary loads 302 are present, then for each additional load 302 module 108C can be scaled with additional dedicated module output ports (like 5 and 6), an additional dedicated switch portion 602, and an additional converter IO port coupled to the additional portion 602.

Energy source 206 can thus supply power for any number of auxiliary loads (e.g., 301 and 302), as well as the corresponding portion of system output power needed by primary load 101. Power flow from source 206 to the various loads can be adjusted as desired.

Module 108 can be configured as needed with two or more energy sources 206 (FIG. 3B) and to supply first and/or second auxiliary loads (FIG. 3C) through the addition of a switch portion 602 and converter port IO5 for each additional source 206B or second auxiliary load 302. Additional module IO ports (e.g., 3, 4, 5, 6) can be added as needed. Module 108 can also be configured as an interconnection module to exchange energy (e.g., for balancing) between two or more arrays, two or more packs, or two or more systems 100 as described further herein. This interconnection functionality can likewise be combined with multiple source and/or multiple auxiliary load supply capabilities.

Control system 102 can perform various functions with respect to the components of modules 108A, 108B, and 108C. These functions can include management of the utilization (amount of use) of each energy source 206, protection of energy buffer 204 from over-current, over-voltage and high temperature conditions, and control and protection of converter 202.

For example, to manage (e.g., adjust by increasing, decreasing, or maintaining) utilization of each energy source 206, LCD 114 can receive one or more monitored voltages, temperatures, and currents from each energy source 206 (or monitor circuitry). The monitored voltages can be at least one of, preferably all, voltages of each elementary component independent of the other components (e.g., each individual battery cell, HED capacitor, and/or fuel cell) of the source 206, or the voltages of groups of elementary components as a whole (e.g., the voltage of the battery array, HED capacitor array, and/or fuel cell array). Similarly, the monitored temperatures and currents can be at least one of, preferably all, temperatures and currents of each elementary component independent of the other components of the source 206, or the temperatures and currents of groups of elementary components as a whole, or any combination thereof. The monitored signals can be status information, with which LCD 114 can perform one or more of the following: calculation or determination of a real capacity, actual State of Charge (SOC) and/or State of Health (SOH) of the elementary components or groups of elementary components; set or output a warning or alarm indication based on monitored and/or calculated status information; and/or transmission of the status information to MCD 112. LCD 114 can receive module control information (e.g., a modulation index, synchronization signal) from MCD 112 and use this module control information to generate switch signals for converter 202 that manage the utilization of the source 206.

To protect energy buffer 204, LCD 114 can receive one or more monitored voltages, temperatures, and currents from energy buffer 204 (or monitor circuitry). The monitored voltages can be at least one of, preferably all, voltages of each elementary component of buffer 204 (e.g., of C_{EB}, C_{EB1}, C_{EB2}, L_{EB1}, L_{EB2}, D_{EB}) independent of the other components, or the voltages of groups of elementary components or buffer 204 as a whole (e.g., between IO1 and IO2 or between IO3 and IO4). Similarly, the monitored temperatures and currents can be at least one of, preferably all, temperatures and currents of each elementary component of buffer 204 independent of the other components, or the temperatures and currents of groups of elementary components or of buffer 204 as a whole, or any combination thereof. The monitored signals can be status information, with which LCD 114 can perform one or more of the following: set or output a warning or alarm indication; communicate the status information to MCD 112; or control converter 202 to adjust (increase or decrease) the utilization of source 206 and module 108 as a whole for buffer protection.

To control and protect converter 202, LCD 114 can receive the module control information from MCD 112 (e.g., a modulated reference signal, or a reference signal and a modulation index), which can be used with a PWM technique in LCD 114 to generate the control signals for each switch (e.g., S1 through S6). LCD 114 can receive a current feedback signal from a current sensor of converter 202, which can be used for overcurrent protection together with one or more fault status signals from driver circuits (not shown) of the converter switches, which can carry information about fault statuses (e.g., short circuit or open circuit failure modes) of all switches of converter 202. Based on this data, LCD 114 can make a decision on which combination of switching signals to be applied to manage utilization of module 108, and potentially bypass or disconnect converter 202 (and the entire module 108) from system 100.

If controlling a module 108C that supplies a second auxiliary load 302, LCD 114 can receive one or more monitored voltages (e.g., the voltage between IO ports 5 and 6) and one or more monitored currents (e.g., the current in coupling inductor L_{C}, which is a current of load 302) in module 108C. Based on these signals, LCD 114 can adjust the switching cycles (e.g., by adjustment of modulation index or reference waveform) of S1 and S2 to control (and stabilize) the voltage for load 302.

### Cascaded Energy System Topology Examples

Two or more modules 108 can be coupled together in a cascaded array that outputs a voltage signal formed by a superposition of the discrete voltages generated by each module 108 within the array. FIG. 7A is a block diagram depicting an example embodiment of a topology for system 100 where N modules 108-1, 108-2 . . . 108-N are coupled together in series to form a serial array 700. In this and all embodiments described herein, N can be any integer greater than one. Array 700 includes a first system IO port SIO1 and a second system IO port SIO2 across which is generated an array output voltage. Array 700 can be used as a DC or single phase AC energy source for DC or AC single-phase loads, which can be connected to SIO1 and SIO2 of array 700. FIG. 8A is a plot of voltage versus time depicting an example output signal produced by a single module 108 having a 48 volt energy source. FIG. 8B is a plot of voltage versus time depicting an example single phase AC output signal generated by array 700 having six 48V modules 108 coupled in series.

System 100 can be arranged in a broad variety of different topologies to meet varying needs of the applications. System 100 can provide multi-phase power (e.g., two-phase, three-phase, four-phase, five-phase, six-phase, etc.) to a load by use of multiple arrays 700, where each array can generate an AC output signal having a different phase angle.

FIG. 7B is a block diagram depicting system 100 with two arrays 700-PA and 700-PB coupled together. Each array 700 is one-dimensional, formed by a series connection of N modules 108. The two arrays 700-PA and 700-PB can each generate a single-phase AC signal, where the two AC signals have different phase angles PA and PB (e.g., 180 degrees apart). IO port 1 of module 108-1 of each array 700-PA and 700-PB can form or be connected to system IO ports SIO1 and SIO2, respectively, which in turn can serve as a first output of each array that can provide two-phase power to a load (not shown). Or alternatively ports SIO1 and SIO2 can be connected to provide single phase power from two parallel arrays. IO port 2 of module 108-N of each array 700-PA and 700-PB can serve as a second output for each array 700-PA and 700-PB on the opposite end of the array from system IO ports SIO1 and SIO2, and can be coupled together at a common node and optionally used for an additional system IO port SIO3 if desired, which can serve as a neutral. This common node can be referred to as a rail, and IO port 2 of modules 108-N of each array 700 can be referred to as being on the rail side of the arrays.

FIG. 7C is a block diagram depicting system 100 with three arrays 700-PA, 700-PB, and 700-PC coupled together. Each array 700 is one-dimensional, formed by a series connection of N modules 108. The three arrays 700-1 and 700-2 can each generate a single-phase AC signal, where the three AC signals have different phase angles PA, PB, PC (e.g., 120 degrees apart). IO port 1 of module 108-1 of each array 700-PA, 700-PB, and 700-PC can form or be connected to system IO ports SIO1, SIO2, and SIO3, respectively, which in turn can provide three-phase power to a load (not shown). IO port 2 of module 108-N of each array 700-PA, 700-PB, and 700-PC can be coupled together at a common node and optionally used for an additional system IO port SIO4 if desired, which can serve as a neutral.

The concepts described with respect to the two-phase and three-phase embodiments of FIGS. 7B and 7C can be extended to systems 100 generating still more phases of power.

For example, a non-exhaustive list of additional examples includes: system 100 having four arrays 700, each of which is configured to generate a single phase AC signal having a different phase angle (e.g., 90 degrees apart): system 100 having five arrays 700, each of which is configured to generate a single phase AC signal having a different phase angle (e.g., 72 degrees apart); and system 100 having six arrays 700, each array configured to generate a single phase AC signal having a different phase angle (e.g., 60 degrees apart).

System 100 can be configured such that arrays 700 are interconnected at electrical nodes between modules 108 within each array. FIG. 7D is a block diagram depicting system 100 with three arrays 700-PA, 700-PB, and 700-PC coupled together in a combined series and delta arrangement. Each array 700 includes a first series connection of M modules 108, where M is two or greater, coupled with a second series connection of N modules 108, where N is two or greater. The delta configuration is formed by the interconnections between arrays, which can be placed in any desired location. In this embodiment, IO port 2 of module 108-(M+N) of array 700-PC is coupled with IO port 2 of module 108-M and IO port 1 of module 108-(M+1) of array 700-PA, IO port 2 of module 108-(M+N) of array 700-PB is coupled with IO port 2 of module 108-M and IO port 1 of module 108-(M+1) of array 700-PC, and IO port 2 of module 108-(M+N) of array 700-PA is coupled with IO port 2 of module 108-M and IO port 1 of module 108-(M+1) of array 700-PB.

FIG. 7E is a block diagram depicting system 100 with three arrays 700-PA, 700-PB, and 700-PC coupled together in a combined series and delta arrangement. This embodiment is similar to that of FIG. 7D except with different cross connections. In this embodiment, IO port 2 of module 108-M of array 700-PC is coupled with IO port 1 of module 108-1 of array 700-PA, IO port 2 of module 108-M of array 700-PB is coupled with IO port 1 of module 108-1 of array 700-PC, and IO port 2 of module 108-M of array 700-PA is coupled with IO port 1 of module 108-1 of array 700-PB. The arrangements of FIGS. 7D and 7E can be implemented with as little as two modules in each array 700. Combined delta and series configurations enable an effective exchange of energy between all modules 108 of the system (interphase balancing) and phases of power grid or load, and also allows reducing the total number of modules 108 in an array 700 to obtain the desired output voltages.

In the embodiments described herein, although it is advantageous for the number of modules 108 to be the same in each array 700 within system 100, such is not required and different arrays 700 can have differing numbers of modules 108. Further, each array 700 can have modules 108 that are all of the same configuration (e.g., all modules are 108A, all modules are 108B, all modules are 108C, or others) or different configurations (e.g., one or more modules are 108A, one or more are 108B, and one or more are 108C, or otherwise). As such, the scope of topologies of system 100 covered herein is broad.

### Control Methodology Examples

As mentioned, control of system 100 can be performed according to various methodologies, such as hysteresis or PWM. Several examples of PWM include space vector modulation and sine pulse width modulation, where the switching signals for converter 202 are generated with a phase-shifted carrier technique that continuously rotates utilization of each module 108 to equally distribute power among them.

FIGS. 8C-8F are plots depicting an example embodiment of a phase-shifted PWM control methodology that can generate a multilevel output PWM waveform using incrementally shifted two-level waveforms. An X-level PWM waveform can be created by the summation of (X−1)/2 two-level PWM waveforms. These two-level waveforms can be generated by comparing a reference waveform Vref to carriers incrementally shifted by 360°/(X−1). The carriers are triangular, but the embodiments are not limited to such. A nine-level example is shown in FIG. 8C (using four modules 108). The carriers are incrementally shifted by 360°/(9−1)=45° and compared to Vref. The resulting two-level PWM waveforms are shown in FIG. 8E. These two-level waveforms may be used as the switching signals for semiconductor switches (e.g., S1 through S6) of converters 202. As an example with reference to FIG. 8E, for a one-dimensional array 700 including four modules 108 each with a converter 202, the 0° signal is for control of S3 and the 180° signal for S6 of the first module 108-1, the 45° signal is for S3 and the 225° signal for S6 of the second module 108-2, the 90 signal is for S3 and the 270 signal is for S6 of the third module 108-3, and the 135 signal is for S3 and the 315 signal is for S6 of the fourth module 108-4. The signal for S3 is complementary to S4 and the signal for S5 is complementary to S6 with sufficient dead-time to avoid shoot-through of each half-bridge. FIG. 8F depicts an example single phase AC waveform produced by superposition (summation) of output voltages from the four modules 108.

An alternative is to utilize both a positive and a negative reference signal with the first (N−1)/2 carriers. A nine-level example is shown in FIG. 8D. In this example, the 0° to 135° switching signals (FIG. 8E) are generated by comparing +Vref to the 0° to 135° carriers of FIG. 8D and the 180° to 315° switching signals are generated by comparing −Vref to the 0° to 135° carriers of FIG. 8D. However, the logic of the comparison in the latter case is reversed. Other techniques such as a state machine decoder may also be used to generate gate signals for the switches of converter 202.

In multi-phase system embodiments, the same carriers can be used for each phase, or the set of carriers can be shifted as a whole for each phase. For example, in a three-phase system with a single reference voltage (Vref), each array 700 can use the same number of carriers with the same relative offsets as shown in FIGS. 8C and 8D, but the carriers of the second phase are shifted by 120 degrees as compared to the carriers of the first phase, and the carriers of the third phase are shifted by 240 degrees as compared to the carriers of the first phase. If a different reference voltage is available for each phase, then the phase information can be carried in the reference voltage and the same carriers can be used for each phase. In many cases, the carrier frequencies will be fixed, but in some example embodiments, the carrier frequencies can be adjusted, which can help to reduce losses in EV motors under high current conditions.

The appropriate switching signals can be provided to each module by control system 102. For example, MCD 112 can provide Vref and the appropriate carrier signals to each LCD 114 depending upon the module or modules 108 that LCD 114 controls, and the LCD 114 can then generate the switching signals. Or all LCDs 114 in an array can be provided with all carrier signals and the LCD can select the appropriate carrier signals.

The relative utilization of each module 108 can be adjusted based on status information to perform balancing of one or more parameters as described herein. Balancing of parameters can involve adjusting utilization to minimize parameter divergence over time as compared to a system where individual module utilization adjustment is not performed. The utilization can be the relative amount of time a module 108 is discharging when system 100 is in a discharge state, or the relative amount of time a module 108 is charging when system 100 is in a charge state.

As described herein, modules 108 can be balanced with respect to other modules in an array 700, which can be referred to as intra-array or intraphase balancing, and different arrays 700 can be balanced with respect to each other, which can be referred to as inter-array or interphase balancing. Arrays 700 of different subsystems can also be balanced with respect to each other. Control system 102 can simultaneously perform any combination of intraphase balancing, interphase balancing, utilization of multiple energy sources within a module, active filtering, and auxiliary load supply.

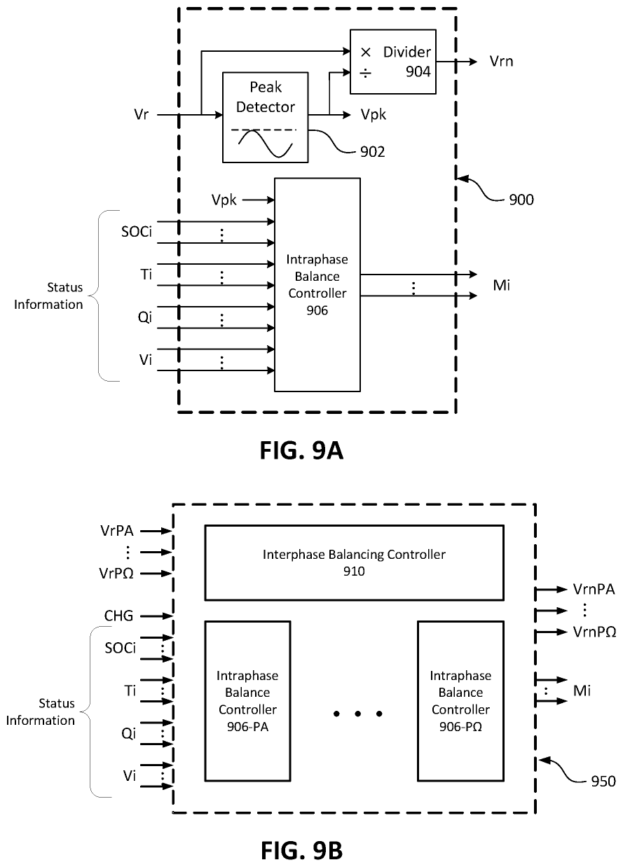

FIG. 9A is a block diagram depicting an example embodiment of an array controller 900 of control system 102 for a single-phase AC or DC array. Array controller 900 can include a peak detector 902, a divider 904, and an intraphase (or intra-array) balance controller 906. Array controller 900 can receive a reference voltage waveform (Vr) and status information about each of the N modules 108 in the array (e.g., state of charge (SOCi), temperature (Ti), capacity (Qi), and voltage (Vi)) as inputs, and generate a normalized reference voltage waveform (Vrn) and modulation indexes (Mi) as outputs. Peak detector 902 detects the peak (Vpk) of Vr, which can be specific to the phase that controller 900 is operating with and/or without balancing. Divider 904 generates Vrn by dividing Vr by its detected Vpk. Intraphase balance controller 906 uses Vpk along with the status information (e.g., SOCi, Ti, Qi, Vi, etc.) to generate modulation indexes Mi for each module 108 within the array 700 being controlled.

The modulation indexes and Vrn can be used to generate the switching signals for each converter 202. The modulation index can be a number between zero and one (inclusive of zero and one). For a particular module 108, the normalized reference Vrn can be modulated or scaled by Mi, and this modulated reference signal (Vrnm) can be used as Vref (or −Vref) according to the PWM technique described with respect to FIGS. 8C-8F, or according to other techniques. In this manner, the modulation index can be used to control the PWM switching signals provided to the converter switching circuitry (e.g., S3-S6 or S1-S6), and thus regulate the operation of each module 108. For example, a module 108 being controlled to maintain normal or full operation may receive an Mi of one, while a module 108 being controlled to less than normal or full operation may receive an Mi less than one, and a module 108 controlled to cease power output may receive an Mi of zero. This operation can be performed in various ways by control system 102, such as by MCD 112 outputting Vrn and Mi to the appropriate LCDs 114 for modulation and switch signal generation, by MCD 112 performing modulation and outputting the modulated Vrnm to the appropriate LCDs 114 for switch signal generation, or by MCD 112 performing modulation and switch signal generation and outputting the switch signals to the LCDs or the converters 202 of each module 108 directly. Vrn can be sent continually with Mi sent at regular intervals, such as once for every period of the Vrn, or one per minute, etc.

Controller 906 can generate an Mi for each module 108 using any type or combination of types of status information (e.g., SOC, temperature (T), Q, SOH, voltage, current) described herein. For example, when using SOC and T, a module 108 can have a relatively high Mi if SOC is relatively high and temperature is relatively low as compared to other modules 108 in array 700. If either SOC is relatively low or T is relatively high, then that module 108 can have a relatively low Mi, resulting in less utilization than other modules 108 in array 700. Controller 906 can determine Mi such that the sum of module voltages does not exceed Vpk. For example, Vpk can be the sum of the products of the voltage of each module's source 206 and Mi for that module (e.g., Vpk=M₁V₁+M₂V₂+M₃V₃ . . . +M_{N}V_{N}, etc). A different combination of modulation indexes, and thus respective voltage contributions by the modules, may be used but the total generated voltage should remain the same.

Controller 900 can control operation, to the extent it does not prevent achieving the power output requirements of the system at any one time (e.g., such as during maximum acceleration of an EV), such that SOC of the energy source(s) in each module 108 remains balanced or converges to a balanced condition if they are unbalanced, and/or such that temperature of the energy source(s) or other components (e.g., energy buffer) in each module remains balanced or converges to a balanced condition if they are unbalanced. Power flow in and out of the modules can be regulated such that a capacity difference between sources does not cause an SOC deviation. Balancing of SOC and temperature can indirectly cause some balancing of SOH. Voltage and current can be directly balanced if desired, but in many embodiments the main goal of the system is to balance SOC and temperature, and balancing of SOC can lead to balance of voltage and current in a highly symmetric system where modules are of similar capacity and impedance.

Since balancing all parameters, e.g., operating characteristics, may not be possible at the same time (e.g., balancing of one parameter may further unbalance another parameter), a combination of balancing any two or more parameters (SOC, T, Q, SOH, V, I) may be applied with priority given to either one depending on the requirements of the application. Priority in balancing can be given to SOC over other parameters (T, Q, SOH, V, I), with exceptions made if one of the other parameters (T, Q, SOH, V, I) reaches a severe unbalanced condition outside a threshold.

Balancing between arrays 700 of different phases (or arrays of the same phase, e.g., if parallel arrays are used) can be performed concurrently with intraphase balancing. FIG. 9B depicts an example embodiment of an Ω-phase (or Ω-array) controller 950 configured for operation in an Ω-phase system 100, having at least Ω arrays 700, where Ω is any integer greater than one. Controller 950 can include one interphase (or inter-array) controller 910 and Ω intraphase balance controllers 906-PA . . . 906-PΩ for phases PA through PΩ, as well as peak detector 902 and divider 904 (FIG. 9A) for generating normalized references VrnPA through VrnPΩ from each phase-specific reference VrPA through VrPΩ. Intraphase controllers 906 can generate Mi for each module 108 of each array 700 as described with respect to FIG. 9A. Interphase balance controller 910 is configured or programmed to balance aspects of modules 108 across the entire multi-dimensional system, for example, between arrays of different phases. This may be achieved through injecting common mode to the phases (e.g., neutral point shifting) or through the use of interconnection modules (described herein) or through both. Common mode injection involves introducing a phase and amplitude shift to the reference signals VrPA through VrPΩ to generate normalized waveforms VrnPA through VrnPΩ to compensate for unbalance in one or more arrays, and is described further in Int'l. Appl. No. PCT/US20/25366 incorporated herein.

Controllers 900 and 950 (as well as balance controllers 906 and 910) can be implemented in hardware, software, or a combination thereof within control system 102. Controllers 900 and 950 can be implemented within MCD 112, distributed partially or fully among LCDs 114, or may be implemented as discrete controllers independent of MCD 112 and LCDs 114.

### Interconnection (IC) Module Examples

Modules 108 can be connected between the modules of different arrays 700 for the purposes of exchanging energy between the arrays, acting as a source for an auxiliary load, or both. Such modules are referred to herein as interconnection (IC) modules 108IC. IC module 108IC can be implemented in any of the already described module configurations (108A, 108B, 108C) and others to be described herein. IC modules 108IC can include any number of one or more energy sources, an optional energy buffer, switch circuitry for supplying energy to one or more arrays and/or for supplying power to one or more auxiliary loads, control circuitry (e.g., a local control device), and monitor circuitry for collecting status information about the IC module itself or its various loads (e.g., SOC of an energy source, temperature of an energy source or energy buffer, capacity of an energy source, SOH of an energy source, voltage and/or current measurements pertaining to the IC module, voltage and/or current measurements pertaining to the auxiliary load(s), etc.).

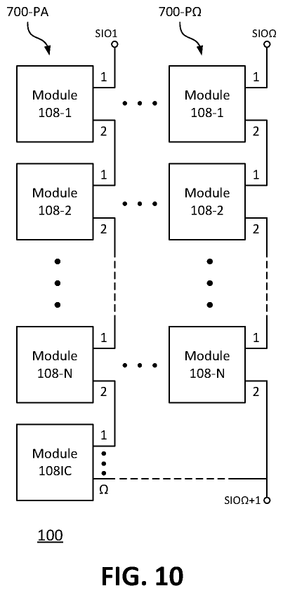

FIG. 10 is a block diagram depicting an example embodiment of a system 100 capable of producing Ω-phase power with Ω arrays 700-PA through 700-PΩ, where Ω can be any integer greater than one. In this and other embodiments, IC module 108IC can be located on the rail side of arrays 700 such that the arrays 700 to which module 108IC are connected (arrays 700-PA through 700-PΩ in this embodiment) are electrically connected between module 108IC and outputs (e.g., SIO1 through SIOS2) to the load. Here, module 108IC has Ω IO ports for connection to IO port 2 of each module 108-N of arrays 700-PA through 700-PΩ. In the configuration depicted here, module 108IC can perform interphase balancing by selectively connecting one or more energy sources of module 108IC to one or more of the arrays 700-PA through 700-PΩ (or to no output, or equally to all outputs, if interphase balancing is not required). System 100 can be controlled by control system 102 (not shown, see FIG. 1A).

### Second Life Energy Source Examples

Energy sources 206 described herein can be used in systems 100 described herein in both first life and second life applications. A first life of a source 206 is an original application in which source 206 is used. For example, the first life application is the first implementation in which sources 206 are put to use by the first customer of sources 206 after their original manufacture (and not refurbishment). The user of sources 206 in their first life will typically have received sources 206 from the manufacturer, distributor, or original equipment manufacturer (OEM). Batteries 206 used in a first life application will typically have the same electrochemistry (e.g., will have the same variant of lithium ion electrochemistry (e.g., LFP, NMC)) and will have the same nominal voltage and will have a capacity variation across the pack or system that is minimal (e.g., 5% or less). Use of an energy storage system with batteries 206 in their first life application will result in batteries 206 having a longer lifespan in that first life application, and upon removal from that first life application, the batteries 206 will be more similar in terms of capacity degradation than batteries from a first life application not using the energy storage system.

As used herein, a “second life” application is any application or implementation after the first life application (e.g., a second implementation, third implementation, fourth implementation, etc.) of source 206. A second life energy source refers to any energy source (e.g., battery or HED capacitor) implemented in that source's second life application.

An example of a first life application for batteries 206 is within an energy storage system for an EV. Then, at the end of that life (e.g., after 100,000 miles of driving, or after degradation of the batteries within that battery pack by a threshold amount), the batteries 206 can be removed from the battery pack, optionally subjected to refurbishing and testing, and then implemented in a second life application that can be, e.g., used within a stationary energy storage system (e.g., residential, commercial, or industrial energy buffering, EV charging station energy buffering, renewable source (e.g., wind, solar, hydroelectric), energy buffering, and the like) or another mobile energy storage system (e.g., battery pack for an electric car, bus, train, or truck). Similarly, the first life application can be a first stationary application and the second life application can be a stationary or mobile application.

For the second life application, sources 206 can be selected and/or utilized by system 100 to minimize (or at least reduce) any differences in initial capacity and nominal voltage. For example, sources 206 having a capacity difference of 5% or more can be included within system 100 and operated to provide energy for a load. In another example, an operator or automated system can select sources 206 for system 100 that have a capacity difference within a threshold amount, e.g., to reduce the initial capacity differences between sources of system 206. If modules 108 are compatible with both the first and second life application (e.g., with or without reconfiguration), modules 108 can be selected for the second life application based on the capacity difference of sources 206 of modules 108.

System 100 can adjust utilization of each source 206 individually such that sources 206 within system 100 or packs of system 100 are relatively balanced in terms of SOC or total charge (SOC times capacity) as the pack or system 100 is discharged, even though the sources 206 in system 100 can have widely varying capacities. Similarly, system 100 can maintain balance as the pack or system 100 is charged. Sources 206 can vary not only in terms of capacity but also in nominal voltage, power rating, electrochemical type (e.g., a combination of LFP and NMC batteries) and the like. Thus, system 100 can be used such that all modules 206 within system 100 or each pack of system 100 are second life energy sources (or such that a combination of first life and second life energy sources are used), having various combinations of different characteristics.

In one example, system 100 can include second life energy sources 206 (and optionally one or more first life energy sources 206) having energy capacity variations of 2% or more, 5% or more, 10% or more, 15% or more, 20% or more, or 25% or more, 30% or more, 5-30%, 10-30%, and/or 20-30%.

In another example, system 100 can include second energy life sources 206 (and optionally one or more first life energy sources 206) having energy capacity per mass density variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having peak power per mass density variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having nominal voltage variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having operating voltage range variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having maximum specified current rise time variations of 2% or more, 5% or more, 10% or more, 15% or more, 20% or more, or 25% or more, 30% or more, 5-30%, 10-30%, and/or 20-30%.

In another example, system 100 can include second life energy sources 206 (and optionally one or more first life energy sources 206) having specified peak current variations of 2% or more, 5% or more, 10% or more, 15% or more, 20% or more, or 25% or more, 30% or more, 5-30%, 10-30%, and/or 20-30%.

A variation of X % (e.g., 5% or more, or 5 to 30%) can be met by a variation between the module 108 having the highest value for that parameter and the module 108 having the lowest value for that parameter within system 100. For example, a variation of 5% or more in capacity can be met by a system 100 where the module 108 with the lowest capacity source 206 has a capacity that is 95% or less than that of the module 108 with the highest capacity source 206. For each and every embodiment and parameter disclosed herein, the time at which the system 100 having one or more second life sources satisfies the X % variation condition in that parameter can be at installation of the system 100, at commissioning of the system 100, after replacement of one source 206 with another source 206, after operation of system 100 for 10 hours or more, after operation of system 100 for 100 hours or more, after operation of system 100 for 1000 hours or more, and/or after operation of system 100 for 10,000 hours or more. For example, a variation of capacity of 5% or more can occur after system 100 is operated for 1000 hours, even though the variation in capacity was not present at the time of commissioning. This reflects the capability of the embodiments of system 100 to continue to operate with and account for capacity differences between sources 206 that grow over time of operation.

In another example, system 100 can include second life energy sources 206 (and optionally one or more first life energy sources 206) having variations of electrochemical type (e.g., lithium ion batteries with non-lithium ion batteries, or different lithium ion batteries (e.g., any combination of NMC, LFP, LTO, or other lithium ion battery types).

System 100 can include second life energy sources 206 (and optionally one or more first life energy sources 206) having any combination of the characteristics provides in the preceding examples.

### Supplemental Signal Conversion Device (SSCD) Examples

Example embodiments of modular energy systems 100 that include arrays 700 for providing AC power to one or more AC loads, e.g., primary AC loads, and a supplemental signal conversion device (SSCD) for providing DC power to DC loads, e.g., auxiliary DC loads, will now be described with reference to FIGS. 11-15K. These embodiments can be implemented with all aspects of system 100 described with reference to FIGS. 1A-10F unless stated otherwise or logically implausible. As such, the many variations contemplated herein will not be repeated with respect to each of the following SSCD embodiments.

FIG. 11 is a block diagram of an example embodiment of a modular energy system 100 having a module pack 1110 and an SSCD 1120. Module pack 1110 includes multiple arrays 700 that can be arranged and/or connected in various ways as described herein to provide power to one or more first loads 101-1, 101-2, which can be referred to as primary loads, and to SSCD 1120 for powering one or more second loads 301-1 . . . 301-N, which can be referred to as auxiliary loads.

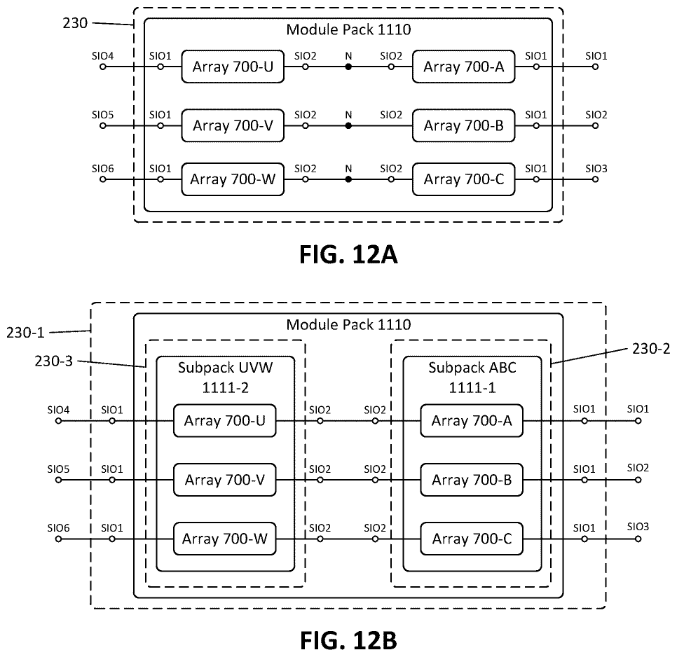

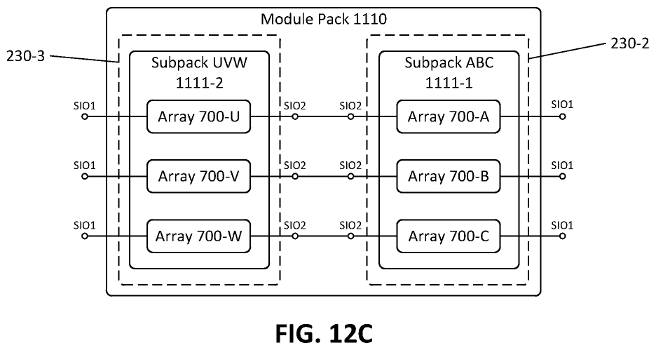

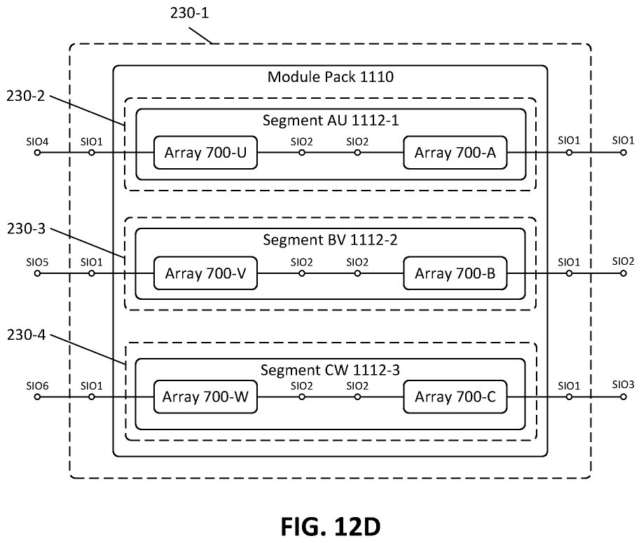

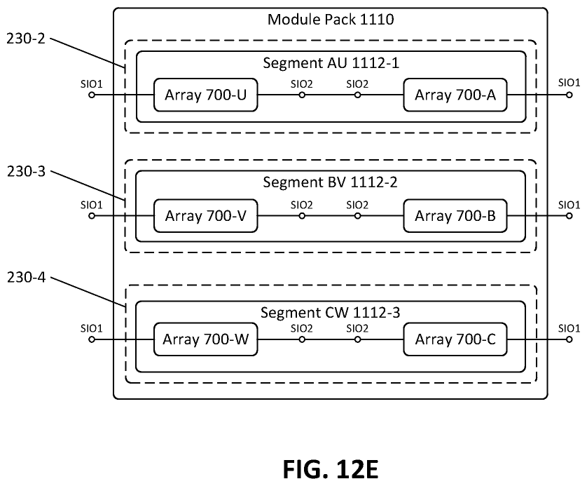

Module pack 1110 can include any number of arrays 700 and each array 700 can include any number of modules 108. Module pack 1110 can be a form of a pack, which as described above, can refer to a common housing containing modules 108. However, in some embodiments, arrays 700 of module pack 1110 can be arranged in multiple packs each in their own independent and discrete housings, outside of a pack (e.g., without any common housing), or in multiple subpacks that may or may not be contained in a common housing. A subpack can refer to a group of arrays 700 that be combined with one or more other subpacks to form a module pack 1110. For example, a subpack can be a multiphase subpack with one or more arrays for each phase or a single phase subpack with one or more arrays for a single phase. Each subpack may or may not be housed separately. Example arrangements of arrays 700 in housings 230 are illustrated in FIGS. 12A-12E and described below.

Although shown outside of module pack 1110, SSCD 1120 and/or SSCD control device 1122 can be included in the same housing 230 as arrays 700 of module pack 1110. In some embodiments, SSCD 1120 and SSCD control device 1122 are in a common housing 230 different from module pack 1110, in different housings 230, or without a housing 230.

Module pack 1110 is coupled to one or more loads 101. In some embodiments, each load 101 is an AC load that is powered by an AC signal provided by module pack 1110. Each load 101 can be a single-phase AC load or a multiphase AC load. An array 700 of module pack 1110 can be coupled to a single-phase AC load 101. Multiple arrays 700 of module pack 1110 can be coupled to a multiphase AC load 101, e.g., one array 700 per phase where each array 700 coupled to load 101 has a different phase.

In the illustrated embodiment, module pack 1110 includes six arrays, arrays 700-A, 700-B, 700-C, 700-U, 700-V, and 700-W. Here, array 700-A is coupled with array 700-U, array 700-B is coupled with array 700-V, and array 700-C is coupled with array 700-W. Coupling arrays 700 in this manner enables flexible arrangements where the arrays 700 can power multiple AC loads or two arrays 700 are combined to provide additional power for a phase of a load 101, in addition to providing power for auxiliary loads. As described in more detail below, each array 700 can include a first port and a second port across which an AC signal is generated by array 700. Depending on the configuration and/or operation of array 700, the first port can be a phase port and the second port can be a neutral port, or the first port can be a neutral port and the second port can be a phase port. The phase port is the port to which array 7000 outputs a varying amplitude signal and the neutral port is the port that is maintained as a neutral potential, e.g., at or near ground potential.

The neutral ports of two or more arrays 700 can be coupled together at, or to form, a common neutral point (or node) for the two or more arrays 700. For example, the neutral port of array 700-A can be coupled to the neutral port of array 700-U at a common neutral point (or node) between arrays 700-A and 700-U. Each other pair of arrays 700 can be coupled together in the same manner.

In some embodiments, two or more arrays can be coupled together to form a larger array that outputs a single phase AC signal. For example, arrays 700-A and 700-U can be coupled together to output a single phase AC signal. In this example, the arrays 700-A and 700-U can be configured such that the phase port of one array 700-A or 700-U is coupled to the neutral port of the other array 700-A or 700-U.

Each pair of arrays 700 together can be configured to generate an AC signal having the same phase. For example, the AC signals output by arrays 700-A and 700-U can have a first phase angle, the AC signals output by arrays 700-B and 700-V can have a second phase angle, and the AC signals output by arrays 700-C and 700-W can have a third phase angle. The first phase angle can be offset by 120 degrees from the second phase angle, which can be offset from the third phase angle by 120 degrees, which can be offset from the first phase angle. Thus, module pack 1110 can be configured to output a three-phase AC signal at the phase terminals of arrays 700-A, 700-B, and 700-C, and another three-phase AC signal at the phase terminals of arrays 700-U, 700-V, and 700-W. The two three-phase AC signals can be in phase with each other or out of phase.

In some embodiments, the three-phase output of arrays 700-A, 700-B, and 700-C can be coupled to one load 101-1 (e.g., a front axle motor) and the three-phase output of arrays 700-U, 700-V, and 700-W can be coupled to another load 101-2 (e.g., a rear axle motor). In some embodiments, three-phase output of arrays 700-A, 700-B, and 700-C and the three-phase output of arrays 700-U, 700-V, and 700-W can be coupled to the same load 101-1. For example, this configuration can provide power to an open-end winding motor (which can also be referred to as an open-winding motor) load 101-1. In some embodiments, arrays 700-A and 700-U are coupled together to form a larger array 700-AU; arrays 700-B and 700-V are coupled together to form a larger array 700-BV; and arrays 700-C and 700-W are coupled together to form a larger array 700-CW. In this embodiment, the three-phase output of the three larger arrays 700-AU, 700-BV, and 700-CW can be coupled to one load 101-1. Thus, the adjustable configuration of arrays 700-A to 700-W in module pack 1110 provides flexibility in powering different loads 101-1 using the same module pack 1110.

A group of two or more arrays 700 that are coupled together at their neutral ports, or between the neutral port of one array 700 and the phase port of another array 700, can be referred to as a segment. As also illustrated in FIG. 12D, arrays 700-A and 700-U are coupled to form a first segment, 700-B and 700-V are coupled to form a second segment, and arrays 700-C and 700-W are coupled to form a third segment. Although each of these segments include two arrays 700, segments can include more than two arrays 700 or two or more sub-arrays. For example, module pack 1110 can include segments having four arrays each to provide power to four loads 101 that are each powered by a single three-phase AC signal or to two loads 101 that are each powered by two three-phase AC signals. Although in these examples, only one load 101 is powered by each three-phase AC signal, each three-phase AC signal can power multiple loads 101. For example, the phase terminals of arrays 700-A, 700-B, and 700-C can be coupled to multiple AC loads 101.

Module pack 1110 can also be configured to output multiphase AC signals other than three-phase AC signals. For example, module pack 1110 can include six segments to output one or more six-phase AC signals. Module pack 1110 can also be configured to output more than two of the same multiphase signal. For example, module pack 1110 can include one or more duplicates of arrays 700-A to 700-W.

Module pack 1110 is communicatively coupled with control system 102 over communication path or link 1131. As described herein, control system 102 can include MCD 112 and multiple LCDs 114. Control system 102 can also include controller 900 and/or controller 950, e.g., as part of MCD 112 and/or LCDs 114 or as separate components. For example, control system 102 can include an MCD 112 for each array 700 of module pack 1110, an MCD 112 for all arrays of module pack 1110, an MCD 112 for each segment, and/or other arrangements of MCD(s) 112 for modules 108 of arrays 700. Control system 102 can also include an array controller 900 for each array 700 or controller 950 for multiple arrays 700, e.g., for all arrays 700 of module pack 1110 or a controller 950 for each group of arrays 700 configured to output a three-phase signal (e.g., a controller 950 of arrays 700-A to 700-C and a controller 950 for arrays 700-U to 700-W). Various other arrangements of MCDs 112, LCDs 114, and controllers 900 and/or 950 can also be used.

Control system 102 can be included in the same housing 230 as arrays 700 of module pack 1110 or in a different housing. Control system 102 can also be distributed between multiple housings 230, e.g., with LCDs 114 contained in the same housing 230 as modules 108, and with MCD 112, controller 900 and/or 950 in one or more different housings 230.

As described herein, control system 102 is configured to control modules 108 based on status information received from modules 108. Control system 102 can also be configured to control modules 108 based on the external control information, e.g., processed external control information, received from SSCD control device 1122, as described in more detail below. Control system 102 can be communicatively coupled to SSCD control device 1122 over communication path or link 1133.

SSCD control device 1122 is also communicatively coupled to SSCD 1120 over communication path or link 1132. SSCD 1120 is configured to convert an AC signal from module pack 1110 into a DC signal and output the DC signal to one or more loads 301 over one or more DC power buses 1136. SSCD 1120 can be or include a rectifier circuit configured to convert the AC signal into a DC signal. The rectifier circuit can include an arrangement of diodes and/or a filter circuit, as described in detail below.

Module pack 1110 is coupled to SSCD 1120 by way of a cable 1134 or other appropriate group of conductors. Cable 1134 can have different configurations of connectors, as described in detail below.

SSCD control device 1122 can control SSCD 1120 to regulate the DC signal output by SSCD 1120. SSCD 1120 can also be configured to balance one or more operating characteristics of modules 108, arrays 700, and/or subpacks of module pack 1110. As described herein, these operating characteristics can include, for example, SOC, SOH, temperature, voltage, current, SOP, and/or SOE.

As described in more detail below, SSCD control device 1122 can be configured to control SSCD 1120 to regulate the DC signal output by SSCD 1120 and/or to balance one or more of the operating characteristics by processing external control information received from external control device 104 and providing the processed external control information to control system 102 over communication path or link 1133. SSCD control device 1122 can be communicatively coupled to external control device 104 over communication path or link 1135.

SSCD control device 1122 can be configured to perform one or more types of balancing. SSCD control device 1122 can be configured to perform subpack balancing between one or more types of subpacks of module pack 1110. For example, SSCD control device 1122 can be configured to balance one or more operating characteristics of a subpack that includes arrays 700-A to 700-C, which can be referred to as a multiphase subpack, with one or more corresponding operating characteristics of a subpack that includes arrays 700-U to 700-W. In another example, SSCD control device 1122 can be configured to balance one or more operating characteristics of subpack that includes arrays 700-A and 700-U, which can be referred to as a segment subpack or simply as a segment as described above, with one or more corresponding operating characteristics of a subpack that includes arrays 700-B and 700-V and/or with one or more corresponding operating characteristics of a subpack that includes arrays 700-C and 700-W.

SSCD control device 1122 and/or control system 102 can be configured to determine operating characteristics for arrays 700 and/or subpacks of arrays 700 based on operating characteristics of modules 108 in arrays 700. The operating characteristics for an array 700 or subpack can include an aggregate value of the operating characteristic across modules 108 in the array 700 or the subpack. The aggregate value can be a sum or a measure of central tendency (e.g., an average or median) of the values across modules 108 in the array 700 or the subpack. The modules 108 used in the aggregate values can include all modules 108 in the array 700 or the subpack, or only active modules 108 in the array 700 or subpack. The values of inactive modules 108 that are being bypassed can be ignored in some embodiments.

Module pack 1110 is also coupled to charge source 150. Charge source 150 can be used to charge energy sources 206 of modules 108. As described in more detail below, control system 102 (or SSCD control device 1122) can be configured to control components, e.g., switches, of system 100 to route a charging signal provided by charge source 150 to arrays 700 of module pack 1110.

SSCD control device 1122 can be implemented in hardware, software, or a combination thereof. SSCD control device 1122 can be implemented as a discrete controller independent of control system 102 or within control system 102. For example, SSCD control device 1122 can be a control device of control system 102, or operations described as being performed by SSCD control device 1122 can be performed by MCD(s) 112 and/or LCD(s) 114 of control system 102.

System 100 can be implemented to provide power to loads 101 and 301 of an EV. In this example, load 101-1 and/or load 101-2 can be EV motors and loads 301 can be auxiliary DC loads of the EV. In an EV example, the auxiliary DC loads 301 can include, for example, the HVAC system of the EV, the on-board electrical network of the EV, battery heaters for batteries of modules 108 of module pack 1110, DC/DC converter(s), and/or other DC loads of the EV. System 100 can also be implemented in stationary applications to provide power to stationary loads 101 and 301.

In EV embodiments, module pack 1110 can be configured to provide AC power to one or more EV motors 101 and to provide AC power to SSCD 1120 for providing DC power to auxiliary DC loads 301. The auxiliary DC loads 301 can include a power distribution unit (PDU) that provides power to other auxiliary loads 301. A PDU auxiliary load 301 can include a voltage converter and/or a current converter that converts the DC signal received from SSCD 1120 to the appropriate voltage and/or current for these auxiliary loads 301. The converters can be DC/DC converters and/or DC/AC converters, depending on the auxiliary loads 301 coupled to PDU 301.

When installed on or in an EV, module pack 1110, SSCD 1120, control system 102 and SSCD control device 1122 can be arranged in various configurations. For example, SSCD 1120 and SSCD control device 1122 can be contained in a common housing 230, which can also contain one or more PDUs 301, be located near PDU(s) 301, or located in a PDU 301. In another example, module pack 1110 and SSCD 1120 can be contained in a common housing 230, which may also contain control system 102 and/or SSCD control device 1122. This housing 230 can be located near PDU 301, e.g., to reduce losses between SSCD 1120 and the one or more PDUs 301.

Module pack 1110 can be implemented in various forms. For example, module pack 1110 can be in the form of a flat battery pack or a tunnel battery pack. Including SSCD 1120 inside the housing 230 of module pack 1112 or close thereto allows for shorter signal routing between voltage and current sensors of SSCD 1120 and control system 102 of module pack 1110. In some embodiments, SSCD 1120 is placed inside PDU 301. In such embodiments, the location of PDU 301 may be defined based on packaging constraints of PDU 301. PDU 301 can be located close to charge port 1330 (FIG. 13A) and have short DC cables between charge port 1330 and SSCD 1120. One or more PDUs 301 can also located be under the hood of the EV, below the cargo area of the EV, or in other areas of the EV.

Some EVs (and other applications of system 100) include high-voltage DC loads and low-voltage DC loads. For example, an EV can include DC loads having voltage levels that are the same or close to the voltage level of the motors of the EV. SSCD 1120 can be configured to output DC power having the same or similar voltage level as the AC power provided to the motor(s) 101. This DC power can be provided, e.g., directly, to the high voltage DC loads 301. In addition, the PDU 301 can convert this DC power to lower voltage levels for the low-voltage DC loads 301.

In a particular example, some EV motors are configured to be powered by an AC signal output by an inverter coupled to a 400VDC link. The inverter can be configured to output a 400VAC peak (310 VAC RMS) line-to-line AC signal to the EV motor. Some high-voltage DC loads of EVs operate at 400VDC, while some low-voltage DC loads of EVs operate at 48VDC or 12VDC. Module pack 1110 can be configured to output 400VAC across the ports of each array 700-A, 700-B, and 700-C and to output 400VAC across the ports of each array 700-U, 700-V, and 700-W. For 800V motors, both of these AC signals can be routed to the motor. SSCD 1120 can be configured to convert one or both 400VAC output signals to 400VDC for powering the 400VDC loads and/or for the PDU to convert to 48VDC and/or 12VDC for the low-voltage DC loads. These voltage values are provided to illustrate an example EV embodiment only. Module pack 1110 can be configured to output higher and lower AC voltages, and SSCD 1120 can be configured to convert these higher and lower AC voltages to DC voltages of various levels and to regulate the DC voltages. For example, higher voltage values may be used in embodiments configured for other mobile entities, such as trains, trams, ships, vessels, aircraft, and spacecraft and/or in stationary applications.

Module pack 1110 and SSCD 1120 can operate similarly or in the same manner in stationary applications. For example, module pack 1110 can be configured to output AC power at an appropriate voltage level for AC loads 101 and/or DC loads 301. SSCD 1120 can be configured to convert the AC power to DC power at the same or similar voltage level for DC loads that operate at those voltage levels. A PDU 301 can convert the DC voltage output by SSCD 1120 to different voltage and/or current levels for loads 301 coupled to the PDU 301.

Module pack 1110 and SSCD 1120 can be configured to provide power to lower voltage loads, and PDU 301 can convert the lower voltage to a higher voltage for higher voltage DC loads. For example, module pack 1110 can be configured to output 120VAC power and SSCD 1120 can be configured to convert the 120VAC to 120VDC, or another appropriate voltage level. PDU 301 can include a DC/DC converter configured to convert the 120VDC to 400VDC (or another voltage level) for higher voltage loads 301.

Using arrays 700 of modules 108 in this way provides a robust and modular power supply for various applications. For example, if one or more modules 108 of an array 700 fails, the failed module(s) can be bypassed to continue providing power to load(s) 101 and load(s) 301 without interruption. This is important in many applications, but especially in mobile applications where the failure of other types of EV batteries would result in loss of propulsion of the EV. The embodiments of system 100 described herein are configured to maintain propulsion in the event of the failure of one or more modules 108 and/or in the event of entire arrays 700. For example, if array 700-A fails such that motor 101-1 is inoperable, motor 101-2 can still be powered by arrays 700-U, 700-V, and 700-W. If motor 101-1 is a front-wheel drive motor that operates the front wheels of an EV and motor 101-2 is a rear-wheel drive motor that operates the rear wheels of the EV, the EV could still operate using rear wheel drive motor 101-2.

In another example, arrays 700-U, 700-V, and 700-W can be configured as redundant sources for a single motor 101-1 normally powered by arrays 700-A, 700-B, and 700-C. In the event of a failure of one or more of arrays 700-A, 700-B, and 700-C, the single motor 101-2 can be powered by arrays 700-U, 700-V, and 700-W.

FIGS. 12A-12E are block diagrams of example embodiments of module packs 1110. In these examples, each module pack 1110 includes six arrays 700-A to 700-W arranged in three segments, but can be arranged to include other numbers of segments and/or other numbers of arrays per segment, as described herein.

Referring to FIG. 12A, arrays 700-A to 700-W of module pack 1110 are enclosed in a housing 230. Arrays 700-A to 700-W may or may not be individually enclosed in individual housings within housing 230.

Each array 700 includes system I/O ports SIO1 and SIO2. Depending on the configuration and/or operation of module pack 1110, one system I/O port SIO1 or SIO2 of an array 700 can be the phase port of the array 700 and the other system I/O port SIO1 or SIO2 of the array 700 can be the neutral port of the array 700.

System I/O port SIO2 of array 700-A is coupled to the system I/O port SIO2 of array 700-U. This segment can be referred to as segment AU. System I/O port SIO2 of array 700-B is coupled to the system I/O port SIO2 of array 700-V. This segment can be referred to as segment BV. System I/O port SIO2 of array 700-C is coupled to system I/O port SIO2 of array 700-W This segment can be referred to as segment CW.

When system I/O ports SIO2 of arrays 700-A and 700-U are the neutral ports of arrays 700-A and 700-U, this coupling provides a common neutral point “N” of the segment that includes arrays 700-A and 700-U. Similar neutral points are formed in segments BV and CW when ports SIO2 of the arrays of these segments are coupled together. In other embodiments system I/O port SIO2 of one or more arrays 700-A to 700-W can be the phase port of the array(s). For example, system I/O port SIO2 of array 700-U can be the phase port of array 700-U. When coupled to the neutral port of array 700-A, this can form a larger array that includes modules 108 of both arrays 700-A and 700-U.

Module pack 1110 also includes system I/O ports SIO1 to SIO6 to which components external to module pack 1110 can be coupled. System I/O port SIO1 of module pack 1110 is coupled to system I/O port SIO1 of array 700-A. System I/O port SIO2 of module pack 1110 is coupled to system I/O port SIO1 of array 700-B. System I/O port SIO3 of module pack 1110 is coupled to system I/O port SIO1 of array 700-C. System I/O port SIO4 of module pack 1110 is coupled to system I/O port SIO1 of array 700-U. System I/O port SIO5 of module pack 1110 is coupled to system I/O port SIO1 of array 700-V. System I/O port SIO6 of module pack 1110 is coupled to system I/O port SIO1 of array 700-W. System I/O ports SIO1 to SIO6 of module pack 1110 can be located internal or external to housing 230.

Referring to FIG. 12B, arrays 700-A to 700-C are arranged in a subpack ABC 1111-1 and arrays 700-U to 700-V are arranged in a subpack UVW 1111-2. In this example, subpack 1111-1 is enclosed in a housing 230-2 and subpack 1111-2 is enclosed in a housing 230-3. These two housings 230-2 and 230-3 are enclosed in a common housing 230-1.

In this example, subpacks 1111 include multiple arrays 700, e.g., an array 700 for each of multiple phases. Here, each subpack 1111 includes three arrays 700 for providing three-phase AC power. Using subpacks 1111 enclosed in separate housings 230 enables subpacks 1111 to be swapped easily in the event of failure or degradation of a subpack 1111 or modules 108 or arrays 700 of a subpack 1111. The system I/O ports SIO1 and SIO2 of arrays 700 of each subpack 1111 can be located internal or external to the housing 230 of the subpack 1111 to couple with system I/O ports of arrays 700 of another subpack 1111 and/or with system I/O ports of module pack 1110.

Referring to FIG. 12C, this embodiment differs from the embodiment of FIG. 12B as subpacks 1111-1 and 1111-2 are enclosed in separate housings 230-2 and 230-3, respectively, but housings 230-2 and 230-3 are not enclosed in a common housing 230-1. Here, system I/O ports SIO1 and SIO2 of arrays 700 can be coupled to system I/O ports of arrays 700 of other subpacks 1111 and/or to components external to the subpack 1111. For example, system IO port SIO2 of array 700-A of subpack 1111-1 is coupled to system IO port SIO2 of array 700-U of subpack 1111-2 and system IO port IO1 of array 700-A can be coupled to an external component.

In FIGS. 12B and 12C, each subpack 1111 can include system IO ports that are coupled to system IO ports of arrays 700 included in the subpack 1111. These system IO ports of subpack 1111 can be located internal or external to the housing 230 of the subpack 1111 for coupling arrays 700 of the subpack 1111 to other components.

Referring to FIG. 12D, module pack 1110 includes segment subpacks 1112-1, 1112-2, and 1112-3 that are enclosed in separate housings 230-2, 230-3, and 230-4, respectively. Housings 230-2 to 230-4 are enclosed in a common housing 230-1 for module pack 1110.

Each segment subpack 1112 includes two arrays 700 having their system I/O ports SIO2 coupled together. Similar to the embodiments of FIGS. 12A and 12B, system IO ports of arrays 700 are coupled to respective system IO ports of module pack 1110. This embodiment enables segments of modules to be swapped easily in the event of failure or degradation of a segment subpack 1112 or modules 108 or arrays 700 of a segment subpack 1112.

Referring to FIG. 12E, this embodiment differs from the embodiment of FIG. 12D as segment subpacks 1112-1, 1112-2, and 1112-3 are enclosed in separate housings 230-2, 230-3, and 230-4, respectively, but housings 230-2 to 230-4 are not enclosed in a common housing 230-1. Here, system I/O ports SIO1 of arrays 700 of a segment subpack 1112 can be coupled to components external to the segment subpack 1112.

In FIGS. 12D and 12E, each segment subpack 1112 can include system IO ports that are coupled to system IO ports of arrays 700 included in the subpack 1112. These system IO ports of segment subpack 1112 can be located internal or external to the housing 230 of the segment subpack 1112 for coupling arrays 700 of the segment subpack 1112 to other components.

Module packs 1110 and SSCDs 1120 can be configured in various ways that each support different numbers of and/or types of loads 101 and/or 301. Such configurations can be used without modification, or with minimal modification, for the different numbers of and/or types of loads 101 and/or 301. Some example embodiments are shown in FIGS. 13A-15K and described below. Although these embodiments are described in terms of providing power to motor loads 101 and auxiliary loads 301 of EVs, the embodiments can also be used to provide power to motor loads of other mobile entities and to loads in stationary applications.

FIGS. 13A-13C are block diagrams of example embodiments of modular energy systems 100 having a module pack 1110 and a SSCD 1120 for providing power to primary and auxiliary loads. In particular, FIG. 13A shows an embodiment of system 100 for providing power to two motors 101-1 and 101-2; FIG. 13B shows an embodiment of system 100 for providing power to one motor 101-1; and FIG. 13C shows an embodiment of system 100 that can be selectively configured to provide power to one or two motors 101.

Referring to FIG. 13A, system 100 includes module pack 1110, which is coupled to SSCD 1120 by way of cable 1134. Module pack 1110 can be implemented using any embodiment of module pack 1110 described herein unless stated otherwise or logically implausible. Although system 100 can include control system 102, SSCD control device 1122, and external control device 104, these components are omitted from FIGS. 13A-13C and described in detail with reference to FIGS. 13H and 13K.

Cable 1134 includes a connector 1316 (FIG. 13E) on each end. Connector 1316 on one end of cable 1134 is configured to releasably couple to a connector 1310-1 of module pack 1110 and a connector 1316 on the other end of cable 1134 is configured to releasably couple to a connector 1310-2 of SSCD 1120 (FIG. 13D). Connector 1310-1 includes ports A, B, C, U, V, W, and two sets of ports N₁ to N₃.

Arrays 700-A, 700-B, and 700-C are selectively coupled to motor 101-1 and to connector 1310-1 (and on to SSCD 1120 via cable 1134) by way of lines 1340-A to 1340-C and lines 1350-A to 1350-C, respectively. Similarly, arrays 700-U, 700-V, and 700-W are selectively coupled to motor 101-2 and connector 1310-1 by way of lines 1340-U to 1340-W and lines 1350-U to 1350-W, respectively. Each line 1340 and 1350 can include one or more conductors that route energy between its components and can include one or more switches between the components. Each of the switches shown in FIG. 13A-13C can be implemented as any type of switch, e.g., mechanical switches, relays, contactors, or power semiconductors, unless stated otherwise or logically implausible.

In this embodiment, each array 700-A to 700-W is configured and operated such that system I/O port SIO1 is a phase port and system I/O port SIO2 is a neutral port. Neutral ports SIO2 of arrays 700-A and 700-U are coupled together to form a common neutral point N₁. Similarly, neutral ports SIO2 of arrays 700-B and 700-V are coupled together to form a common neutral point N₂ and neutral ports SIO2 of arrays 700-C and 700-W are coupled together to form a common neutral point N₃.

Phase port SIO1 of array 700-A is selectively coupled to motor 101-1 by way of system I/O port SIO1 of module pack 1110 and line 1340-A, which includes switches SA1 and SA2. When switches SA1 and SA2 are closed, line 1340-A couples phase port SIO1 of array 700-A to motor 101-1.

Phase port SIO1 of array 700-A is also selectively coupled to SSCD 1120 by way of I/O port SIO1 of module pack 1110 and a portion of line 1340-A that includes switch SA2 and a portion of line 1350-A. When switch SA2 is closed, lines 1340-A and 1350-A couple port SIO1 of array 700-A to port A of connector 1310-1, which couples to SSCD 1120 by way of cable 1134 and connector 1310-2.

Phase port SIO1 of array 700-B is selectively coupled to motor 101-1 by way of system I/O port SIO2 of module pack 1110 and line 1340-B, which includes switches SB1 and SB2. When switches SB1 and SB2 are closed, line 1340-B couples phase port SIO1 of array 700-B to motor 101-1.

Phase port SIO1 of array 700-B is also selectively coupled to SSCD 1120 by way of I/O port SIO2 of module pack 1110 and a portion of line 1340-B that includes switch SB2 and a portion of line 1350-B. When switch SB2 is closed, lines 1340-B and 1350-B couple port SIO1 of array 700-B to port B of connector 1310-1.

Phase port SIO1 of array 700-C is selectively coupled to motor 101-1 by way of system I/O port SIO3 of module pack 1110 and line 1340-C, which includes switches SC1 and SC2. When switches SC1 and SC2 are closed, line 1340-C couples phase port SIO1 of array 700-C to motor 101-1.

Phase port SIO1 of array 700-C is also selectively coupled to SSCD 1120 by way of I/O port SIO3 of module pack 1110 and a portion of line 1340-C that includes switch SC2 and a portion of line 1350-C. When switch SC2 is closed, lines 1340-C and 1350-C couple port SIO1 of array 700-C to port C of connector 1310-1.

Phase port SIO1 of array 700-U is selectively coupled to motor 101-2 by way of system I/O port SIO4 of module pack 1110 and line 1340-U, which includes switches SU1 and SU2. When switches SU1 and SU2 are closed, line 1340-U couples phase port SIO1 of array 700-U to motor 101-2.

Phase port SIO1 of array 700-U is also selectively coupled to SSCD 1120 by way of I/O port SIO4 of module pack 1110 and a portion of line 1340-U that includes switch SU2 and a portion of line 1350-U. When switch SU2 is closed, lines 1340-U and 1350-U couple port SIO1 of array 700-U to port U of connector 1310-1.

Phase port SIO1 of array 700-V is selectively coupled to motor 101-2 by way of system I/O port SIO5 of module pack 1110 and line 1340-V, which includes switches SV1 and SV2. When switches SV1 and SV2 are closed, line 1340-V couples phase port SIO1 of array 700-V to motor 101-2.

Phase port SIO1 of array 700-V is also selectively coupled to SSCD 1120 by way of I/O port SIO5 of module pack 1110 and a portion of line 1340-V that includes switch SV2 and a portion of line 1350-V. When switch SV2 is closed, lines 1340-V and 1350-V couple port SIO1 of array 700-V to port V of connector 1310-1.

Phase port SIO1 of array 700-W is selectively coupled to motor 101-2 by way of system I/O port SIO6 of module pack 1110 and line 1340-W, which includes switches SW1 and SW2. When switches SW1 and SW2 are closed, line 1340-W couples phase port SIO1 of array 700-W to motor 101-2.

Phase port SIO1 of array 700-W is also selectively coupled to SSCD 1120 by way of I/O port SIO6 of module pack 1110 and a portion of line 1340-W that includes switch SW2 and a portion of line 1350-W. When switch SW2 is closed, lines 1340-W and 1350-W couple port SIO1 of array 700-W to port W of connector 1310-1.

In this embodiment, the common neutral point (N₁, N₂, and N₃) of each segment of arrays is coupled together by way of a bus bar 1320 or other conductors. This forms a common neutral point for all three segments and forms two three-phase converters, one of arrays 700-A to 700-C and one of arrays 700-U to 700-W, to provide AC power to motors 101-1 and 101-2, respectively.

In addition, the common neutral point N₁ of segment AU is selectively coupled to port N₁ of connector 1310-1 by way of system I/O port SIO7 of module pack 1110 and switch SN1. Similarly, the common neutral point N₂ of segment BV is selectively coupled to port N₂ of connector 1310-1 by way of system I/O port SIO8 of module pack 1110 and switch SN2; and the common neutral point N₃ of segment CW is selectively coupled to port N₃ of connector 1310-1 by way of system I/O port SIO9 of module pack 1110 and switch SN3.

System 100 includes a charge port 1330 that couples with charge source 150, which can be an AC charge source (e.g., a utility grid) or DC charge source. Charge port 1330 includes system I/O ports SIO1 and SIO2 for DC charging, e.g., when in a DC charge state and coupled with a DC charge source. Charge port 1330 also includes system I/O ports SIO3 and SIO4 for AC charging, e.g., when in an AC charge state and coupled with an AC charge source.

System I/O ports SIO1 and SIO2 of charge port 1330 are selectively coupled with arrays 700-A to 700-W by way of lines 1350-C and 1350-W and lines 1340-A to 1340-W. A DC charge source can charge energy sources 206 of modules 108 of arrays 700-A to 700-W when switches SCH2, SCH3, SCH5, SCH6, SCH7, SCH8, SA2, SB2, SC2, SU2, SV2, and SW2 are closed. All arrays do not have to be charged at the same time. For example, switches SA2, SB2, SC2, SU2, SV2, and SW2 can be controlled to selectively charge arrays 700-A to 700-W, respectively, when SCH2, SCH3, SCH5, SCH6, SCH7, and SCH8 are closed.

An AC charge source can charge energy sources 206 of modules 108 of arrays 700-A to 700-W when switches SCH1, SCH4 to SCH8, and SA2, SB2, SC2, SU2, SV2, and SW2 are closed. Switches SA2, SB2, SC2, SU2, SV2, and SW2 can also be controlled to selectively charge arrays 700-A to 700-W, respectively, in an AC charge state when SCH1, and SCH4 to SCH8 are closed. During AC charging, an AC signal from charge source 150 can be routed to modules 108 of module pack 1110, e.g., without conversion to DC.

Charge port 1330 can also be coupled with SSCD 1120 by way of lines 1350-A, 1350-C, 1350-U, and 1350-W. For example, in a DC charge state when chart port 1330 is coupled with a DC charge source, line 1350-C can couple system I/O port SIO2 of charge port 1330 to port C of connector 1310-1 and line 1350-W can couple system I/O port SIO1 of charge port 1330 to port W of connector 1310-1. When in an AC charge state, line 1350-A can couple system I/O port SIO4 of charge port 1330 to port A of connector 1310-1 and line 1350-U can couple system I/O port SIO3 of charge port 1330 to port U of connector 1310-1.

Inductor L1 is an optional component that can be used to filter AC signals being used to charge energy source of modules 108 in an AC charge state. If only DC charging is used or when an EV includes an on-board charger that converts an AC charge source to DC for charging modules 108, inductor L1 can be removed.

In this example embodiment, the ports of connector 1310 can be arranged as shown in FIG. 13A. Different arrangements are also possible. Here, ports S and R are shorted together using a wire 1312 or other conductor. This enables system 100, e.g., control system 102, to ensure that connectors 1310-1 and 1310-2 are connected appropriately before operating system 100, e.g., before providing power to motors 101-1 and 101-2 and/or loads 301, as described in more detail with reference to FIG. 13E.

SSCD control device 1122 and/or control system 102 can be configured to operate the switches of system 100, e.g., by sending control signals to the switches, to selectively provide power to motors 101-1 and/or 101-2, to provide power to auxiliary loads 301, and/or to charge energy sources 206 of modules 108 of module pack 1110. Example techniques for controlling system 100 of FIG. 13A are described below with reference to FIGS. 13F-13H.

Referring to FIG. 13B, this embodiment of system 100 differs from the embodiment of FIG. 13A as system 100 provides power to only one motor 101-1 and does not include bus bar 1320 to couple the common neutral points of the segments together. Instead, each segment AU, BV, and CW forms a larger array than individual arrays 700-A to 700-W for providing power to motor 101-1.

In this embodiment, arrays 700-A to 700-C are configured and operated such that system I/O port SIO1 is a phase port and system I/O port SIO2 is a neutral port. In contrast, arrays 700-U to 700-W are configured and operated such that system I/O port SIO1 is a neutral port and system I/O port SIO2 is a phase port. In this way, each segment AU, BV, and CW forms a larger array that outputs a single phase AC signal.

As ports SIO2 of arrays 700-U to 700-V are phase ports, there are no common neutral points between the arrays of each segment. However, points N₁, N₂, and N₃ between segments AU, BV, and CW, respectively, are coupled to connector 1310-1 in the same manner as in the embodiment of FIG. 13A. This routes the AC signals output by arrays 700-U to 700-W to SSCD 1120 via cable 1134 to also provide power to auxiliary load(s) 301.

The similarities and minor differences between the embodiments of system 100 in FIGS. 13A and 13B enable module packs 1110 to be manufactured for both applications with only minor differences in the manufacturing process. For example, all manufacturing steps can be the same, with only an addition of a bus bar for two-motor applications. This can substantially reduce the complexity and associated costs associated with manufacturing different energy systems or battery packs for different types of EVs.

Control system 102 can be adapted to operate modules 108 of arrays 700-A to 700-W based on whether module pack 1110 is providing power to one motor 101-1 or two motors 101-1 and 101-2. Example techniques for controlling system 100 of FIG. 13B are described below with reference to FIGS. 13I-13K.

Referring to FIG. 13C, this embodiment of system 100 differs from the embodiments of FIGS. 13A and 13B as it includes switches SB1 and SB2 to selectively couple the common neutral points of the segments together. In this way, control system 102 can control switches SN1 and SN2 based on whether module pack 1110 is installed or otherwise implemented with a one-motor EV or a two-motor EV. If the EV has two motors powered by module pack 1110, control system 102 can close switches SB1 and SB2 to form a common neutral point for the three segments, similar to bus bar 1320. If the EV has one motor powered by module pack 1110, control system 102 can open switches SB1 and SB2 such that there is no common neutral point between the three segments.

FIG. 13D is a block diagram of an example embodiment of a SSCD 1120 for providing power to auxiliary loads 301. This embodiment of SSCD 1120 can be used, for example, as the SSCD for each embodiment shown in FIGS. 13A-13C and described herein.

SSCD 1120 includes system I/O ports SIO1-SIO7 for coupling with connector 1310-2 and system I/O ports SIO8 and SIO9 for coupling with DC+ and DC− lines 1136-1 and 1136-2, respectively, of a DC bus 1136 that routes DC power output by SSCD 1120 to auxiliary load(s) 301.

In particular, system I/O ports SIO1, SIO2, and SIO3 of SSCD 1220 are coupled to ports SIO1 of arrays 700-U, 700-V, and 700-W, respectively, by way of ports U, V, and W, respectively, of cable 1134. Similarly, system I/O ports SIO4, SIO5, and SIO6 of SSCD 1220 are coupled to ports SIO1 of arrays 700-A, 700-B, and 700-C, respectively, by way of ports A, B, and C, respectively, of cable 1134.

System I/O port SIO7 of SSCD 1220 is coupled to port N of connector 1310-2. Port N of connector 1310-2 can be coupled to port N₂ of connector 1310-1 by way of a conductor of cable 1134. In two-motor embodiments, this couples the common neutral point of arrays segments AU, BV, and CW to intermediate DC line 1363-2 of SSCD 1120 so that the neutral potential of both module pack 1110 and SSCD 12220 are the same or close to the same (e.g., within a defined tolerance). In single motor embodiments, this couples the neutral points of arrays 700-U to 700-V to intermediate DC line 1363-2, as described in more detail below.

SSCD 1220 can be or include a rectifier circuit that includes a diode circuit 1360 and a filter circuit 1362. Diode circuit 1360 is configured as two three-phase full-wave rectifiers. Diode circuit 1360 includes diodes D1 to D14. Diode circuit 1360 includes three diode segments DSU, DSV, and DSW that form a three-phase full-wave rectifier. Rectifier circuit 1360 also includes three diode segments DSA, DSB, and DSC to form a three-phase full-wave rectifier. Each diode segment includes two diodes coupled between DC+ line 1363-1 and DC− line 1363-3.

Diodes D1, D3, D5, D7, D9, D11, and D13 allow positive current to flow from their respective ports to DC+ line 1363-1, creating positive pulses on DC+ line 1363-1. Similarly, diodes D2, D4, D6, D8, D10, D12, and D14 allow negative current to flow from their respective ports to DC+ line 1363-1, creating negative pulses on DC− line 1363-3. The positive pulse diodes D1, D3, D5, D7, D9, D11, and D13 and the negative pulse diodes D2, D4, D6, D8, D10, D12, and D14 together form two three-phase full-wave rectifiers.

Diode circuit 1360 also includes an output diode segment DSO that includes two diodes D13 and D14. A point between diodes D13 and D14 is coupled to an intermediate DC line 1363. Diodes D13 and D14 are optional components. When diodes D13 and D14 are not included, system port SIO7 can be coupled to intermediate DC line 1363-2.

System I/O ports SIO1 to SIO3 of SSCD 1120 are coupled between the diodes of diode segments DSU to DSW, respectively, and system I/O ports SIO4 to SIO6 of SSCD 1120 are coupled between the diodes of diode segments DSA to DSC, respectively. In two motor embodiments, this couples the phase output of array 700-A to diode segment DSA, the phase output of array 700-B to diode segment DSB, the phase output of array 700-C to diode segment DSC, the phase output of array 700-U to diode segment DSU, the phase output of array 700-V to diode segment DSV, and the phase output of array 700-W to diode segment DSW. In single motor embodiments, this couples the phase output of array 700-U to diode segment DSA, the phase output of array 700-V to diode segment DSB, and the phase output of array 700-W to diode segment DSC, as described below.

SSCD 1120 includes a relay 1361 arranged along DC+ line 1363-1 and coupled between diode segments DSU to DSW and diode segments DSA to DSC. As described in more detail below, SSCD control device 1122 can control relay 1361, e.g., by sending control signals to relay 1361, based on whether system 100 is in a charge state or a discharge state (e.g., in a driving mode for the EV) and/or based on whether system 100 is providing power to one or two motors 101.

Diode circuit 1360 is coupled to filter circuit 1362 by way of DC lines 1363-1 to 1363-3. Filter circuit 1362 includes an inductor Lᵤ on DC+ line 1363-1 and an inductor L₁ on DC− line 1363-3. Filter circuit 1362 also includes a resistor Rᵤ coupled between DC+ line 1363-1 and intermediate DC line 1363-2 and a resistor R₁ coupled between intermediate DC line 1363-2 and DC− line 1363-3. Similarly, filter circuit 1362 includes a capacitor Cᵤ coupled between DC+ line 1363-1 and intermediate DC line 1363-2 and a capacitor C₁ coupled between intermediate DC line 1363-2 and DC− line 1363-3.

Diode circuit 1360 is configured to convert three-phase AC signals to voltage pulses of a same polarity, e.g., the positive polarity, across DC+ line 1363-1 and intermediate DC line 1363-2 and voltage pulses of the same polarity, e.g., the positive polarity, across intermediate DC line 1363-2 and DC-line 1363-3. Resistors Rᵤ and R₁, capacitors Cᵤ and C₁, and inductors Lᵤ and Lᵢ are configured to filter these pulses to generate a constant or close to constant DC output signal across DC+ line 1136-1 and DC− line 1136-3 of DC bus 136. Capacitors Cᵤ and C₁ can also operate as energy buffers that dampen or filter fluctuations in current across DC+ line 1136-1 and DC− line 1136-3, similar to energy buffer 204.

As described in more detail below, SSCD control device 1122 can regulate the voltage level V_{c,u} across capacitor Cᵤ and the voltage level V_{c,1} across capacitor C₁ to provide a target output DC voltage level across DC+ line 1136-1 and DC− line 1136-3. This output voltage is the sum of V_{c,u} across capacitor Cᵤ and voltage level V_{c,1} across capacitor C₁. SSCD control device 1122 can regulate the voltage levels V_{c,u} and V_{c,1} to be the same level or close to the same level, or to have different voltage levels.

SSCD 1120 can include sensors for sensing voltage level V_{c,u} across capacitor Cᵤ, voltage level V_{c,1} across capacitor C₁, output current Iₒᵤₜ, current I_{L,u} through inductor Lᵤ, and current I_{L,1} through inductor Lᵢ. The sensors can include voltage and current sensors. The outputs of the sensors can be communicatively coupled to SSCD control device 1122, e.g., using communication path or link 1132. For example, communication path or link 1132 can be communicatively coupled to each sensor and to relay 1361 using one or more conductors for each component.

In another example, as shown in FIG. 13D, SSCD 1120 can include a local control device 1368 that collects the sensed signals and provides the sensed signals to SSCD control device 1122 over communication path or link 1132. SSCD LCD 1368 can also control relay 1361 based on control signals received from SSCD control device 1122 over communication path or link 1132.

SSCD 1120 includes a discharge circuit 1364 coupled to DC lines 1363-1 to 1363-3. Discharge circuit 1364 is configured to discharge capacitors Cᵤ and C₁ in response to detection of a condition, such as a fault or short circuit, and/or during shutdowns of system 100. Module pack 1110 can include isolation features, such as contactors that can be opened to isolate the module pack 1110 and its components upon detection of a condition. This can prevent energy from being transferred to capacitors Cᵤ and C₁. However, the energy stored in capacitors Cᵤ and C₁ should be discharged safely as well. Discharge circuit 1364 can discharge capacitors Cᵤ and C₁ safely and without sending the energy to load(s) 301 by way of DC bus 1136 or to module pack 1110.

FIG. 13E is a diagram that shows example embodiments of connectors 1310 for coupling module packs 1110 with SSCDs 1120. For both one-motor and two-motor EVs, the ports of connector 1310-1 at module pack 1110 that couple with ports of a connector 1316-1 at an end of cable 1134 can be arranged the same. The ports of connector 1310-2 at SSCD 1120 that couple with ports of connector 1316-2 at the other end of cable 1134 can be arranged the same, but connector 1316-2 may be rotated 90 degrees (e.g., in a counterclockwise direction) when coupled to a connector 1310-2 of an SSCD 1120 in a one-motor EV relative to the connection in a two-motor EV.

In either embodiment, ports having the same designator and located in the same location in connectors 1316-1 and 1316-2 are coupled to each other by a conductor of cable 1134. For example, port C of connector 1316-1 is coupled to port C of connector 1316-2 in each embodiment.

At module pack 1110, ports having the same designator and located in the same location in connectors 1310-1 and 1316-1 are coupled together when connector 1316-1 is appropriately connected to connector 1310-1. For example, connector 1316-1 is connected to connector 1310-1 appropriately when port C of connector 1316-1 is connected to port C of connector 1310-1.

At SSCD 1120, the orientation of ports of connector 1316-2 can differ between single motor embodiments and two-motor embodiments. For two-motor embodiments, ports A, B, and C of connector 1316-2 are coupled to ports A, B, and C, respectively of connector 1310-2; ports U, V, and W of connector 1316-1 are coupled to ports U, V, and W, respectively of connector 1310-2; a first set 1313-1 of ports N₁ to N₃ of connector 1316-2 is coupled to a set 1314 of non-connected (NC) ports of connector 1310-2, and a second set of ports N₁ to N₃ is coupled to a set 1315 of ports that include two NC ports and an N port such that port N₂ is coupled to the N port.

As shown in FIG. 13D, phase ports SIO1 of arrays 700-U, 700-V, and 700-W of connector 1310-2 are coupled to system I/O ports SIO1, SIO2, and SIO3 of SSCD 1120. In this two-motor configuration, phase ports SIO1 of arrays 700-U, 700-V, and 700-W of module pack 1120 are coupled between the two diodes of diode segments DSU, DSV, and DSW, respectively, when connector 1316-2 is appropriately coupled to connector 1310-2. Similarly, phase ports SIO1 of arrays 700-A, 700-B, and 700-C of connector 1310-2 are coupled to system I/O ports SIO4, SIO5, and SIO6 of SSCD 1120 such that phase ports SIO1 of arrays 700-A, 700-B, and 700-C of module pack 1120 are coupled between the two diodes of diode segments DSA, DSB, and DSC, respectively, when connector 1316-2 is appropriately coupled to connector 1310-2.

Referring back to FIG. 13A, system I/O ports SIO7, SIO8, and SIO9 of module pack 1110 can be coupled to both the first set 1313-1 of ports N₁ to N₃ and the second set of ports N₁ to N₃ of connector 1310-1 shown in FIG. 13E. In this way, common neutral point N₂ of segment 70BV can be coupled to connector N of connector 1310-2 when both connectors 1316-1 and 1316-2 are appropriately coupled with connectors 1310-1 and 1310-2, respectively. This connection routes the common neutral points of segments AU, BV, and CW to intermediate DC line 1363-2 of SSCD 1120 as port N of connector 1310-2 is coupled to system I/O port SIO7, which is coupled to intermediate DC line 1363-2.

In single motor embodiments, connector 1316-2 is rotated 90 degrees with respect to connector 1316-2 of two-motor embodiments. The ports of connector 1310-2 are coupled to system I/O ports SIO1 to SIO7 of SSCD 110 in the same manner as in the two-motor embodiment (e.g., port U of connector 1310-2 coupled to SIO1, port V of connector 1310-2 coupled to SIO2, and so on). Here, due to the rotation of connector 1316-2, ports A, B, and C of connector 1316-2 are coupled to ports U, V, and W, respectively, of connector 1310-2. This would route the phase outputs of arrays 700-A, 700-B, and 700-C to diode segments DSU, DSV, and DSW, respectively, of SSCD 1120 if relay 1361 is closed. However, relay 1361 is kept open in single motor control.

Ports U, V, and W of connector 1316-2 are coupled to the set 1315 of ports that include two NC ports and an N port of connector 1310-2 such that port V is coupled to the N port of connector 1310-2. As shown in FIG. 13G and described below, system I/O ports SIO1 of arrays 700-U to 700-W, which are neutral ports in the single motor embodiment, can be coupled together to form a common neutral point. In this example, this common neutral point is routed to intermediate DC line 1363-2 by way of port V of connector 1310-1 being coupled to port V of connector 1316-1, port V of connector 1316-1 being coupled to port V of connector 1316-2, port V of connector 1316-2 being coupled to port N of connector 1310-2, and port N of connector 1310-2 being coupled to intermediate DC line 1363-2 via system I/O port SIO7 of SSCD 1120.

The first set 1313-1 of ports N₁ to N₃ of connector 1316-2 are coupled to ports A to C, respectively. In this way, system I/O ports SIO2 of arrays 700-U, 700-V, and 700-W, which are the phase ports for arrays 700-U, 700-V, and 700-W in this embodiment, are coupled to diode segments DSA, DSB, and DSC, respectively, when connectors 1316-1 and 1316-2 are appropriately coupled to connectors 1310-1 and 1310-2, respectively. For example, port SIO2 of array 700-2 is coupled to both N₁ ports of connector 1310-1, each port N₁ of connector 1310-1 is coupled to a corresponding port N₁ of connector 1316-1, which is coupled to corresponding port N₁ of connector 1316-2. Port N₁ of the first set 1313-1 of connector 1316-2 is coupled to port A of connector 1310-2 and port A of connector 1310-2 is coupled to diode segment DSA via system I/O port SIO4 of SSCD 1120.

This enables the physical arrangement of the ports of SSCD 1120 that couple to connector 1310-2, cable 1134, and ports of connectors 1310-1 and 1310-2 to be the same for both one-motor and two-motor applications. Cable 1134 can simply be rotated 90 degrees for single motor control relative to that of two-motor control to route the phase outputs of arrays 700-U to 700-V to rectifier circuit 1360 of SSCD 1120 at ports SIO4 to SIO6 of SSCD 1120 where the phase outputs of arrays 700-A to 700-C are routed during two-motor control. Ports NC of connector 1310-2 are not connected to any component of SSCD 1120.

Ports S and R of connector 1310-1 can be shorted together with a wire 1312 or other conductor to enable SSCD control device 1122 to sense whether connector 1310-2 is connected properly, based on whether system 100 is being used to provide power to one or two motors. Port S can be a send port and port R can be a received port. SSCD control device 1122 can send a test signal on port S and detect whether the signal is received on port R. In two-motor embodiments, SSCD control device 1122 should be able to detect the signal if connectors 1316-1 and 1316-2 are appropriately coupled to connectors 1310-1 and 1310-2, respectively. If SSCD control device 1122 is configured for two-motor control, SSCD control device 1122 can prevent operation of SSCD 1120 and/or of module pack 1110 if the signal is applied to port S and not detected on port R as this would indicate an incorrect connection. For example, SSCD control device 1122 can send, to an MCD 112 of control system 102, a control signal indicating the incorrect connection and, in turn, MCD 112 may not release energy from modules 108 of module pack 1110.

In single motor embodiments, SSCD control device 1122 should not be able to detect the signal if connectors 1316-1 and 1316-2 are appropriately coupled to connectors 1310-1 and 1310-2, respectively. If SSCD control device 1122 is configured for single motor control, SSCD control device 1122 can prevent operation of SSCD 1120 and/or of module pack 1110 if the signal is applied to port S and detected on port R as this would indicate an incorrect connection.

In some embodiments, ports S and R can be shorted at connector 1310-2 rather than connector 1310-1. In this example, MCD 112 of control system 102 can send the test signal on port S and determine whether the signal is received on port R. MCD 112 can then enable operation of module pack 1110 and/or SSCD 1120 or disable operation, in a similar manner as SSCD control deice 1122.

FIGS. 13F-13H illustrate example techniques for controlling components of the example embodiments of system 100 shown in FIG. 13B (or 13C) and 13D for providing and regulating AC power to a single motor 101-1 of an EV and for providing and regulating DC power to auxiliary load(s) 301.

FIG. 13F is a diagram of an example equivalent rectifier circuit 1380 during single motor control and FIG. 13G is a diagram of an example equivalent module pack 1381 configuration during single motor control.

When operating motor 101-1, SSCD control device 1122 can open relay 1361, which blocks the phase outputs of arrays 700-A, 700-B, and 700-C present at system IO ports SIO1 to SIO3 from passing through relay 1361 and reaching DC+ line 1363-1 and DC− line 1363-3 of SSCD 1120. Thus, diode segments DSU to DSW are effectively decoupled from the rest of the other diode segments DSA to DSC and DSO.

Control system 102 can close switches SA1, SA2, SB1, SB2, SC1, and SC2 to couple the phase outputs of arrays 700-A to 700-C to motor 101-1. Control system 102 can also open switches SCH1 to SCH4 to isolate charge source 150 from the components of system 100. Control system 102 can also close switches SN1 to SN3 to couple the phase outputs of arrays 700-U to 700-W at their ports SIO2 to ports N₁, N₂, and N₃ of connector 1310-1 and on to diode arrays DSA, DSB, and DSC, respectively, via cable 1134 and due to the rotation of connector 1316-2, as described above.

Control system 102 can close switches SU2, SV2, SW2, SCH5, and SCH6 to couple the neutral points of arrays 700-U, 700-V, and 700-W together to form a common neutral point. This also routes the neutral points of arrays 700-U to 700-W to ports U, V, and W, respectively, of connector 1310-1, which routes their common neutral point to intermediate bus 1363-2 via cable 1134 via cable 1134 and due to the rotation of connector 1316-2, as described above.

When the embodiment of system 100 of FIG. 13C is used, control system 102 open switches SN1 and SN2 to remove the equivalent bus bar that would otherwise couple the common neutral points together and open switches SU1, SV1, and SW1 since there is no motor connected to the other side of these switches. These switches can also remain open in the embodiment of system 100 of FIG. 13B.

In the illustrated configuration of FIG. 13F, the phase outputs of arrays 700-U to 700-W charge capacitors during operation of motor 101-1. Diodes D7 to D12 rectify the AC signals received from arrays 700-U to 700-W and pass the rectified signal to filter circuit 1362, which filters the rectified signal to a DC signal that is output on DC power bus 1136. Thus, arrays 700-U to 700-W can provide power to auxiliary load(s) 301 by way of SSCD 1120 and arrays 700-A to 700-C can provide AC power to motor 101-1. Arrays 700-U to 700-W are coupled to arrays 700-A to 700-C, respectively, such that arrays 700-U to 700-W also contribute to the AC signal output to motor 101-1.

FIG. 13H is a diagram of an example control scheme for single motor control using system 100 of FIG. 13B or 13C. In this example scheme, an external motor control device 104 is configured to provide control information to SSCD control device 1122 over communication path or link 1135, as described in more detail below. This control information, which can be referred to as external control information, can include a modulation index for each phase of AC signal being provided to motor 101-1, a modulated reference signal for each phase, a modulation index and reference signal for each phase, or other control information.

Each segment of arrays (e.g., segments, AU, BV, and CW) can output a single-phase AC signal that includes a superposition of output voltages from the modules of the arrays in the segment. For single motor control, the external control information for a phase can be for the segment outputting the AC signal for that phase (e.g., that has the corresponding phase angle).

Motor control device 104 can generate the external control information based on a reference signal for motor control, motor feedback signals received from motor 101-1 over communication path or link 1391, and/or module feedback signals received from control system 102 of module pack 1110 over communication path or link 1133. The motor feedback signals can include, for example, operating characteristics of motor 101-1, such as actual or estimated instantaneous values of the torque of motor 101-1 and/or the speed of motor 101-1. The module feedback signals can include, for example, the output voltage level of the AC signal provided to motor 101-1 by module pack 1110 and/or the output current level of the AC signal provided to motor 101-1 by module pack 1110. Motor control device 104 can provide the external control information to SSCD control device 1122 over communication path or link 1135.

SSCD control device 1122 is configured to process the external control information and generate processed control information based on a reference signal for SSCD 1120 (e.g., a reference for the output DC signal) and/or SSCD feedback signals received from SSCD 1120 over communication path or link 1132. The processed control information can include a modulation index for each phase or a modulated reference signal for each phase. The SSCD feedback signals can include, for example, sensed voltages and/or currents of SSCD 1120. For example, the SSCD feedback signals can include voltage level V_{c,u} across capacitor Cᵤ, voltage level V_{c,1} across capacitor C₁, current I_{L,u} through inductor Lᵤ, and/or current I_{L,1} through inductor Lᵢ.

Processing the control information can include adjusting the control information, e.g., adjusting the modulation index for one or more phases and/or the modulation reference signal for one or more phases. In general, SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136.

To regulate the voltage level of the output DC signal, SSCD control device 1122 can regulate voltage level V_{c,u} across capacitor Cᵤ and/or voltage level V_{c,1} across capacitor C₁ as the voltage level of the output DC signal is the sum of these voltage levels. In some embodiments, SSCD control device 11220 can be configured to balance voltage levels V_{c,u} and V_{c,1}.

SSCD control device 1122 can regulate V_{c,u} and V_{c,1} by adjusting the external control information to increase or decrease the amount of energy being transferred from module pack 1110 to capacitors Cᵤ and C₁. For example, if the voltage level of the output DC signal is less than a reference voltage for the output DC signal, SSCD control device 1122 can adjust the external control information to increase the amount of energy being transferred from module pack 1110 to capacitors Cᵤ and C₁. If the voltage level of the output DC signal is greater than a reference voltage for the output DC signal, SSCD control device 1122 can adjust the external control information to decrease the amount of energy being transferred from module pack 1110 to capacitors Cᵤ and C₁.

SSCD control device 1122 can balance the voltage levels V_{c,u} and V_{c,1} by adjusting the external control information to increase or decrease the amount of energy transferred from module pack 1110 to capacitors Cᵤ and C₁. For example, SSCD control device 1122 can compare a reference voltage for each capacitor (e.g., which can be half of the reference voltage for the output DC signal) to the sensed value for the capacitor. Based on one or both of these comparisons and/or a comparison between the reference voltage for the output DC signal and the sum of the sensed values of V_{c,u} and V_{c,1}. Using these comparisons, SSCD control device 1122 can determine whether to increase or decrease the amount of energy being transferred from module pack 1110 to capacitors Cᵤ and C₁.

If SSCD control device 1122 determines to adjust the external control information to increase or decrease the amount of energy being transferred to capacitors Cᵤ and C₁, SSCD control device 122 can adjust the modulation index and/or modulated reference signal for all three phases in the same manner, e.g., by increasing or decreasing the values by the same amount. In this way, the adjustment does not affect the amount of AC power being provided to motor 101-1. In other words, the voltage level of the output DC signal can be regulated by adjusting the common mode voltage of the AC signal provided to motor 101-1.

In this example embodiment, arrays 700-U to 700-W provide energy to capacitors Cᵤ and C₁ from their phase outputs. To increase or decrease the amount of energy being transferred to capacitors Cᵤ and C₁, SSCD control device 1122 can adjust the modulation indexes for the three phases and provide the adjusted modulation indexes to control system 102 for use in controlling modules 108 of arrays 700-U to 700-W. The same adjusted modulation indexes can also be provided to corresponding arrays 700-A to 700-C. For example, the modulation index for a first phase can be provided for both arrays 700-A and 700-U; the modulation index for a second phase can be provided for both arrays 700-B and 700-V, and the modulation index for a third phase can be provided for both arrays 700-C and 700-W.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, in the single motor embodiment of FIG. 13H, the AC signals generated by arrays 700-A to 700-W are provided to motor 101-1.

In addition, the AC signals generated by arrays 700-U to 700-W are provided to SSCD 1120 by cable 1134. SSCD 1120 converts the AC signals to a DC signal and outputs the DC signal onto DC power bus 1136 to power auxiliary loads 301.

FIGS. 131-13K illustrate example techniques for controlling components of the example embodiments of system 100 shown in FIG. 13A (or 13C) and 13D for providing and regulating AC power to two motors 101-1 and 101-2 of an EV and for providing and regulating DC power to auxiliary load(s) 301.

FIG. 13I is a diagram of an example equivalent rectifier circuit 1382 during two-motor control. FIG. 13J is a diagram of an example equivalent module pack configuration 1383 during two-motor control.

When operating motors 101-1 and 101-2, SSCD control device 1122 can close relay 1361, which allows the phase outputs of arrays 700-U, 700-V, and 700-W to pass through relay 1361 and reach DC+ line 1363-1 and DC− line 1363-3 of SSCD 1120.

Control system 102 can close switches SA1, SA2, SB1, SB2, SC1, and SC2 to couple the phase outputs of arrays 700-A, 700-B, and 700-C to motor 101-1. Control system 102 can also close switches SU1, SU2, SV1, SV2, SW1, and SW2 to couple the phase outputs of arrays 700-U, 700-V, and 700-W to motor 101-2. In this example embodiment, arrays 700-U to 700-W are configured and operated such that system I/O port SIO1 of each array 700-U to 700-W is a phase port and system I/O port SIO2 of each array 700-U to 700-W is a neutral port

Control system 102 can also open switches SCH1 to SCH4 to isolate charge source 150 from the components of system 100. Control device 102 can also close switches SN1 to SN3 to couple the common neutral points N₁ to N₃ of arrays 700 of module pack 1110 to connector 1310-1 and on to intermediate DC line 1363-2 by cable 1134. When the embodiment of system 100 of FIG. 13C is used, control system 102 can close switches SB1 and SB2 to apply the equivalent bus bar that couples the common neutral points of segments AU, BV, and CW together.

FIG. 13K is a diagram of an example control scheme for two-motor control using system 100 of FIG. 13A or 13C. In this example scheme, there is an external motor control device 104-1 for motor 101-1 and an external motor control device 104-2 for motor 101-2. In other examples, one motor control device can be used to control both motors 101-1 and 101-2.

External motor control device 104-1 is configured to provide external control information to SSCD control device 1122 over communication path or link 1135-1. The external control information can include a modulation index for each phase of AC signal being provided to motor 101-1, a modulated reference signal for each phase, or a modulation index and reference signal for each phase, or other control information. As motor 101-1 is powered by arrays 700-A to 700-C, the external control information can include the control information for arrays 700-A to 700-C, which can also be referred to as subpack ABC. Similarly, external motor control device 104-2 can provide external control information for arrays 700-U to 700-W, which can also be referred to as subpack UVW, to SSCD control device 1122 over communication path or link 1135-2.

Motor control device 104-1 can generate the external control information for arrays 700-A to 700-C based on a reference signal for motor control, motor feedback signals received from motor 101-1 over communication path or link 1394, and/or module feedback signals received from control system 102 of module pack 1110 over communication path or link 1396. The motor feedback signals can include, for example, operating characteristics of motor 101-1, such as actual or estimated instantaneous values of the torque of motor 101-1 and/or the speed of motor 101-1. The module feedback signals can include, for example, the output voltage level of the AC signal provided to motor 101-1 by arrays 700-A to 700-C and/or the output current level of the AC signal provided to motor 101-1 by arrays 700-A to 700-C.

Similarly, motor control device 104-2 can generate the external control information for arrays 700-U to 700-W based on a reference signal for motor control, motor feedback signals received from motor 101-1 over communication path or link 1395, and/or module feedback signals received from control system 102 of module pack 1110 over communication path or link 1397. The motor feedback signals can include, for example, operating characteristics of motor 101-1. The module feedback signals can include, for example, the output voltage level of the AC signal provided to motor 101-1 by arrays 700-U to 700-W and/or the output current level of the AC signal provided to motor 101-1 by arrays 700-U to 700-W.

Motor control device 104-1 can provide the external control information to SSCD control device 1122 over communication path or link 1135-1. Motor control device 104-2 can provide the external control information to SSCD control device 1122 over communication path or link 1135-2.

SSCD control device 1122 is configured to process the external control information from each motor control device 104-1 and 104-2 and generate processed control information for subpack ABC and subpack UVW based on a voltage reference for SSCD 1120 (e.g., a reference for the output DC signal), SSCD feedback signals received from SSCD 1120 over communication path or link 1132 and/or module feedback signals received from control system 102 of module pack 1110 over communication path or link 1133. The processed control information for a subpack ABC or UVW can include a modulation index for each phase for that subpack ABC or UVW or a modulated reference signal for each phase of that subpack ABC or UVW. Thus, the processed control information for a subpack ABC or UVW can include a modulation index or modulated reference signal for each array 700 in the subpack ABC or UVW.

The SSCD feedback signals can include, for example, sensed voltages and/or currents of SSCD 1120. For example, the SSCD feedback signals can include voltage level V_{c,u} across capacitor Cᵤ, voltage level V_{c,1} across capacitor C₁, current I_{L,u} through inductor Lᵤ, and/or current I_{L,1} through inductor Lᵢ.

In this example embodiment, the module feedback signals can include, for example, one or more operating characteristics of subpack ABC (shown as OC_{ABC} in FIG. 13K) and one or more operating characteristics of subpack UVW (shown as OC_{UVW} in FIG. 13K). The operating characteristics can include, for example, aggregate values of SOC, SOH, temperature, voltage, current, SOP, and/or SOE for each subpack ABC and UVW.

Processing the control information can include adjusting the control information, e.g., adjusting the modulation index for one or more phases and/or the modulation reference signal for one or more phases. SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136.

To regulate the voltage level of the output DC signal, SSCD control device 1122 can regulate voltage level V_{c,u} across capacitor Cᵤ and voltage level V_{c,1} across capacitor C₁ as the voltage level of the DC signal is the sum of these voltage levels. In some embodiments, SSCD control device 11220 can be configured to balance voltage levels V_{c,u} and V_{c,1}.

SSCD control device 1122 can regulate V_{c,u} and V_{c,1} by adjusting the external control information for one or both subpacks ABC and UVW to increase or decrease the amount of energy being transferred from module pack 1110 to capacitors Cᵤ and C₁. For example, if the voltage level of the output DC signal is less than a reference voltage for the output DC signal, SSCD control device 1122 can adjust the external control information for one or both subpacks ABC and UVW to increase the amount of energy being transferred from module pack 1110 to capacitors Cᵤ and C₁. If the voltage level of the output DC signal is less than a reference voltage for the output DC signal, SSCD control device 1122 can adjust the external control information for one or both subpacks ABC and UVW to decrease the amount of energy being transferred from module pack 1110 to capacitors Cᵤ and C₁.

SSCD control device 1122 can balance the voltage levels V_{c,u} and V_{c,1} by adjusting the external control information for one or both subpacks ABC and UVW to increase or decrease the amount of energy transferred from module pack 1110 to capacitors Cᵤ and C₁. For example, SSCD control device 1122 can compare a reference voltage for each capacitor (e.g., half of the reference voltage for the output DC signal) to the sensed value for the capacitor. Based on one or both of these comparisons and/or a comparison between the reference voltage for the output DC signal and the sum of the sensed values of V_{c,u} and V_{c,1}, SSCD control device 1122 can determine whether to increase, decrease, or to not adjust the amount of energy being transferred from module pack 1110 to capacitors Cᵤ and C₁.

If SSCD control device 1122 determines to adjust the external control information one or both subpacks ABC and UVW to increase or decrease the amount of energy being transferred to capacitors Cᵤ and C₁, SSCD control device 122 can adjust the modulation index and/or modulated reference signal for all three phases of the subpack(s) in the same manner, e.g., by increasing or decreasing the values by the same amount. In this way, the adjustment does not affect the amount of AC power being provided to motor 101-1 and/or motor 101-2.

Processing the external control information can also include adjusting the external control information to balance one or more operating characteristics of modules 108, arrays 700, and/or groups of arrays. In this example, arrays 700-A, 700-B, and 700-C of subpack ABC and/or arrays 700-U, 700-V, and 700-W of subpack UVW are used to provide energy to capacitors Cᵤ and C₁. SSCD control device 1122 can perform subpack balancing techniques to balance one or more operating characteristics of these subpacks by selecting which subpack to provide additional or less energy to capacitors Cᵤ and C₁. Balancing between subpacks ABC and UVW can be referred to as multiphase subpack balancing.

For example, if the aggregate SOC of subpack UVW is higher than the aggregate SOC of subpack ABC and more energy is needed for capacitor Cᵤ and/or C₁, SSCD control device 1122 can adjust the external control information for subpack UVW to cause subpack UVW to provide more energy to capacitors Cᵤ and C₁. SSCD control device 1122 can adjust the control information, for example, by increasing the modulation indexes for arrays 700-U to 700-W. In this way, more energy is used from modules 108 of subpack UVW than subpack ABC, resulting in the aggregate SOCs trending towards a balanced state for subpacks ABC and UVW.

In another example, if the aggregate temperature of subpack ABC is higher than the aggregate temperature of subpack UVW and less energy is needed for capacitor Cᵤ and/or C₁, SSCD control device 1122 can adjust the external control information for subpack ABC to cause subpack ABC to provide less energy to capacitors Cᵤ and C₁. SSCD control device 1122 can adjust the control information, for example, by decreasing the modulation indexes for arrays 700-A to 700-C. In this way, less energy is used from modules 108 of subpack ABC which should reduce the temperatures of modules 108 in subpack 108, resulting in the aggregate temperatures trending towards a balanced state for subpacks ABC and UVW.

Although these examples illustrate adjustments to the control information for one subpack at a time, SSCD control device 1122 can adjust the control information for both subpacks ABC and UVW to balance one or more operating characteristics of subpacks ABC and UVW. For example, if the aggregate SOC of subpack UVW is higher than the aggregate SOC of subpack ABC, SSCD control device 1122 can adjust the external control information for subpack UVW to cause subpack UVW to provide more energy to capacitors Cᵤ and C₁ and also adjust the external control information for subpack ABC to cause subpack ABC to provide less energy to capacitors Cᵤ and C₁. SSCD control device 1122 can be configured to make these adjustments while also ensuring that sufficient energy is being transferred to capacitors Cᵤ and C₁ to regulate the output DC signal of SSCD 1120.

SSCD control device 1122 can perform subpack balancing techniques any time (e.g., continuously or periodically) during operation of motors 101-1 and 101-2 and while providing power to auxiliary load(s) 301. For example, even when the output DC signal of SSCD 1120 is regulated to the reference voltage, SSCD control device 1120 can adjust control information for one or both subpacks ABC and UVW to balance the one or more operating characteristics of subpacks ABC and UVW. In a particular example, if the aggregate SOC of subpack ABC is lower than the aggregate SOC of subpack UVW, SSCD control device 1122 can increase the modulation indexes for subpack UVW and decrease the modulation indexes for subpack ABC to balance the aggregate SOCs. In this example, SSCD control device 1122 can adjust the modulation indexes such that the energy provided to SSCD 1120 is the same and/or such that the output DC signal of SSCD 1120 otherwise remains regulated.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, the AC signals generated by arrays 700-A to 700-C are provided to motor 101-1 and AC signals generated by arrays 700-U to 700-W are provided to motor 101-2.

In addition, the AC signals generated by arrays 700-A to 700-C and/or the AC signals generated by arrays 700-U to 700-W are provided to SSCD 1120 by way of cable 1134. SSCD 1120 converts the AC signals to a DC signal and outputs the DC signal onto DC power bus 1136 to power auxiliary loads 301.

Control system 102 and/or SSCD control device 1122 can be configured to control charging of energy sources 206 of modules 108 of module pack 1110 while providing DC power to auxiliary load(s) 301 in both single motor and two-motor embodiments.

FIGS. 13L-13M illustrate example techniques for controlling components of the example embodiments of system 100 shown in FIG. 13B (or 13C) and 13D for charging energy sources 206 in single motor embodiments. FIG. 13L is a diagram of an example equivalent rectifier circuit 1384 during charging in single motor embodiments. FIG. 13M is a diagram of an example equivalent module pack configuration 1385 during charging in single motor embodiments.

To charge energy sources 206 of arrays 700 of module pack 1110, control system 102 can couple charge source 150 to arrays 700-A to 700-W of module pack 1110 to route a charge signal to energy sources 206 of arrays 700-A to 700-W. To do so, control system 102 can open switches SA1, SB1, and SC1 to isolate module pack 1110 and charge source 150 from motor 101-1. Control system 102 or SSCD control device 1122 can also open switches SU1, SV1, and SW1.

Control system 102 can close switches SA2, SB2, SC2, SU2, SV2, and SW2 to enable charge signals to reach arrays 700-A to 700-W from charge source 150. Control system 102 can also close switches SN1 to SN3 to couple the common neutral points N₁ to N₃ to SSCD 1120. When DC charging using a DC charge source 150, control system 102 or SSCD control device 1122 can close switches SCH2, SCH3, and SCH5-SCH8 to couple DC charge source 150 to arrays 700-A to 700-W and to SSCD 1120 by way of cable 1134 and ports A-C and U-W of connector 1310-1. When AC charging using an AC charge source 150, control system 102 can close switches SCH1 and SCH4 to couple AC charge source 150 to arrays 700-A to 700-W and to SSCD 1120 by way of cable 1134 and ports A and U of connector 1310-1. In AC charging, modules 108 of arrays 700-A to 700-W are connected to an AC charge source 150 without an intermediate AC to DC converter (e.g., without an on-board charger). DC charging can be performed using an AC to DC converter coupled between an AC charge source 150 and arrays 700-A to 700-W, or using a DC charge source 150.

SSCD control device 1122 can also close relay 1361. For DC charging, this switch configuration results in equivalent rectifier circuit 1384 and equivalent module pack configuration 1385 where the DC charge signal is provided to arrays 700-A to 700-W and to diode segments DSU to DSW and DSA to DSC. The positive DC charge signal can be provided to arrays 700-A to 700-C and the negative DC charge signal can be provided to arrays 700-U to 700-W.

As described above connector 1310-2 can be rotated 90 degrees for single motor embodiments. This results in the DC charge signal at ports A-C of connector 1310-1 being routed to diode segments DSY to DSW rather than DSA to DSC. Similarly, this results in ports N1 to N3 of connector 1310-1 coupling the points between each segment AU, BV, and CW to diode segments DSA to DSC, and coupling the DC charge signal at ports U-W to intermediate DC line 1363-2.

During charging, SSCD controller 1122 can be bypassed as the DC voltage is constructed naturally from the DC charge signal coupled to SSCD 1120. The positive DC charge signal is passed through ports A-C of connector 1310-1 to diode segments DU to DW and the negative DC charge signal is passed through ports U-W of connector to the intermediate DC line 1363-2, resulting in the DC charge signal being applied to capacitor Cᵤ. The DC charge signal charges capacitor Cᵤ to the voltage level of charge source 150 and the voltage level of capacitor C₁ can remain at zero. The output DC signal of SSCD 1120 provided to DC power bus 1136 can be the same as the DC charge signal, thus providing power to auxiliary load(s) 301 during charging.

FIGS. 13N-130 illustrate example techniques for controlling components of the example embodiments of system 100 shown in FIG. 13A (or 13C) and 13D for charging energy sources 206 in two-motor embodiments. FIG. 13N is a diagram of an example equivalent rectifier circuit 1386 during charging in two-motor embodiments. FIG. 130 is a diagram of an example equivalent module pack configuration 1387 during charging in two-motor embodiments.

To charge energy sources 206 of arrays 700-A to 700-W of module pack 1110, control system 102 can couple charge source 150 to arrays 700-A to 700-W of module pack 1110 to route a charge signal to energy sources 206 of arrays 700. To do so, control system 102 or SSCD control device 1122 can open switches SA1, SB1, and SC1 to isolate module pack 1110 and charge source 150 from motor 101-1. Control system 102 or SSCD control device 1122 can also open switches SU1, SV1, and SW1 to isolate module pack 1110 and charge source 150 from motor 101-2.

Control system 102 can close switches SA2, SB2, SC2, SU2, SV2, SW2 to enable charge signals to reach arrays 700-A to 700-W form charge source 150. Control system 102 can also close switches SN1 to SN3 to couple the common neutral points N₁ to N₃ to SSCD 1120. When DC charging using a DC charge source 150, control system 102 can close switches SCH2, SCH3, and SCH5-SCH8 to couple DC charge source 150 to arrays 700-A to 700-W and to SSCD 1120 by way of cable 1134 and ports A-C and U-W. When AC charging using an AC charge source 150, control system 102 can close switches SCH1 and SCH4 to couple AC charge source 150 to arrays 700-A to 700-W and to SSCD 1120 by way of cable 1134 and ports A and U.

SSCD control device 1122 can also close relay 1361. For DC charging, this switch configuration results in equivalent rectifier circuit 1384 and equivalent module pack configuration 1385 where the DC charge signal is provided to arrays 700-A to 700-W and to diode segments DSU to DSW and DSA to DSC via ports A-C and U-W of connectors 1310-1 and 1310-2. The positive DC charge signal can be provided to arrays 700-A to 700-C and the negative DC charge signal can be provided to arrays 700-U to 700-W. During charging, SSCD controller 1122 can be bypassed as the DC voltage is constructed naturally from the DC charge signal.

The positive DC charge signal is routed to diode segments DSA to DSC by way of ports A-C of connectors 1310-1 and 1310-2 and the negative DC charge signal is routed to diode segments DSU to DSW by way of ports U-W of connectors 1310-1 and 1310-2. In this configuration, the DC charge signal charges both capacitors capacitor Cᵤ and capacitor C₁ to half the voltage level of charge source 150 by passing the positive DC charge signal to DC+ line 1363-1, the negative DC charge signal to DC− line 1363-3, and the neutral points N₁ to N₃ to intermediate DC line 1363-2. The output DC signal of SSCD 1120 provided to DC power bus 1136 can be the same as the DC charge signal, thus providing power to auxiliary load(s) 301 during charging.

The embodiments described above can be implemented to provide power to various types of three-phase AC motors, such as Y-connected motors and delta-connected motors. Simply rotating connector 1310-2 and dynamically adding or removing a bus bar enables the same module pack 1110 and SSCD 1120 to be used for both single motor and two-motor control, which simplifies manufacturing and increases the flexibility of systems 100 that include these module packs 1110 and SSCDs 1120. This also allows for the same hardware to be installed in front-wheel drive (FWD) EVs, rear-wheel drive (RWD) EVs, and all-wheel drive (AWD) EVs.

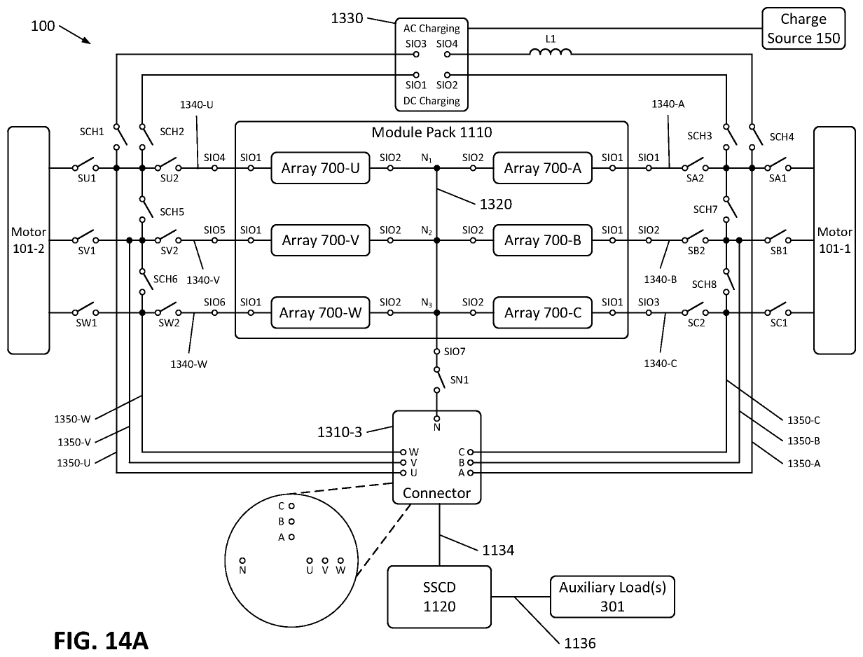

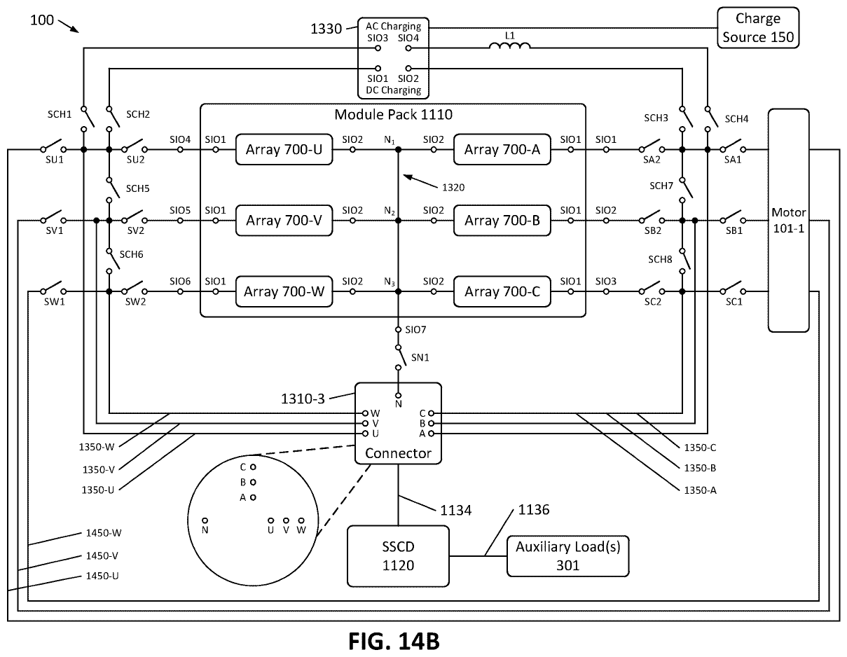

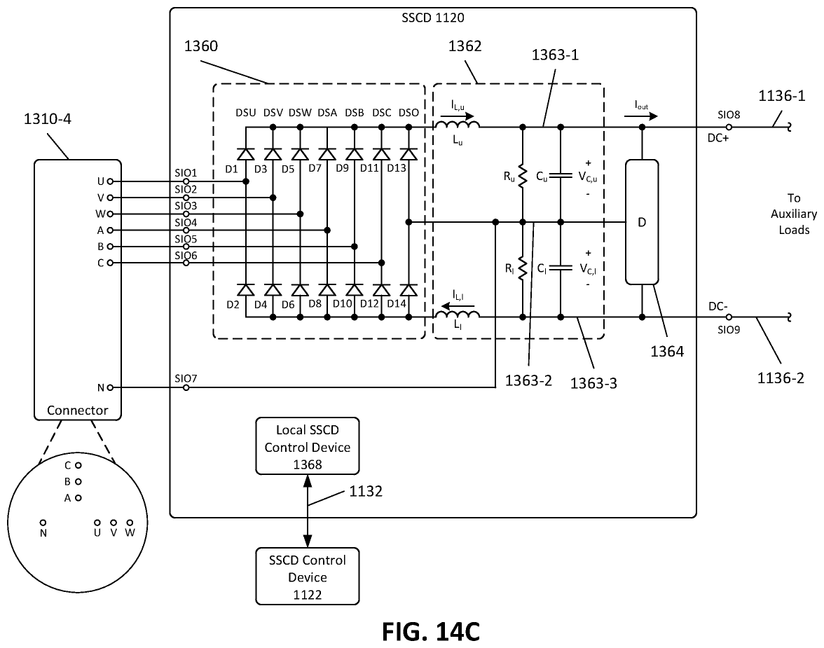

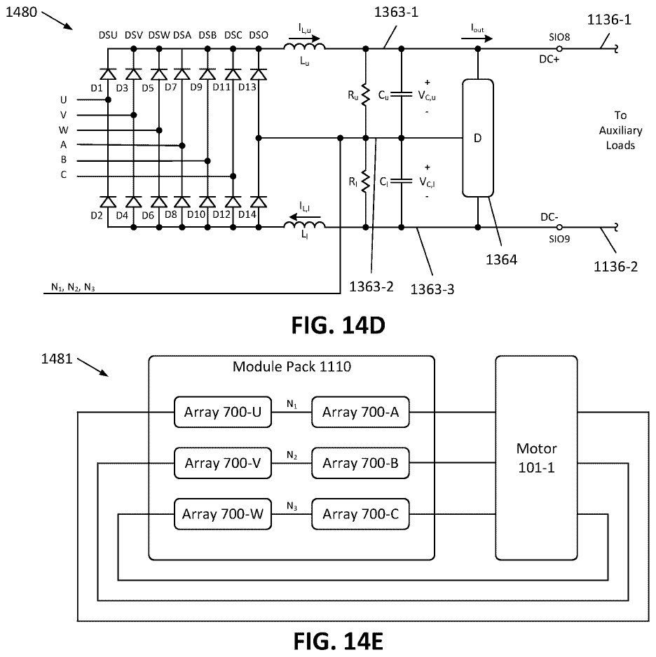

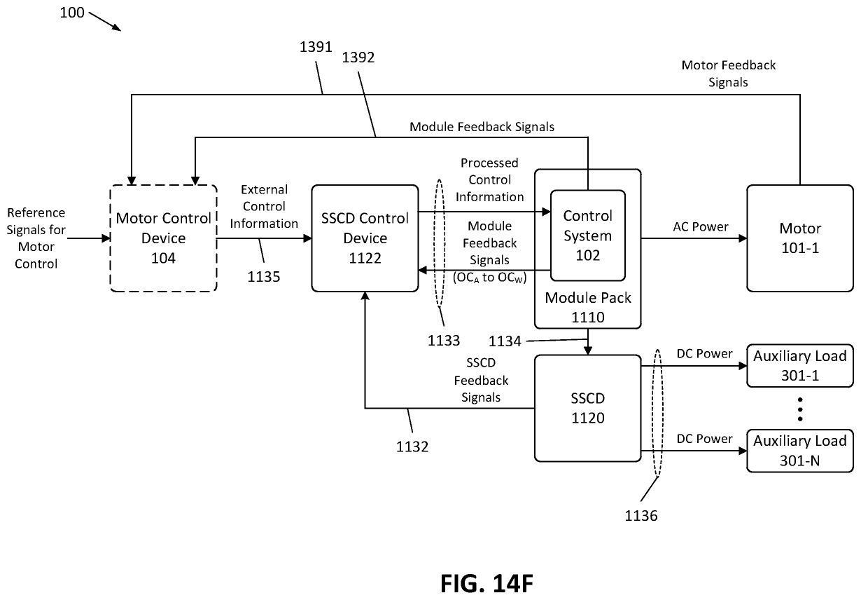

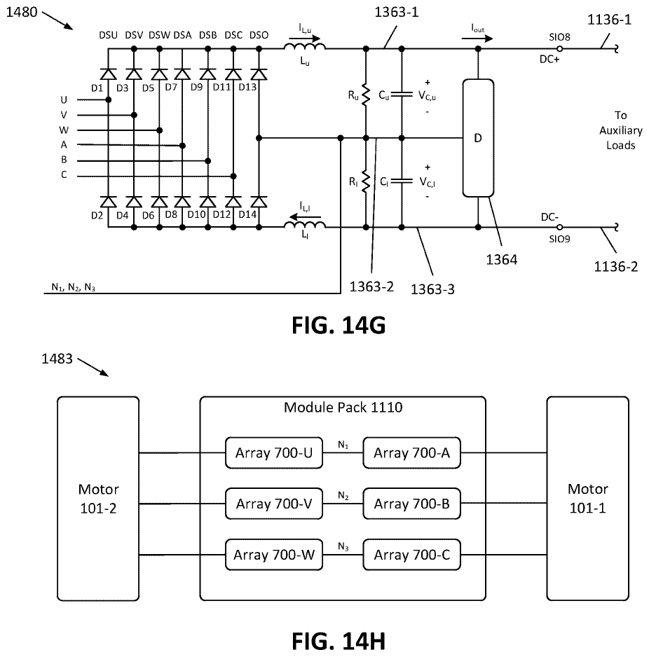

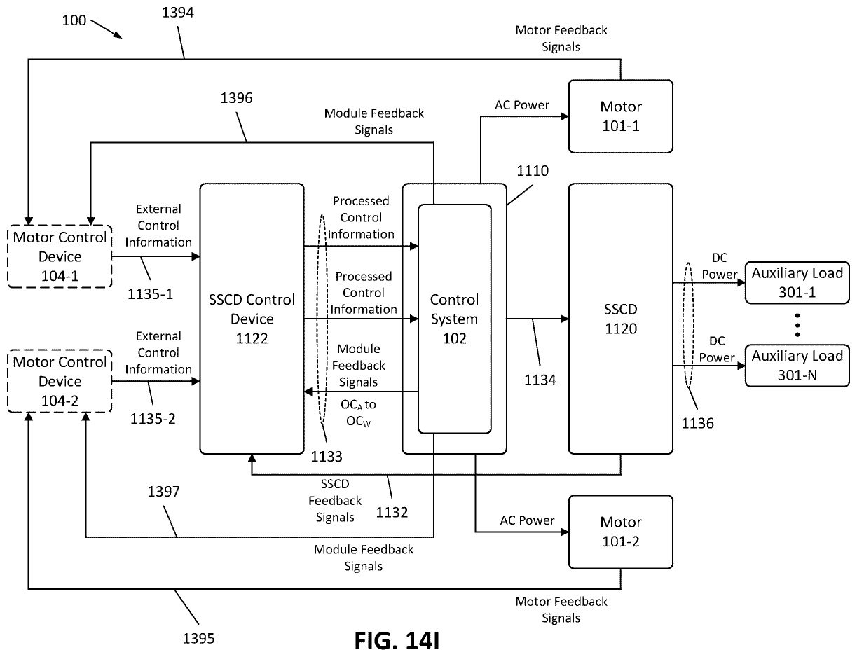

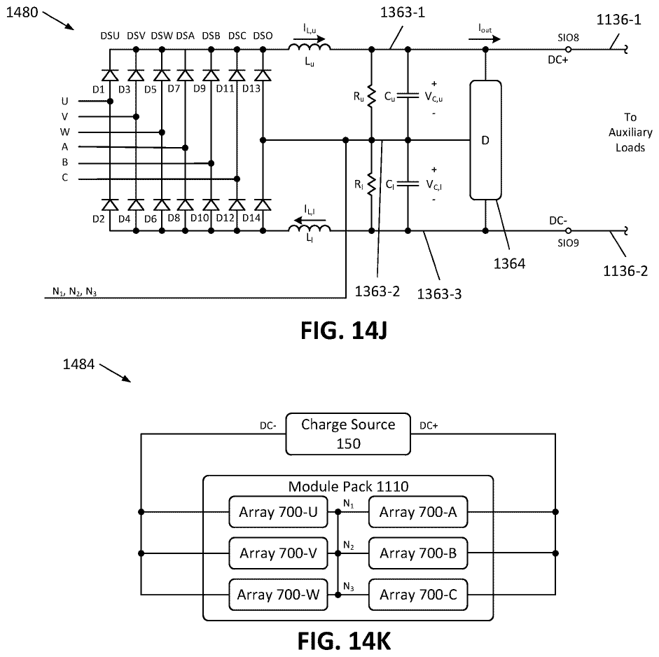

FIGS. 14A-14K illustrate additional embodiments of systems 100 that include a module pack 1110 and an SSCD 1120. In these embodiments, the same module pack 1110 and SSCD 1120 can be used for both single motor and two-motor controls without rotating a connector or adding or removing a bus bar. These embodiments can be used with open-winding motors in single motor embodiments, but may not be compatible with all types of motors in single motor embodiments.

FIG. 14A is a block diagram of an example embodiment of a modular energy system 100 having a module pack 1110 and an SSCD 1120 for providing power to two motors 101-1 and 101-2, and to one or more auxiliary load(s) 301. System 100 of FIG. 14A is similar to system 100 of FIG. 13A but has a different connector configuration for cable 1134 and different neutral connections.

In this embodiment, module pack 1110 includes a connector 1310-3 that is configured to releasably couple with a connector of cable 1134. SSCD 1120 can also include a connector 1310-4 (FIG. 14C) for releasably coupling with a connector of cable 1134. The connector on each end of cable 1134 can have the same configuration as connector 1310-3. That is, the connector on each end of cable 1134 can have the same ports in the same orientation as those shown in FIG. 14A.

Like connector 1310-1, connector 1310-3 includes ports A to C for coupling with system I/O ports SIO1 of arrays 700-A to 700-C by way of lines 1350-A to 1350-C and 1340-A to 1340-C, respectively, and includes ports U to W for coupling with system I/O ports SIO1 of arrays 700-U to 700-W by way of lines 1350-U to 1350-W and 1340-U to 1340-W, respectively. However, connector 1310-3 includes one neutral port N that couples with the common neutral point of segments AU, BV, and CW by way of switch SN1 and SIO port SIO7 of module pack 1110 rather than the three neutral ports of connector 1310-1. Example techniques for controlling system 100 of FIG. 14A are described below with reference to FIGS. 14G-14I.

FIG. 14B is a block diagram of an example embodiment of a modular energy system 100 having a module pack 1110 and an SSCD 1120 for providing power to a single motor 101 and to one or more auxiliary load(s) 301. System 100 of FIG. 14B is similar to system 100 of FIG. 13B but has a different connector configuration for cable 1134 and different neutral connections. In particular, this embodiment uses the same connector 1310-3 and associated connections as the embodiment of FIG. 14A.

In addition, the phase outputs of all six arrays 700-A to 700-W are coupled to motor 101-2. In particular, system I/O ports SIO1 of arrays 700-U, 700-V, and 700-W are selectively coupled to motor 101-1 by way of lines 1450-U, 1450-V, and 1450-W and their switches SU1, SV1, and SW1, respectively. In this embodiment, arrays 700-A to 700-W are configured and/or operated such that system I/O ports SIO1 of each array 700-A to 700-W is the phase port and system I/O port SIO2 is the neutral port.

In this configuration, motor 101-1 can be an open-winding motor 101-1 that is controlled based on voltage differences between the phase outputs of arrays 700-A to 700-C and the corresponding phase outputs of arrays 700-U to 700-W (e.g., based on the difference between the AC voltage output of array 700-A and the AC voltage output of array 700-U, the difference between the AC voltage output of array 700-B and the AC voltage output of array 700-V, and the difference between the AC voltage output of array 700-C and the AC voltage output of array 700-W). Example techniques for controlling system 100 of FIG. 14A are described below with reference to FIGS. 14D-14F.

FIG. 14C is a block diagram of an example embodiment of an SSCD 1120 for providing power to auxiliary loads. This embodiment of SSCD 1120 is similar to the embodiment of SSCD 1120 shown in FIG. 13D, but has a different connector 1310-4 for coupling with a corresponding connector of cable 1134 and does not include relay 1361. Relay 1361 is not used here as the same equivalent configuration of SSCD 1120 can be used for one and two motor control. This embodiment of SSCD 1120 can be used as the SSCD for each embodiment shown in FIGS. 14A-14B and described herein.

Connectors 1310-3 and 1310-4 both have the same ports, A, B, C, U, V, W, and N, which can be in the same configuration. Ports having the same designator on both connectors 1310-3 and 1310-4 are coupled together by conductors of cable 1134. For example, port A of connector 1310-3 is coupled to port A of connector 1310-4 by way of a conductor.

FIG. 14D is a diagram of an example equivalent rectifier circuit during single motor control and FIG. 14E is a diagram of an example equivalent module pack configuration during single motor control.

When operating motor 101-1, control system 102 1122 can close switches SA1, SA2, SB1, SB2, SC1, and SC2 to couple the phase outputs of arrays 700-A, 700-B, and 700-C to motor 101-1. Similarly, control system 102 can close switches SU1, SU2, SV1, SV2, SW1, and SW2 to couple the phase outputs of arrays 700-U, 700-V, and 700-W to motor 101-1. Here, the phase outputs of arrays 700-A to 700-C are coupled to system I/O ports SIO4 to SIO6 of SSCD 1120 and to diode segments DSA to DSC, respectively. Similarly, the phase outputs of arrays 700-U to 700-W are coupled to system I/O ports SIO1 to SIO3 of SSCD 1120 and to diode segments DSU to DSW, respectively.

Control system 102 can also open switches SCH1 to SCH4 to isolate charge source 150 from the components of system 100. Control device 102 or SSCD control device 1122 can also close switches SN1 to couple the common neutral points N₁ to N₃ of arrays 700 of module pack 1110 to intermediate DC line 1363-2.

In the illustrated configuration, the phase outputs of arrays 700-A to 700-C and/or the phase outputs of arrays 700-U to 700-W charge capacitors Cᵤ and C₁ during the operation of motor 101-1 for providing an output DC signal to auxiliary load(s) 301, as described in more detail herein.

FIG. 14F is a diagram of an example control scheme for single motor control using system 100 of FIGS. 14A and 14C. The control scheme is similar to that of FIG. 13H, but includes the use of module feedback signals by SSCD control device 1122 to perform balancing techniques.

External motor control device 104 is configured to provide control information to SSCD control device 1122 over communication path or link 1135. This external control information can include a modulation index for each phase of AC signal being provided to motor 101-1, a modulated reference signal for each phase, or a modulation index and reference signal for each phase, or other control information.

Each segment of arrays (e.g., segments, AU, BV, and CW) can output a single-phase AC signal that includes a superposition of output voltages from the modules of the arrays in the segment. For single motor control, the external control information for a phase can be for the segment outputting the AC signal for that phase (e.g., that has the corresponding phase angle). In the illustrated example, the external control information would include control information for array segment AU, array segment BV, and array segment CW.

Motor control device 104 can generate the external control information based on a reference signal for motor control, motor feedback signals received from motor 101-1 over communication path or link 1391, and/or module feedback signals received from control system 102 of module pack 1110 over communication path or link 1133, as described above with reference to FIG. 13H. Motor control device 104 can provide the external control information to SSCD control device 1122 over communication path or link 1135.

SSCD control device 1122 is configured to process the external control information and generate processed control information based on a reference signal for SSCD 1120 (e.g., a reference for the output DC signal), SSCD feedback signals received from SSCD 1120 over communication path or link 1132 and/or module feedback signals received from control system 102 of module pack 1110 over communication path or link 1133. The processed control information can include a modulation index for each phase or a modulated reference signal for each phase.

The SSCD feedback signals can include, for example, sensed voltages and/or currents of SSCD 1120. For example, the SSCD feedback signals can include voltage level V_{c,u} across capacitor Cᵤ, voltage level V_{c,1} across capacitor C₁, current I_{L,u} through inductor Lᵤ, and/or current I_{L,1} through inductor Lᵢ.

In this example, the module feedback signals can include, for example, one or more operating characteristics of each array 700-A to 700-W, which are designated as OC_{A} to OC_{W} in FIG. 14F. As described above, the operating characteristics can include, for example, aggregated values of SOC, SOH, temperature, voltage, current, SOP, and/or SOE of arrays 700-A to 700-W.

Processing the control information can include adjusting the control information, e.g., adjusting the modulation index for one or more phases and/or the modulation reference signal for one or more phases. In general, SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136.

To regulate the voltage level of the output DC signal, SSCD control device 1122 can regulate voltage level V_{c,u} across capacitor Cᵤ and/or voltage level V_{c,1} across capacitor C₁ as the voltage level of the output DC signal is the sum of these voltage levels. In some embodiments, SSCD control device 11220 can be configured to balance voltage levels V_{c,u} and V_{c,1}.

SSCD control device 1122 can regulate V_{c,u} and V_{c,1} by adjusting the external control information to increase or decrease the amount of energy being transferred from module pack 1110 to capacitors Cᵤ and C₁. For example, if the voltage level of the output DC signal is less than a reference voltage for the output DC signal, SSCD control device 1122 can adjust the external control information to increase the amount of energy being transferred from module pack 1110 to capacitors Cᵤ and C₁. If the voltage level of the output DC signal is greater than a reference voltage for the output DC signal, SSCD control device 1122 can adjust the external control information to decrease the amount of energy being transferred from module pack 1110 to capacitors Cᵤ and C₁.

SSCD control device 1122 can balance the voltage levels V_{c,u} and V_{c,1} by adjusting the external control information to increase or decrease the amount of energy transferred from module pack 1110 to capacitors Cᵤ and C₁. For example, SSCD control device 1122 can compare a reference voltage for each capacitor (e.g., which can be half of the reference voltage for the output DC signal) to the sensed value for the capacitor. Based on one or both of these comparisons and/or a comparison between the reference voltage for the output DC signal and the sum of the sensed values of V_{c,u} and V_{c,1}. Using these comparisons, SSCD control device 1122 can determine whether to increase, or decrease the amount of energy being transferred from module pack 1110 to capacitors Cᵤ and C₁.

If SSCD control device 1122 determines to adjust the external control information to increase or decrease the amount of energy being transferred to capacitors Cᵤ and C₁, SSCD control device 122 can adjust the modulation index and/or modulated reference signal for all three phases in the same manner, e.g., by increasing or decreasing the values by the same amount, or in different manners for balancing purposes.

Processing the external control information can also include adjusting the external control information to balance one or more operating characteristics of arrays 700-A to 700-W. For open-winding motors, increasing or decreasing the voltage of both phase signals of the same phase (e.g., phase output of array 700-A and phase output of array 700-U) by the same amount does not affect the control of motor 101-2 as the increases or decreases cancel each other out.

SSCD control device 1122 can perform subpack balancing techniques to balance one or more operating characteristics of arrays 700-A to 700-W. One type of subpack balancing includes balancing operation characteristics on a segment-by-segment basis, which can be referred to as segment subpack balancing. In this example, SSCD control device 1122 can adjust the amount of energy output by one or more segments AU, BV, and CW to balance one or more aggregate operating characteristics of segments AU, BV, and CW and/or to balance one or more aggregate operating characteristics of arrays 700-A to 700-W in segments AU, BV, and CW. In this way, increasing the amount of energy output by a segment AU, BV, or CW does not affect motor control, but can achieve balancing between segments AU, BV, and CW and arrays 700-A to 700-W, and provide regulated DC power to auxiliary load(s) 301. This is a form of interphase balancing using segment subpacks.

In segment subpack balancing, SSCD control device 1122 can select a segment AU, BV, or CW to contribute more to powering auxiliary load(s) 301 based on the aggregate operating characteristic(s) of each segments AU, BV, and CW and/or the aggregate operating characteristic(s) of each arrays 700-A to 700-W.

For example, if the aggregate SOC of subpack AU is greater than the aggregate SOC of subpacks BV and CW, SSCD control device 1122 can select segment AU to output more energy for powering auxiliary load(s) 301. In this example, SSCD control device 1122 can adjust the control information for subpack AU (e.g., by increasing a modulation index for arrays 700-A and 700-U) to cause arrays 700-A and 700-U to output more energy. Similarly, SSCD control device 1122 can adjust the control information for subpacks BV and/or CW (e.g., by decreasing a modulation index for arrays 700-B and 700-V and/or arrays 700-C and 700-W) to cause arrays 700-B and 700-V and/or arrays 700-C and 700-W to output less energy.

In another example, if the SOC of array 700-A is lower than the SOC of each other array 700-B to 700-W, SSCD control device 1122 can reduce the amount of energy output by arrays 700-A and 700-U, and select segment BV and/or segment CW to output more energy that is transferred to capacitors Cᵤ and C₁ for powering auxiliary load(s) 301. To do this, SSCD control device 1122 can adjust the external control information to decrease the modulation indexes for arrays 700-A and 700-U of segment AU, and increase the modulation indexes for arrays 700-B and 700-V of segment BV and/or the modulation indexes for arrays 700-C and 700-W of segment CW. In this way, the SOCs of arrays 700-B, 700-C, 700-V, and 700-W trend lower faster than the SOCs of arrays 700-A and 700-U to balance the SOCs among arrays 700-A to 700-W.

In this embodiment, SSCD control device 1122 can be configured to perform multiphase subpack balancing between subpacks ABC and UVW. As both of these multiphase subpacks provide AC power to motor 101-1 in this embodiment, SSCD control device 1122 can adjust the amount of energy provided to motor 101-1 by subpacks ABC and UVW to balance one or more aggregate operating characteristics of subpack ABC with subpack UVW. For example, SSCD control device 1122 can select a subpack ABC or UVW to contribute more to motor 101-1 based on the aggregate operating characteristic(s) of each subpack ABC and UVW and/or the aggregate operating characteristic(s) of each arrays 700-A to 700-W.

For example, if the aggregate SOC of subpack ABC is greater than the aggregate SOC of subpack UVW, SSCD control device 1122 can select subpack ABC to output more energy for powering motor 101-1. In this example, SSCD control device 1122 can adjust the control information for arrays 700-A to 700-C of subpack ABC (e.g., by increasing a modulation index for arrays 700-A to 700-C) to output more energy. Similarly, SSCD control device 1122 can adjust the control information for subpack UVW (e.g., by decreasing a modulation index for arrays 700-U to 700-W) to cause arrays 700-U to 700-W to output less energy.

In another example, if the SOC of array 700-A is lower than the SOC of each other array 700-B to 700-W, SSCD control device 1122 can reduce the amount of energy output by arrays 700-A to 700-C of subpack ABC. To do this, SSCD control device 1122 can adjust the external control information to decrease the modulation indexes for arrays 700-A to 700-C of subpack ABC, and increase the modulation indexes for arrays 700-U to 700-W of subpack UVW.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, the AC signals generated by arrays 700-A to 700-W are provided to motor 101-1.

In addition, the AC signals generated by arrays 700-A to 700-C and/or the AC signals generated by arrays 700-U to 700-W are provided to SSCD 1120 by way of cable 1134. SSCD 1120 converts the AC signals to a DC signal and outputs the DC signal onto DC power bus 1136 to power auxiliary loads 301.

FIGS. 14G-14I illustrate example techniques for controlling components of the example embodiments of system 100 shown in FIGS. 14A and 14C for providing and regulating AC power to two motors 101-1 and 101-2 of an EV and for providing and regulating DC power to auxiliary load(s) 301.

FIG. 14G is a diagram of an example equivalent rectifier circuit 1480 during two-motor control and FIG. 14G is a diagram of an example equivalent module pack configuration 1483 during two-motor control. In this example, equivalent rectifier circuit 1480 is the same as equivalent rectifier circuit 1480 of FIG. 14D as the connectors 1310-3 and 1310-4 are the same for both embodiments and the switch configurations of both systems 100 are the same. Equivalent module pack configuration 1483 differs from equivalent module pack configuration 1481 as arrays 700-U to 700-W are coupled to motor 101-2 rather than motor 101-1.

FIG. 14I is a diagram of an example control scheme for two-motor control. The control scheme is similar that of FIG. 13K, but includes balancing techniques.

As described with reference to FIG. 13K, external motor control device 104-1 is configured to generate and provide external control information for arrays 700-A to 700-C to SSCD control device 1122 over communication path or link 1135-1. Similarly, external motor control device 104-2 is configured to generate and provide external control information for arrays 700-U to 700-W to SSCD control device 1122 over communication path or link 1135-2.

SSCD control device 1122 is configured to process the external control information from each motor control device 104-1 and 104-2 and generate processed control information for subpack ABC and subpack UVW based on a voltage reference for SSCD 1120 (e.g., a reference for the output DC signal), SSCD feedback signals received from SSCD 1120 over communication path or link 1132 and/or module feedback signals received from control system 102 of module pack 1110 over communication path or link 1133. The processed control information for a subpack ABC or UVW can include a modulation index for each phase for that subpack ABC or UVW or a modulated reference signal for each phase of that subpack ABC or UVW. Thus, the processed control information for a subpack ABC or UVW can include a modulation index or modulated reference signal for each array 700 in the subpack ABC or UVW.

The SSCD feedback signals can include, for example, sensed voltages and/or currents of SSCD 1120. For example, the SSCD feedback signals can include voltage level V_{c,u} across capacitor Cᵤ, voltage level V_{c,1} across capacitor C₁, current I_{L,u} through inductor Lᵤ, and/or current I_{L,1} through inductor Lᵢ.

In this example, the module feedback signals can include, for example, one or more operating characteristics of each array 700-A to 700-W, which are designated as OC_{A} to OC_{W} in FIG. 14I. As described above, the operating characteristics can include, for example, aggregated values of SOC, SOH, temperature, voltage, current, SOP, and/or SOE of arrays 700-A to 700-W.

Processing the control information can include adjusting the control information, e.g., adjusting the modulation index for one or more phases and/or the modulation reference signal for one or more phases. SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136.

To regulate the voltage level of the output DC signal, SSCD control device 1122 can regulate voltage level V_{c,u} across capacitor Cᵤ and voltage level V_{c,1} across capacitor C₁ as the voltage level of the output DC signal is the sum of these voltage levels. In some embodiments, SSCD control device 11220 can be configured to balance voltage levels V_{c,u} and V_{c,1}.

SSCD control device 1122 can regulate V_{c,u} and V_{c,1} by adjusting the external control information for one or both subpacks ABC and UVW to increase or decrease the amount of energy being transferred from module pack 1110 to capacitors Cᵤ and C₁. For example, if the voltage level of the output DC signal is less than a reference voltage for the output DC signal, SSCD control device 1122 can adjust the external control information one or both subpacks ABC and UVW to increase the amount of energy being transferred from module pack 1110 to capacitors Cᵤ and C₁. If the voltage level of the output DC signal is greater than a reference voltage for the output DC signal, SSCD control device 1122 can adjust the external control information one or both subpacks ABC and UVW to decrease the amount of energy being transferred from module pack 1110 to capacitors Cᵤ and C₁.

SSCD control device 1122 can balance the voltage levels V_{c,u} and V_{c,1} by adjusting the external control information one or both subpacks ABC and UVW to increase or decrease the amount of energy transferred from module pack 1110 to capacitors Cᵤ and C₁. For example, SSCD control device 1122 can compare a reference voltage for each capacitor (e.g., which can be half of the reference voltage for the output DC signal) to the sensed value for the capacitor. Based on one or both of these comparisons and/or a comparison between the reference voltage for the output DC signal and the sum of the sensed values of V_{c,u} and V_{c,1}. Using these comparisons, SSCD control device 1122 can determine whether to increase, decrease, or to not adjust the amount of energy being transferred from module pack 1110 to capacitors Cᵤ and C₁.

If SSCD control device 1122 determines to adjust the external control information one or both subpacks ABC and UVW to increase or decrease the amount of energy being transferred to capacitors Cᵤ and C₁, SSCD control device 122 can adjust the modulation index and/or modulated reference signal for all three phases of the subpack(s) in the same manner, e.g., by increasing or decreasing the values by the same amount, or in different manners for balancing purposes.

Similar to the single motor control described with reference to FIG. 14F, SSCD control device 1122 can also perform multiphase balancing techniques to balance one or more aggregated operating characteristics of subpack ABC with one or more aggregated operating characteristics of subpack UVW. To avoid affecting operation of motors 101-1 and 101-2 in performing this balancing, SSCD control device 1122 can be configured to make the same adjustment to the control information for each phase of a subpack ABC of UVW to adjust the common mode voltage of the AC signal provided to motor 101-1 or motor 101-2.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, the AC signals generated by arrays 700-A to 700-C are provided to motor 101-1 and AC signals generated by arrays 700-U to 700-W are provided to motor 101-2.

In addition, the AC signals generated by arrays 700-A to 700-C and the AC signals generated by arrays 700-U to 700-W are provided to SSCD 1120 by way of cable 1134. SSCD 1120 converts the AC signals to a DC signal and outputs the DC signal onto DC power bus 1136 to power auxiliary loads 301.

Control system 102 can be configured to control charging of energy sources 206 of modules 108 of module pack 1110 while providing DC power to auxiliary load(s) 301 in both single motor and two-motor embodiments.

FIGS. 14J and 14K illustrate example techniques for controlling components of the example embodiments of system 100 shown in FIGS. 14A-14C for charging energy sources 206 in both single motor and two-motor embodiments. FIG. 14J is a diagram of an example equivalent rectifier circuit 1480 during charging in single motor and two-motor embodiments. FIG. 14K is a diagram of an example equivalent module pack configuration 1484 during charging in single motor and two-motor embodiments.

In this example, the equivalent circuits are the same for both single motor and two-motor charging. In addition, equivalent rectifier circuit 1480 is the same as equivalent rectifier circuits 1480 of FIGS. 14D and 14G.

To charge energy sources 206 of arrays 700 of module pack 1110, control system 102 can couple charge source 150 to arrays 700-A to 700-W of module pack 1110 to route a charge signal to energy sources 206 of arrays 700-A to 700-W. To do so, control system 102 opens switches SA1, SB1, and SC1 to isolate module pack 1110 and charge source 150 from motor 101-1. Control system 102 can also open switches SU1, SV1, and SW1 to isolate module pack 1110 and charge source 150 from motor 101-1 or motor 101-2 (depending on whether a single motor or two-motor embodiment).

Control system 102 can close switches SA2, SB2, SC2, SU2, SV2, and SW2 to enable charge signals to reach arrays 700-A to 700-W from charge source 150. Control system 102 can also close switch SN1 to couple the common neutral points N₁ to N₃ to SSCD 1120. When DC charging using a DC charge source 150, control system 102 can close switches SCH2, SCH3, and SCH5-SCH8 to couple DC charge source 150 to arrays 700-A to 700-W and to SSCD 1120 by way of cable 1134 and ports A-C and U-W of connector 1310-3.

For DC charging, this switch configuration results in equivalent rectifier circuit 1480 and equivalent module pack configuration 1484 where the DC charge signal is provided to arrays 700-A to 700-W and to diode segments DSU to DSW and DSA to DSC. The positive DC charge signal can be provided to arrays 700-A to 700-C and the negative DC charge signal can be provided to arrays 700-U to 700-W.

During charging, SSCD controller 1122 can be bypassed as the DC voltage is constructed naturally from the DC charge signal coupled to SSCD 1120. The positive DC charge signal is passed through ports A-C of connector 1310-1 to diode segments DA to DC and the negative DC charge signal is passed through ports U-W of connector to diode segments DU to DW. The DC charge signal charges each capacitor Cu and CI to half the DC charge signal. The output DC signal of SSCD 1120 provided to DC power bus 1136 can be the same as the DC charge signal.

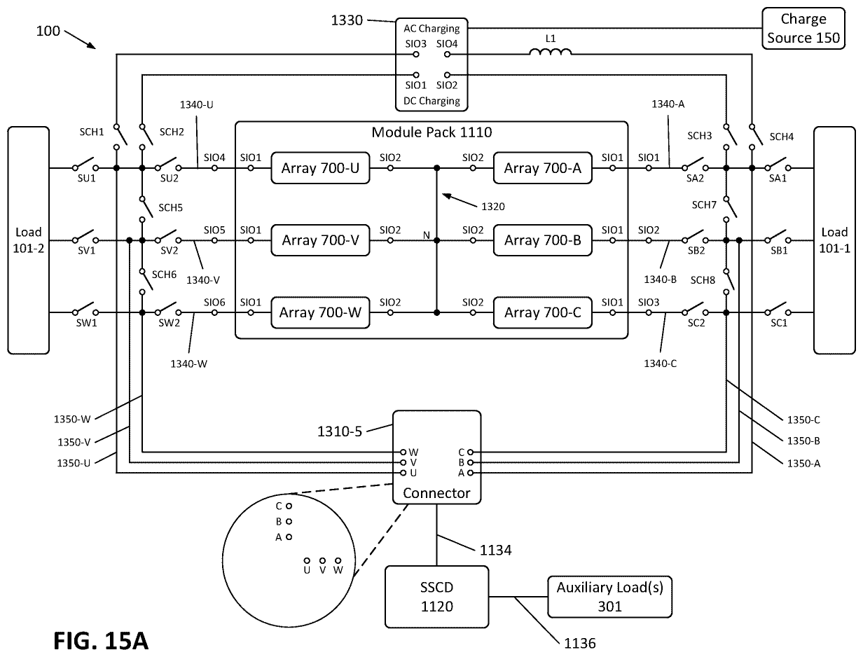

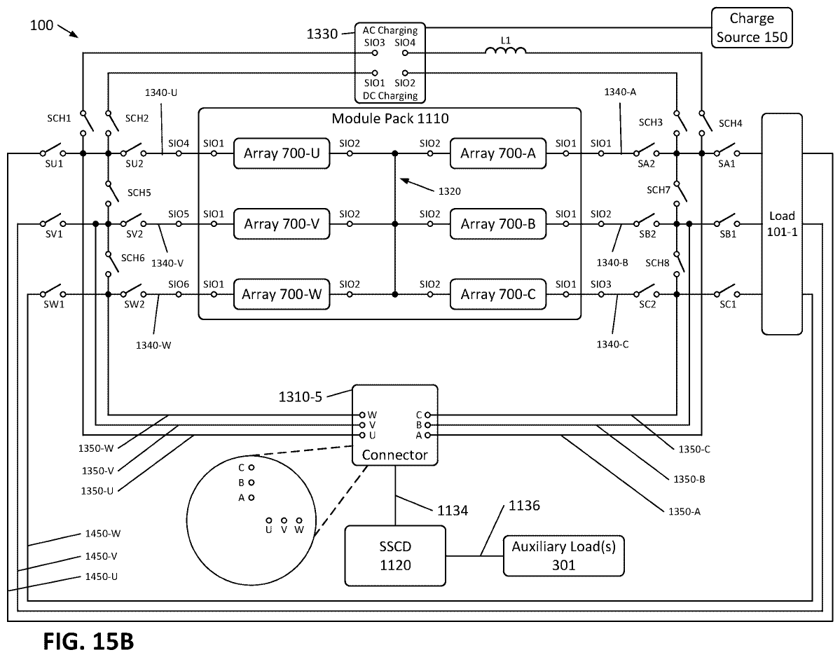

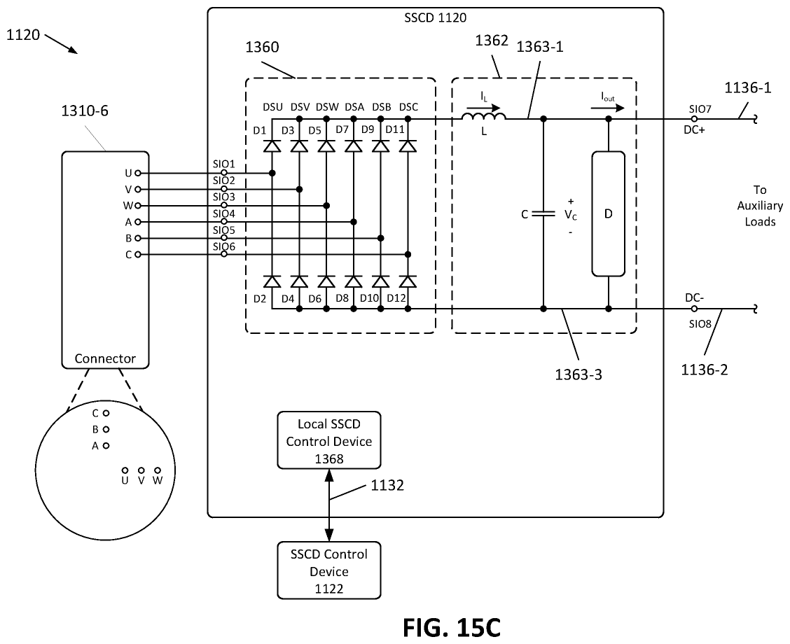

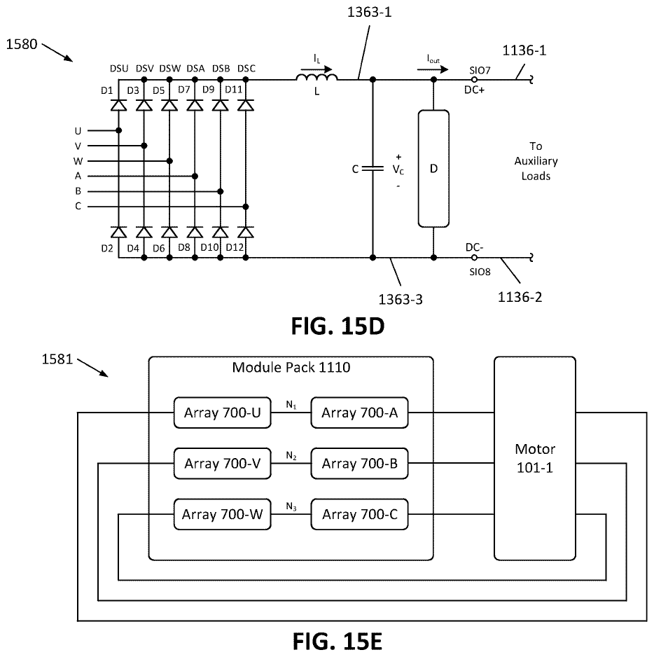

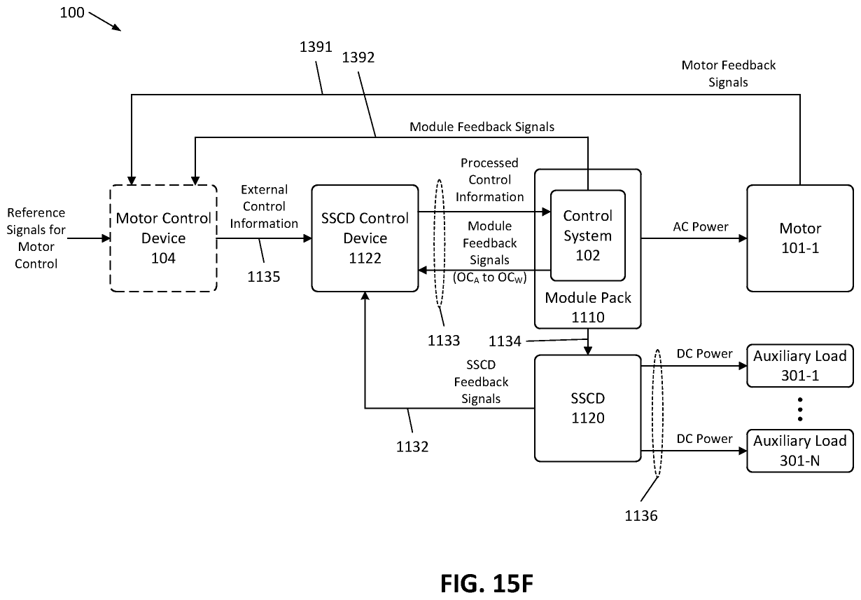

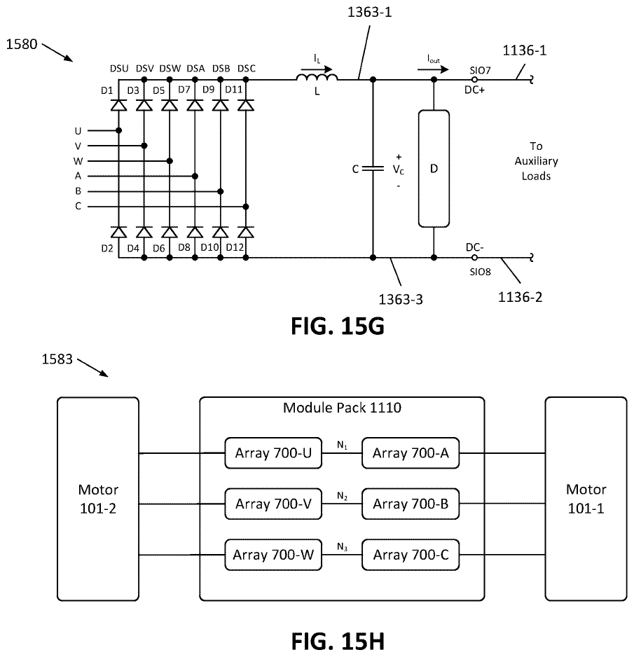

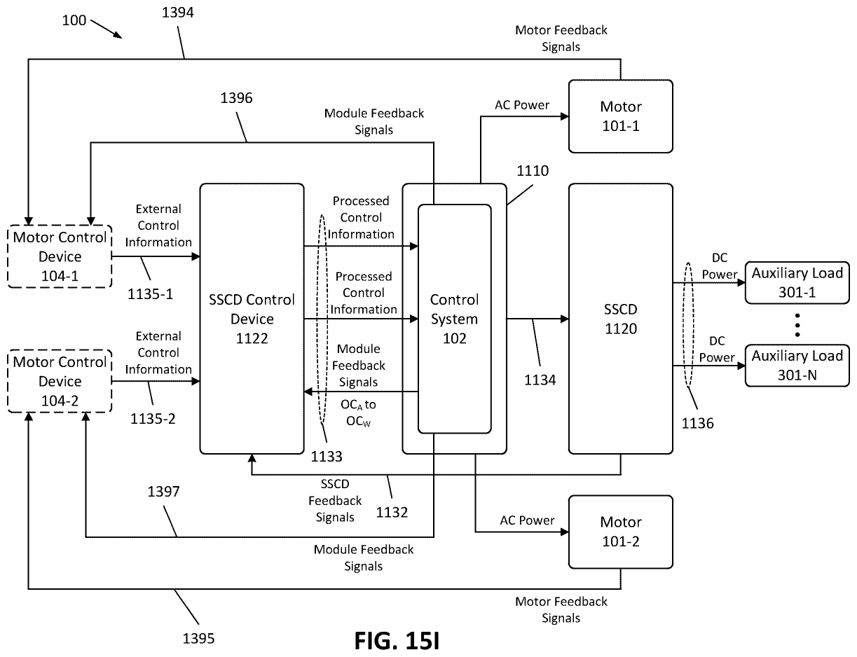

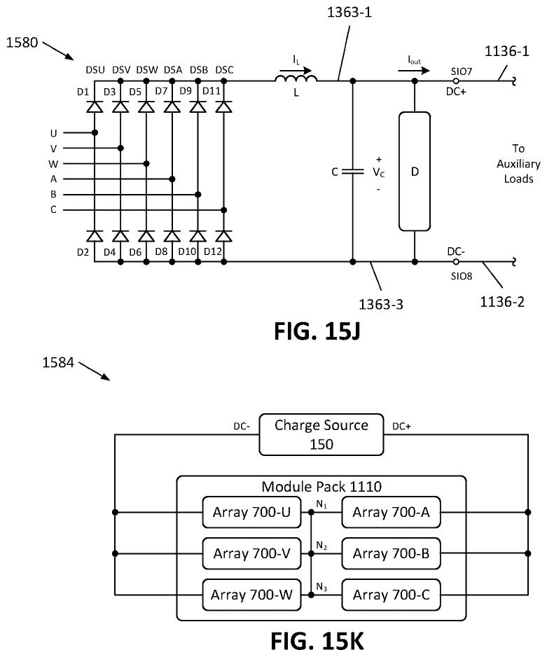

FIGS. 15A-15K illustrate additional embodiments of systems 100 that include a module pack 1110 and an SSCD 1120. Similar to the embodiments of FIGS. 14A-14K, in these embodiments the same module pack 1110 and SSCD 1120 can be used for both single motor and two-motor controls without rotating a connector or adding or removing a bus bar. These embodiments can be used with open-winding motors in single motor embodiments, but may not be compatible with all types of motors in single motor embodiments.

FIG. 15A is a block diagram of an example embodiment of a modular energy system 100 having a module pack 1110 and a SSCD 1120 for providing power to two motors 101-1 and 101-2, and to one or more auxiliary load(s) 301. System 100 of FIG. 15A is similar to system 100 of FIG. 14A but has a different connector configuration for cable 1134 as the neutral point is not transferred to SSCD 1120.

In this embodiment, module pack 1110 includes a connector 1310-5 that is configured to releasably couple with a connector of cable 1134. SSCD 1120 can also include a connector 1310-6 (FIG. 15C) for releasably coupling with a connector of cable 1134. The connector on each end of cable 1134 can have the same configuration as connector 1310-5. That is, the connector on each end of cable 1134 can have the same ports in the same orientation as those shown in FIG. 15A.

Like connector 1310-3, connector 1310-5 includes ports A to C for coupling with phase array ports SIO1 of arrays 700-A to 700-C by way of lines 1350-A to 1350-C and 1340-A to 1340-C, respectively, and includes ports U to W for coupling with phase array ports SIO1 of arrays 700-U to 700-W by way of lines 1350-U to 1350-W and 1340-U to 1340-W, respectively. However, connector 1310-5 does not include any neutral port and there is no system I/O port SIO7 or switch SN1 to couple the common neutral points of segments AU, BV, and CW to cable 1134 and on to SSCD 1220. Example techniques for controlling system 100 of FIG. 15A are described below with reference to FIGS. 15H-15K.

FIG. 15B is a block diagram of an example embodiment of a modular energy system 100 having a module pack 1110 and an SSCD 1120 for providing power to a single motor 101 and to one or more auxiliary load(s) 301. System 100 of FIG. 15B is similar to system 100 of FIG. 14B but has a different connector configuration for cable 1134. In particular, this embodiment uses the same connector 1310-5 as the embodiment of FIG. 15A and also does not include system I/O port SIO7 or switch SN1 to couple the common neutral points of segments AU, BV, and CW to cable 1134 and on SSCD 1220.

FIG. 15C is a block diagram of an example embodiment of an SSCD 1120 for providing power to auxiliary loads. This embodiment of SSCD 1120 can be used as the SSCD for each embodiment shown in FIGS. 15A-15B and described herein. This embodiment of SSCD 1120 differs from those of FIGS. 13D and 14C, as this embodiment does not include an intermediate DC line and therefore does not couple to the common neutral points of arrays 700 of module pack 1110.

SSCD 1120 includes system I/O ports SIO1-SIO6 for coupling with connector 1310-6 of cable 1134 and system I/O ports SIO7 and SIO8 for coupling with DC+ and DC− lines 1136-1 and 1136-2, respectively of a DC bus 1366 that routes DC power output by SSCD 1120 to auxiliary load(s) 301.

In particular, system I/O ports SIO1, SIO2, and SIO3 of SSCD 1220 are coupled to phase ports SIO1 of arrays 700-U, 700-V, and 700-W, respectively, by way of cable 1134. Similarly, system I/O ports SIO4, SIO5, and SIO6 of SSCD 1220 are coupled to phase ports SIO1 of arrays 700-A, 700-B, and 700-C, respectively, by way of cable 1134.

SSCD 1220 can include a rectifier circuit that includes a diode circuit 1360 and a filter circuit 1362. Diode circuit 1360 is configured as two three-phase full-wave rectifiers, one for arrays 700-A to 700-C and one for arrays 700-U to 700-W. Diode circuit 1360 includes diodes D1 to D12. Diode circuit 1360 includes three diode segments DSU, DSV, and DSW that form a three-phase full-wave rectifier for arrays 700-U to 700-W. Rectifier circuit 1360 also includes three diode segments DSA, DSB, and DSC to form a three-phase full-wave rectifier for arrays 700-A to 700-C. Each diode segment includes two diodes between which the phase output of an array 700 is coupled. For example, diode segment DSU includes diodes D1 and D2, and the phase port SIO1 of array 700-U is coupled between diodes D1 and D2 by way of cable 1134. The two diodes of each segment are coupled between DC+ line 1363-1 and DC− line 1363-3.

Diode circuit 1360 is coupled to filter circuit 1362 by way of DC lines 1363-1 and 1363-3. Filter circuit 1362 includes an inductor L on DC+ line 1363-1 a resistor Rᵤ coupled between DC+ line 1363-1 and intermediate DC line 1363-2 and a capacitor C coupled between DC+ line 1363-1 and DC− line 1363-3.

Diode circuit 1360 is configured to convert three-phase AC signals to voltage pulses of a same polarity, e.g., the positive polarity, across DC+ line 1363-1 and DC− line 1363-3. Capacitor C and inductor L are configured to filter these pulses to generate a constant or close to constant DC output signal across DC+ line 1136-1 and DC− line 1136-3 of DC bus 136. In this embodiment, capacitor C can be smaller and/or have a lower rating than capacitors of FIGS. 13D and 14C as capacitor C may not act as an energy buffer while capacitors of FIGS. 13D and 14C may act as energy buffers.

As described in more detail below, SSCD control device 1122 can regulate the voltage level V_{c}, across capacitor C to provide a target output DC voltage level across DC+ line 1136-1 and DC− line 1136-3. SSCD 1120 can include sensors for sensing voltage level V_{c} across capacitor C, output current Iₒᵤₜ, and current I_{L} through inductor L. The sensors can include voltage and current sensors. The outputs of the sensors can be communicatively coupled to SSCD control device 1122, e.g., using communication path or link 1132. For example, communication path or link 1132 can be communicatively coupled to each sensor and to relay 1361 using one or more conductors for each component.

SSCD 1120 includes a discharge circuit 1364 coupled to DC lines 1363-1 to 1363-3. Discharge circuit 1364 is configured to discharge capacitors Cᵤ and C₁ in response to the detection of a condition, such as a fault or short circuit, and/or during normal system shutdowns. Module pack 1110 can include isolation features, such as contactors, that can be opened to isolate the module pack 1110 and its components upon detection of a condition. This can prevent energy from being transferred to capacitor C. However, the energy stored in capacitor C should be discharged safely as well. Discharge circuit 1364 can discharge capacitors C safely and without sending the energy to load(s) 301 by way of DC bus 1136 or to module pack 1110.

FIGS. 15D-15F illustrate example techniques for controlling components of the example embodiments of system 100 shown in FIGS. 15B and 15C for providing and regulating AC power to a single motor 101-1 of an EV and for providing and regulating DC power to auxiliary load(s) 301.

FIG. 15D is a diagram of an example equivalent rectifier circuit 1580 during single motor control and FIG. 15E is a diagram of an example equivalent module pack 1581 configuration during single motor control.

When operating motor 101-1, control system 102 can close switches SA1, SA2, SB1, SB2, SC1, and SC2 to couple the phase outputs of arrays 700-A, 700-B, and 700-C to motor 101-1. Control system 102 can also open switches SCH1 to SCH4 to isolate charge source 150 from the components of system 100. Control system 102 can also close switches SU1, SU2, SV1, SV2, SV1, and SV2 to couple the phase outputs of arrays 700-U, 700-V, and 700-W to motor 101-1.

In the illustrated configuration, the phase outputs of arrays 700-A to 700-C and/or the phase outputs of arrays 700-U to 700-W charge capacitor C during operation of motor 101-1 for providing an output DC signal to auxiliary load(s) 301, as described in more detail below.

FIG. 15F is a diagram of an example control scheme for single motor control using system 100 of FIGS. 15A and 15C. The control scheme is similar to that of FIG. 14F but differs based on the configuration of SSCD 1120.

External motor control device 104 is configured to provide control information to SSCD control device 1122 over communication path or link 1135. This external control information can include a modulation index for each phase of AC signal being provided to motor 101-1, a modulated reference signal for each phase, or a modulation index and reference signal for each phase, or other control information.

Each segment of arrays (e.g., segments, AU, BV, and CW) can output a single-phase AC signal that includes a superposition of output voltages from the modules of the arrays in the segment. For single motor control, the external control information for a phase can be for the segment outputting the AC signal for that phase (e.g., that has the corresponding phase angle). In the illustrated example, the external control information would include control information for array segment AU, array segment BV, and array segment CW.

Motor control device 104 can generate the external control information based on a reference signal for motor control, motor feedback signals received from motor 101-1 over communication path or link 1391, and/or module feedback signals received from control system 102 of module pack 1110 over communication path or link 1133, as described above with reference to FIG. 13H. Motor control device 104 can provide the external control information to SSCD control device 1122 over communication path or link 1135.

SSCD control device 1122 is configured to process the external control information and generate processed control information based on a reference signal for SSCD 1120 (e.g., a reference for the output DC signal), SSCD feedback signals received from SSCD 1120 over communication path or link 1132 and/or module feedback signals received from control system 102 of module pack 1110 over communication path or link 1133. The processed control information can include a modulation index for each phase or a modulated reference signal for each phase.

The SSCD feedback signals can include, for example, sensed voltages and/or currents of SSCD 1120. For example, the SSCD feedback signals can include voltage level V_{c} across capacitor C and/or current I_{L} through inductor L.

In this example, the module feedback signals can include, for example, one or more operating characteristics of each array 700-A to 700-W, which are designated as OC_{A} to OC_{W} in FIG. 15F. As described above, the operating characteristics can include, for example, aggregated values of SOC, SOH, temperature, voltage, current, SOP, and/or SOE of arrays 700-A to 700-W.

Processing the control information can include adjusting the control information, e.g., adjusting the modulation index for one or more phases and/or the modulation reference signal for one or more phases. In general, SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136. To regulate the voltage level of the output DC signal, SSCD control device 1122 can regulate voltage level V_{c} across capacitor C as the voltage level of the output DC signal is the same as this voltage level.

SSCD control device 1122 can regulate V_{c}, by adjusting the external control information to increase or decrease the amount of energy being transferred from module pack 1110 to capacitor C. For example, if the voltage level of the output DC signal is less than a reference voltage for the output DC signal, SSCD control device 1122 can adjust the external control information to increase the amount of energy being transferred from module pack 1110 to capacitor C. If the voltage level of the output DC signal is greater than a reference voltage for the output DC signal, SSCD control device 1122 can adjust the external control information to decrease the amount of energy being transferred from module pack 1110 to capacitor C.

If SSCD control device 1122 determines to adjust the external control information to increase or decrease the amount of energy being transferred to capacitors C, SSCD control device 122 can adjust the modulation index and/or modulated reference signal for all three phases in the same manner, e.g., by increasing or decreasing the values by the same amount, or in different manners for balancing purposes.

Processing the external control information can also include adjusting the external control information to balance one or more operating characteristics of arrays 700-A to 700-W. For open-winding motors, increasing or decreasing the voltage of both phase signals of the same phase (e.g., phase output of array 700-A and phase output of array 700-U) by the same amount does not affect the control of motor 101-2 as the increases or decreases cancel each other out.

SSCD control device 1122 can perform subpack balancing techniques to balance one or more operating characteristics of arrays 700-A to 700-W. One type of subpack balancing includes balancing operation characteristics on a segment-by-segment basis, which can be referred to as segment subpack balancing. In this example, SSCD control device 1122 can adjust the amount of energy output by one or more segments AU, BV, and CW to balance one or more aggregate operating characteristics of segments AU, BV, and CW and/or to balance one or more aggregate operating characteristics of arrays 700-A to 700-W in segments AU, BV, and CW. In this way, increasing the amount of energy output by a segment AU, BV, or CW does not affect motor control, but can achieve balancing between segments AU, BV, and CW and arrays 700-A to 700-W, and provide regulated DC power to auxiliary load(s) 301.

In segment subpack balancing, SSCD control device 1122 can select a segment AU, BV, or CW to contribute more to powering auxiliary load(s) 301 based on the aggregate operating characteristic(s) of each segments AU, BV, and CW and/or the aggregate operating characteristic(s) of each arrays 700-A to 700-W.

For example, if the aggregate SOC of subpack AU is greater than the aggregate SOC of subpacks BV and CW, SSCD control device 1122 can select segment AU to output more energy for powering auxiliary load(s) 301. In this example, SSCD control device 1122 can adjust the control information for subpack AU (e.g., by increasing a modulation index for arrays 700-A and 700-U) to cause arrays 700-A and 700-U to output more energy. Similarly, SSCD control device 1122 can adjust the control information for subpacks BV and/or CW (e.g., by decreasing a modulation index for arrays 700-B and 700-V and/or arrays 700-C and 700-W) to cause arrays 700-B and 700-V and/or arrays 700-C and 700-W to output less energy.

In another example, if the SOC of array 700-A is lower than the SOC of each other array 700-B to 700-W, SSCD control device 1122 can reduce the amount of energy output by arrays 700-A and 700-U, and select segment BV and/or segment CW to output more energy that is transferred to capacitors Cu and Ci for powering auxiliary load(s) 301. To do this, SSCD control device 1122 can adjust the external control information to decrease the modulation indexes for arrays 700-A and 700-U of segment AU, and increase the modulation indexes for arrays 700-B and 700-V of segment BV and/or the modulation indexes for arrays 700-C and 700-W of segment CW. In this way, the SOCs of arrays 700-B, 700-C, 700-V, and 700-W trend lower faster than the SOCs of arrays 700-A and 700-U to balance the SOCs among arrays 700-A to 700-W.

In this embodiment, SSCD control device 1122 can be configured to perform multiphase subpack balancing between subpacks ABC and UVW. As both of these multiphase subpacks provide AC power to motor 101-1 in this embodiment, SSCD control device 1122 can adjust the amount of energy provided to motor 101-1 by subpacks ABC and UVW to balance one or more aggregate operating characteristics of subpack ABC with subpack UVW. For example, SSCD control device 1122 can select a subpack ABC or UVW to contribute more to motor 101-1 based on the aggregate operating characteristic(s) of each subpack ABC and UVW and/or the aggregate operating characteristic(s) of each arrays 700-A to 700-W.

For example, if the aggregate SOC of subpack ABC is greater than the aggregate SOC of subpack UVW, SSCD control device 1122 can select subpack ABC to output more energy for powering motor 101-1. In this example, SSCD control device 1122 can adjust the control information for arrays 700-A to 700-C of subpack ABC (e.g., by increasing a modulation index for arrays 700-A to 700-C) to output more energy. Similarly, SSCD control device 1122 can adjust the control information for subpack UVW (e.g., by decreasing a modulation index for arrays 700-U to 700-W) to cause arrays 700-U to 700-W to output less energy.

In another example, if the SOC of array 700-A is lower than the SOC of each other array 700-B to 700-W, SSCD control device 1122 can reduce the amount of energy output by arrays 700-A to 700-C of subpack ABC. To do this, SSCD control device 1122 can adjust the external control information to decrease the modulation indexes for arrays 700-A to 700-C of subpack ABC, and increase the modulation indexes for arrays 700-U to 700-W of subpack UVW.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, the AC signals generated by arrays 700-A to 700-C and arrays 700-U to 700-W are provided to motor 101-1.

In addition, the AC signals generated by arrays 700-A to 700-C and/or the AC signals generated by arrays 700-U to 700-W are provided to SSCD 1120 by way of cable 1134. SSCD 1120 converts the AC signals to a DC signal and outputs the DC signal onto DC power bus 1136 to power auxiliary loads 301.

FIGS. 15G-15I illustrate example techniques for controlling components of the example embodiments of system 100 shown in FIGS. 15A and 15C for providing and regulating AC power to a two motors 101-1 and 101-2 of an EV and for providing and regulating DC power to auxiliary load(s) 301.

FIG. 15G is a diagram of an example equivalent rectifier circuit 1580 during two-motor control and FIG. 15H is a diagram of an example equivalent module pack configuration 1583 during two-motor control. In this example, equivalent rectifier circuit 1580 is the same as equivalent rectifier circuit 1580 of FIG. 15D. Equivalent module pack configuration 1583 differs from equivalent module pack configuration 1581 as arrays 700-U to 700-W are coupled to motor 101-2 rather than motor 101-1.

FIG. 15I is a diagram of an example control scheme for two-motor control. The control scheme is similar that of FIG. 14I, but differs based on the configuration of SSCD 1120.

As described with reference to FIG. 14I, external motor control device 104-1 is configured to generate and provide external control information for arrays 700-A to 700-C to SSCD control device 1122 over communication path or link 1135-1. Similarly, external motor control device 104-2 is configured to generate and provide external control information for arrays 700-U to 700-W to SSCD control device 1122 over communication path or link 1135-2.

SSCD control device 1122 is configured to process the external control information from each motor control device 104-1 and 104-2 and generate processed control information for subpack ABC and subpack UVW based on a voltage reference for SSCD 1120 (e.g., a reference for the output DC signal), SSCD feedback signals received from SSCD 1120 over communication path or link 1132 and/or module feedback signals received from control system 102 of module pack 1110 over communication path or link 1133. The processed control information for a subpack ABC or UVW can include a modulation index for each phase for that subpack ABC or UVW or a modulated reference signal for each phase of that subpack ABC or UVW. Thus, the processed control information for a subpack ABC or UVW can include a modulation index or modulated reference signal for each array 700 in the subpack ABC or UVW.

The SSCD feedback signals can include, for example, sensed voltages and/or currents of SSCD 1120. For example, the SSCD feedback signals can include voltage level V_{c} across capacitor C and/or current I_{L} through inductor L.

In this example, the module feedback signals can include, for example, one or more operating characteristics of each array 700-A to 700-W, which are designated as OC_{A} to OC_{W} in FIG. 15I. As described above, the operating characteristics can include, for example, aggregated values of SOC, SOH, temperature, voltage, current, SOP, and/or SOE of arrays 700-A to 700-W.

Processing the control information can include adjusting the control information, e.g., adjusting the modulation index for one or more phases and/or the modulation reference signal for one or more phases. SSCD control device 1122 can adjust the control information to regulate the DC signal output by SSCD 1120 to auxiliary load(s) 301. For example, SSCD control device 1122 can adjust the control information to regulate the voltage level and/or current level of the DC signal output onto DC power bus 1136.

To regulate the voltage level of the output DC signal, SSCD control device 1122 can regulate voltage level V_{c}, across capacitor C as the voltage level of the output DC signal is the same as this voltage level.

SSCD control device 1122 can regulate V_{c} by adjusting the external control information for one or both subpacks ABC and UVW to increase or decrease the amount of energy being transferred from module pack 1110 to capacitor C. For example, if the voltage level of the output DC signal is less than a reference voltage for the output DC signal, SSCD control device 1122 can adjust the external control information one or both subpacks ABC and UVW to increase the amount of energy being transferred from module pack 1110 to capacitor C. If the voltage level of the output DC signal is greater than a reference voltage for the output DC signal, SSCD control device 1122 can adjust the external control information one or both subpacks ABC and UVW to decrease the amount of energy being transferred from module pack 1110 to capacitors C.

If SSCD control device 1122 determines to adjust the external control information one or both subpacks ABC and UVW to increase or decrease the amount of energy being transferred to capacitor C, SSCD control device 122 can adjust the modulation index and/or modulated reference signal for all three phases of the subpack(s) in the same manner, e.g., by increasing or decreasing the values by the same amount, or in different manners for balancing purposes.

Similar to the single motor control described with reference to FIG. 14F, SSCD control device 1122 can also perform multiphase balancing techniques to balance one or more aggregated operating characteristics of subpack ABC with one or more aggregated operating characteristics of subpack UVW. To avoid affecting operation of motors 101-1 and 101-2 in performing this balancing, SSCD control device 1122 can be configured to make the same adjustment to the control information for each phase of a subpack ABC of UVW to adjust the common mode voltage of the AC signal provided to motor 101-1 or motor 101-2.

SSCD control device 1122 provides the processed control information to control system 102 of module pack 1110. As described above, control system 102 can include one or more MCDs 112, LCDs 114, and an array controller 900 for each array 700 or controller 950 for multiple arrays 700, e.g., for all arrays 700 of module pack 1110 or a controller 950 for each segment. In this embodiment, control system 102 can include an array controller 900 for each array 700-A to 700-W.

Array controller 900 for an array 700 can perform intraphase balancing techniques to balance one or more operating characteristics of modules 108 in the array 700. Controller 900 for an array 700 can receive the processed control information for that array 700 (e.g., a processed modulation index for that array 700) and generate, based on the processed control information and the one or more operating characteristics of each module in the array 700, a modulation index for each module 108 of the array 700, as described herein. For example, controller 900 for array 700-A can receive the processed modulation index for array 700-A and adjust the processed modulation index for each module 108 in array 700-A to balance one or more operating characteristics of modules 108 in array 700-A.

As described herein, MCD 112 can provide the modulation indexes and reference signals or modulated reference signals for modules 108 of an array 700 to LCDs 114 that control the modules 108 to generate an AC signal output by the array 700. Here, the AC signals generated by arrays 700-A to 700-C are provided to motor 101-1 and AC signals generated by arrays 700-U to 700-W are provided to motor 101-2.

In addition, the AC signals generated by arrays 700-A to 700-C and the AC signals generated by arrays 700-U to 700-W are provided to SSCD 1120 by way of cable 1134. SSCD 1120 converts the AC signals to a DC signal and outputs the DC signal onto DC power bus 1136 to power auxiliary loads 301.

Control system 102 and/or SSCD control device 1122 can be configured to control charging of energy sources 206 of modules 108 of module pack 1110 while providing DC power to auxiliary load(s) 301 in both single motor and two-motor embodiments.

FIGS. 15J and 15K illustrate example techniques for controlling components of the example embodiments of system 100 shown in FIGS. 15A-15C for charging energy sources 206 in both single motor and two-motor embodiments. FIG. 15J is a diagram of an example equivalent rectifier circuit 1580 during charging in single motor and two-motor embodiments. FIG. 15K is a diagram of an example equivalent module pack configuration 1584 during charging in single motor and two-motor embodiments.

In this example, the equivalent circuits are the same for both single motor and two-motor charging. In addition, equivalent rectifier circuit 1580 is the same as equivalent rectifier circuits 1580 of FIGS. 15D and 15G.

To charge energy sources 206 of arrays 700 of module pack 1110, control system 102 can couple charge source 150 to arrays 700 of module pack 1110 to route a charge signal to energy sources 206 of arrays 700. To do so, control system 102 can open switches SA1, SB1, and SC1 to isolate module pack 1110 and charge source 150 from motor 101-1. Control system 102 can also open switches SU1, SV1, and SW1 to isolate module pack 1110 and charge source 150 from motor 101-1 or motor 101-2 (depending on whether a single motor or two-motor embodiment).

Control system 102 can close switches SA2, SB2, SC2, SU2, SV2, and SW2 to enable charge signals to reach arrays 700-A to 700-W from charge source 150. When DC charging using a DC charge source 150, control system 102 can close switches SCH2, SCH3, and SCH5-SCH8 to couple DC charge source 150 to arrays 700-A to 700-W and to SSCD 1120 by way of cable 1134 and ports A-C and U-W.

For DC charging, this switch configuration results in equivalent rectifier circuit 1580 and equivalent module pack configuration 1584 where the DC charge signal is provided to arrays 700-A to 700-W and to diode segments DSU to DSW and DSA to DSC. The positive DC charge signal can be provided to arrays 700-A to 700-C and the negative DC charge signal can be provided to arrays 700-U to 700-W.

During charging, SSCD controller 1122 can be bypassed as the DC voltage is constructed naturally from the DC charge signal coupled to SSCD 1120. The positive DC charge signal is passed through ports A to C of connector 1310-1 to diode segments DA to DC and the negative DC charge signal is passed through ports U to W of connector to diode segments DU to DW. The DC charge signal charges capacitor C to the DC charge signal. The output DC signal of SSCD 1120 provided to DC power bus 1136 can be the same as the DC charge signal.

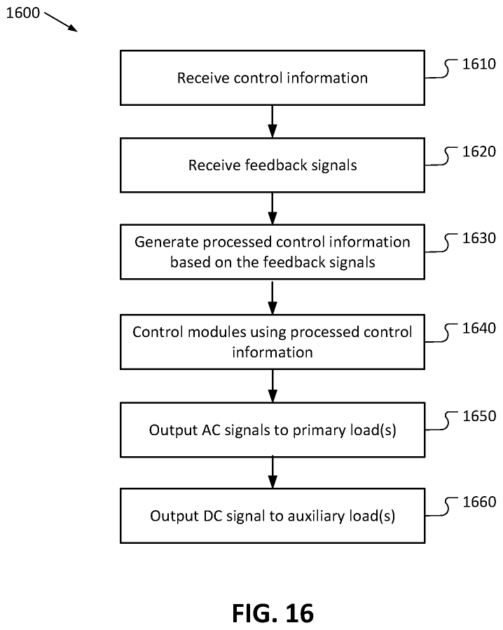

FIG. 16 is a flow diagram depicting an example embodiment of a method 1600 for providing power to one or more primary load(s) 101 and one or more auxiliary loads 301. The method 1600 can be performed by any embodiment of system 100 having a module pack 1110 and SSCD 1120 described herein. Each primary load 101 can be AC load that is powered by an AC signal and each auxiliary load 301 can be a DC load powered by a DC signal

At step 1610, SSCD control device 1122 receives control information. SSCD control device 1122 can receive control information from an external control device 104, such as from a motor control device 104. The control information can include, for example, a modulation index for each phase of AC signal being provided to load(s) 101, a modulated reference signal for each phase, a modulation index and reference signal for each phase, or other control information.

At step 1620, SSCD control device 1122 receives feedback signals. SSCD control device 1122 can receive feedback signals from SSCD 1120 and/or module pack 1110. The feedback signals received from SSCD 1120 can feedback signals related to the DC signal being provided to load(s) 301. For example, these feedback signals can include one or more capacitor voltage measurements across one or more capacitors of SSCD 1120 and/or one or more currents measurements along one or more DC lines of SSCD 1120. The capacitor voltage measurements can include V_{c,u} and V_{c,1} (e.g., in embodiments of FIGS. 13A-14K) or V_{c} (e.g., in embodiments of FIGS. 15A-15K). The current measurements can include I_{L,u} and I_{L,1} (e.g., in embodiments of FIGS. 13A-14K) or I_{L} (e.g., in embodiments of FIGS. 15A-15K).

The feedback signals from module pack 1110 can include operating characteristics for modules 108, arrays 700-A to 700-W, and/or subpacks of arrays 700 (e.g., multiphase subpacks ABC and UVW and/or segment subpacks AU, BV, and CW). The operating characteristics can include, for example, SOC, SOH, temperature, voltage, current, SOP, and/or SOE of each module 108, array 700-A to 700-W and/or subpack. As described herein, the operating characteristics for arrays 700-A to 700-W and subpacks can include aggregated values of the operating characteristics.

The level of aggregation and/or types of operating characteristics can differ for different embodiments and can vary based on the types of balancing techniques used, if any, in those embodiments. For example, the module feedback signals in some embodiments can include aggregated values for subpacks ABC and UVW. In some embodiments, the module feedback signals can include aggregated values for some or all arrays 700-A to 700-W in module pack 1110. In some embodiments, the module feedback signals can include values of operating characteristics of individual modules 108 of module pack 1110. SSCD control device 1122 can be configured to aggregate values as appropriate for balancing techniques performed by SSCD control device 1122.

At step 1630, SSCD control device 1122 generates processed control information based on the feedback signals. SSCD control device 1122 can generate the processed control information to regulate the DC signal that is output by SSCD 1120. In some embodiments, SSCD control device 1122 can also generate the processed control information to balance one or more operating characteristics of modules 108, arrays 700-A to 700-W, and/or subpacks (e.g., multiphase subpacks ABC and UVW and/or segment subpacks AU, BV, and CW).

To regulate the output DC signal, SSCD control device 1122 can compare the voltage measurement(s) received from SSCD to corresponding reference(s). The reference(s) can be based on the target voltage level of the output DC signal. For example, SSCD control device 1122 can compare voltages V_{c,u} and V_{c,1} to corresponding references and/or compare the sum of voltages V_{c,u} and V_{c,1} to a reference. If the reference is higher than the measurement, SSCD control device 1122 can adjust the control information to cause module pack 1110 to increase the amount of energy output from module pack 1110 to SSCD 1120, e.g., by increasing the modulation index for one or more phases. If the reference is lower than the measurement, SSCD control device 1122 can adjust the control information to cause module pack 1110 to reduce the amount of energy output from module pack 1110 to SSCD 1120, e.g., by reducing the modulation index for one or more phases.

SSCD control device 1122 can be configured to perform one or more balancing techniques depending on the configuration of module pack 1110 and/or SSCD 120, and/or based on the number of load(s) 101 being powered by module pack 1110. In embodiments having two loads 101-1 and 101-2 and in which subpack ABC provides power to load 101-1 and subpack UVW provides power to load 101-2, SSCD control device 1122 can be configured to perform multiphase subpack balancing to balance one or more operating characteristics between multiphase subpacks ABC and UVW.

In multiphase subpack balancing, SSCD control device 1122 can be configured to adjust the control information such that each array 700 of the multiphase subpack outputs the same amount of additional or less energy to adjust the common mode voltage of the AC signal provided by the arrays 700 in the subpack. In this way, the amount of energy output to SSCD 1120 is adjusted without adjusting the amount of energy output to load 101. For example, if multiphase subpack ABC has a higher SOC than subpack UVW, SSCD control device 1122 can decrease the energy output by multiphase subpack UVW to SSCD 1120 (e.g., by decreasing the modulation indexes for arrays 700-U to 700-W) and increase the amount of energy output by multiphase subpack ABC to SSCD 1120 (e.g., by decreasing the modulation indexes for arrays 700-U to 700-W). If the increases are equal across arrays 700-A to 700-B and the decrease s are equal across arrays 700-U to 700-W, then the power provided to loads 101-1 and 101-2 can remain the same while shifting the source of energy to SSCD 1120 and on to auxiliary load(s) 301.

In embodiments having one load 101-1 that is powered in an open-winding configuration such that both subpacks ABC and UVW provides power to load 101-1, SSCD control device 1122 can be configured to perform multiphase balancing techniques to balance one or more operating characteristics between multiphase subpacks ABC and UVW (as described above) and/or segment subpack balancing techniques to balance one or more operating characteristics between segment subpacks AU, BV, and CW.

In segment subpack balancing, SSCD control device 1122 can adjust the amount of energy output by segment subpacks AU, BV, and/or CW to balance their operating characteristic(s). For example, if subpack CW has a the highest temperature and AU has the lowest temperature, SSCD control device 1122 can adjust the control information for subpack CW to reduce the amount of energy output by array 700-C and array 700-W (e.g., equally) and/or increase the amount of energy output by array 700-A and array 700-U (e.g., equally).

In both of these types of subpack balancing, SSCD control device 1122 can adjust the control information for the subpacks in such a way that the appropriate amount of energy is provided to SSCD 1120 to regulate the output DC voltage of SSCD 1120 for auxiliary load(s) 301, but the amount of energy contributed by each subpack differs. For example, if SSCD control device 1122 decreases the amount of energy output by one subpack, SSCD control device 1122 can make up this reduction by increasing the amount of energy output by one or more other subpacks.

At step 1640, control system 102 controls modules 108 of module pack 1110 based on the processed control information. SSCD control device 1122 can provide the processed control information to one or more MCDs 112 of control system 102. For example, control system 102 can include an MCD 112 for the entire module pack 1110, an MCD 112 for each subpack ABC and UVW (or segment subpacks AU, BC, and CW), or an MCD 112 for each array 700-A to 700-W. SSCD control device 1122 can provide the appropriate processed control information to each MCD 112. MCD 112 can generate, based on the processed control information, control information for modules 108 controlled by MCD 112. For example, if there is an MCD 112 for each array 700-A to 700-W, MCD 112 can receive processed control information for its array 700 and generate control information for each module 108 in that array 700.

In some embodiments, MCD 112 can generate the control information using intraphase balancing techniques to balance one or more operating characteristics of modules 108 in an array 700 controlled by MCD 112. For example, if MCD 112 controls modules 108 of array 700-A, MCD 112 can receive control information (e.g., modulation indexes or modulated reference signals) and generate individual modulation indexes or individual modulated reference signals for modules 108 of array 700-A based on the received control information and the operating characteristics of modules 108 in array 700-A.

At step 1650, module pack 1110 outputs AC signals to load(s) 101. As described herein, MCD 112 can provide control information to LCDs 114 that control converters 202 of modules 108 to output energy based on the control information. Each array 700 can be configured to output an AC voltage signal including a superposition of output voltages from modules 108 of that array 700.

At step 1660, SSCD 1120 outputs a DC signal to auxiliary load(s) 301. SSCD 1120 can receive AC signals output by arrays 700-A to 700-C and/or 700-U to 700-W and convert the AC signals to an output DC signal for auxiliary load(s) 301.

### Examples of Reconfigurable Arrays for Charging and Discharging

It can be beneficial to reconfigure the connections between arrays 700 in a module pack 1110 depending on whether the arrays 700 are discharging to power one or more loads 101, 301 or charging. For example, a three-phase load 101, e.g., a three-phase motor 101-1 can be powered using a three Y-connected arrays 700 or segments. These three arrays 700 or segments can be charged in parallel using a charge source 150. However, if the three arrays 700 or segments are coupled in two parallel legs, a higher voltage can be used to charge modules 108 of the arrays 700, resulting in faster charging.

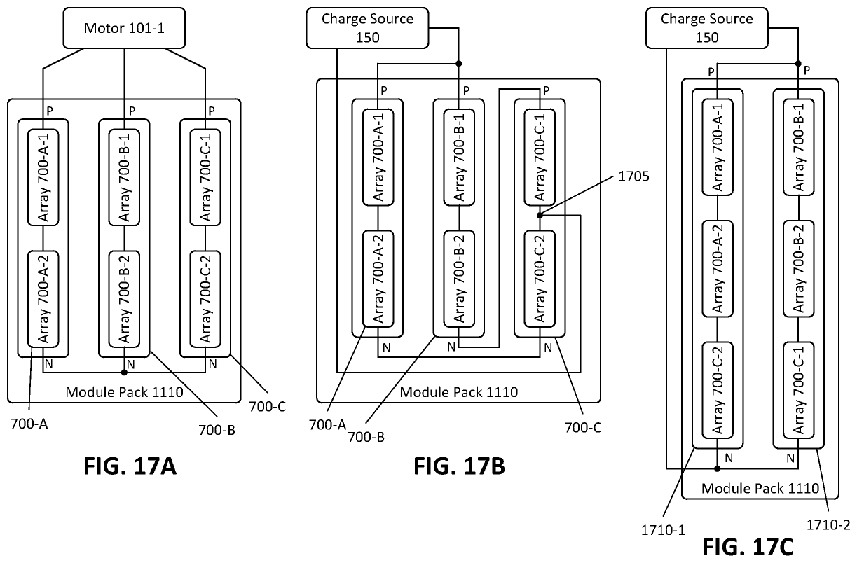

FIGS. 17A-17C are equivalent module pack configurations 1110 during charging and discharging. In particular, FIG. 17A shows a module pack 1110 that includes three arrays 700-A to 700-C that are coupled to motor 101-1 using a Y-connection (e.g., in a Wye configuration) during a discharge mode in which arrays 700-A to 700-C are providing power to motor 101-1. Although a motor 101-1 is shown in this example, other Y-connected loads can be used. Here, the phase port of each array 700-A to 700-C is coupled to motor 101-1 and the neutral ports of each array 700-A to 700-C are coupled together as shown by phase designators “P” and neutral designators “N.”

Each array 700-A to 700-C is shown as having two sub-arrays, e.g., arrays 700-A-1 and 700-A-2, to illustrate a connection within array 700-C (FIG. 17B). However each array 700-A to 700-C can be implemented as a full array 700 in any configuration described herein. For example, each array 700-A to 700-C can include N modules coupled together as shown in FIGS. 7A-7C and described above. Each sub-array of an array 700 can include half of the modules 108 of the array 700. For example, sub-array 700-C-1 can include half of the N modules 108 of array 700-C. In other examples, the number of modules 108 can differ between sub-arrays of an array 700. For example, sub-array 700-C-1 can include ⅓ of the modules 108 of array 700-C and array 700-C-2 can include ⅔ of the modules 108 of array 700-C.

Referring now to FIG. 17B, this figure shows the three arrays 700-A to 700-C of module pack 1110 coupled in a different configuration during a charging mode. In particular, the neutral port of array 700-B is coupled to the phase port of array 700-C, while the neutral ports of arrays 700-A and 700-C are coupled together. Additionally, charge source 150 is coupled to the phase ports of arrays 700-A and 700-B and to a connection point 1705 between sub-arrays 700-C-1 and 700-C-2. For example, a positive terminal of charge source 150 can be coupled to the phase ports of arrays 700-A and 700-B and the neutral terminal of charge source 150 can be coupled to connection point 1705. This results in two parallel charging legs 1710-1 and 1710-2, as shown in FIG. 17C.

Referring to FIG. 17C, charging leg 1710-1 includes both sub-arrays 700-A-1 and 700-A-2 of array 700-A and sub-array 700-C-2 of array 700-C. Charging leg 1710-2 includes both sub-arrays 700-B-1 and 700-B-2 of array 700-B and sub-array 700-C-1 of array 700-C. In this configuration, charging source 150 can charge modules 108 of both charging legs 1710-1 and 1710-2 in parallel. Assuming each array 700-A to 700-C includes the same number of the same modules 108 in both configurations, charging modules 108 using the two parallel charging legs 1710-1 and 1710-2 enables the use of a higher charging voltage, resulting in faster charging. Being able to reconfigure arrays 700 of a module pack 1110 between the charging and discharging configurations shown in FIGS. 17A-17C allows the module pack 1110 to both provide power to Y-connected loads and to charge using higher voltages than would be possible or safe using three parallel arrays 700-A to 700-C.

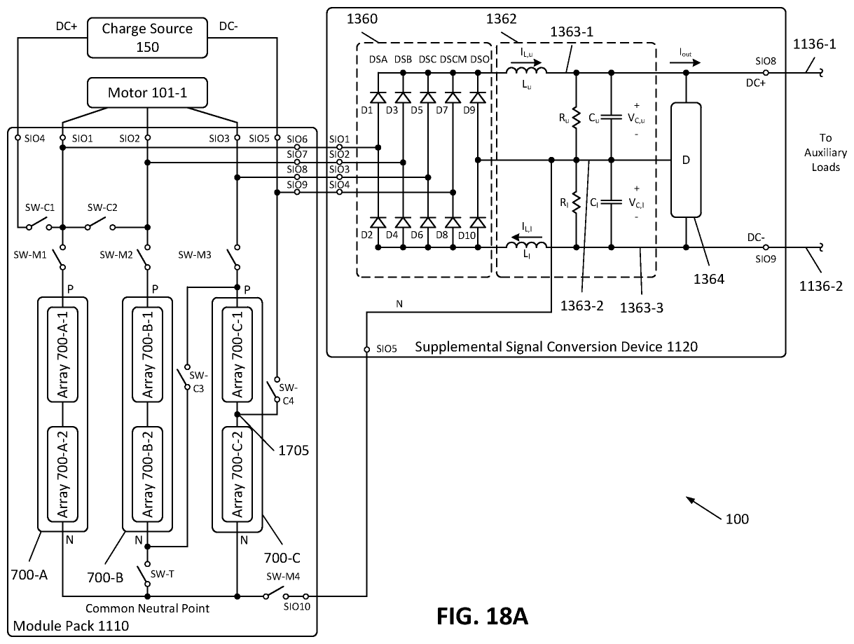

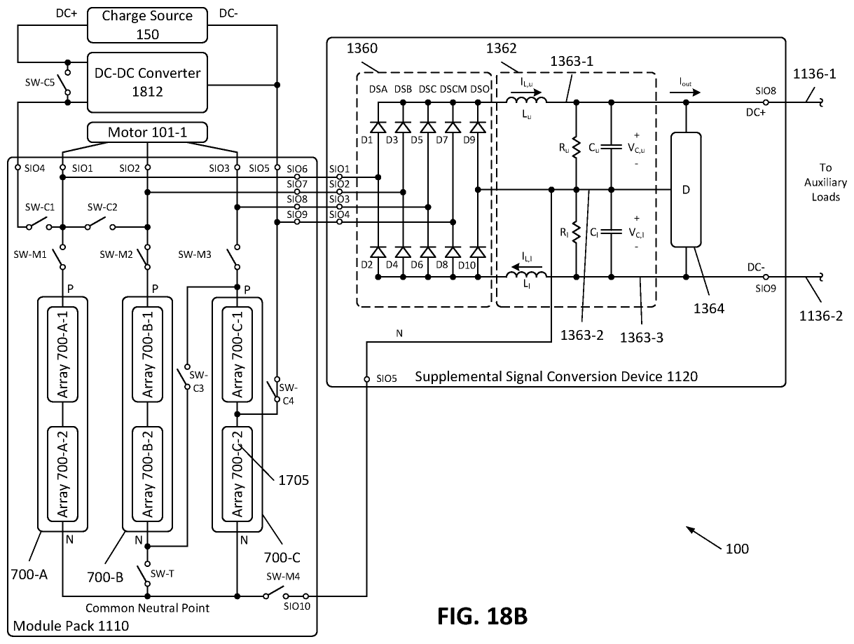

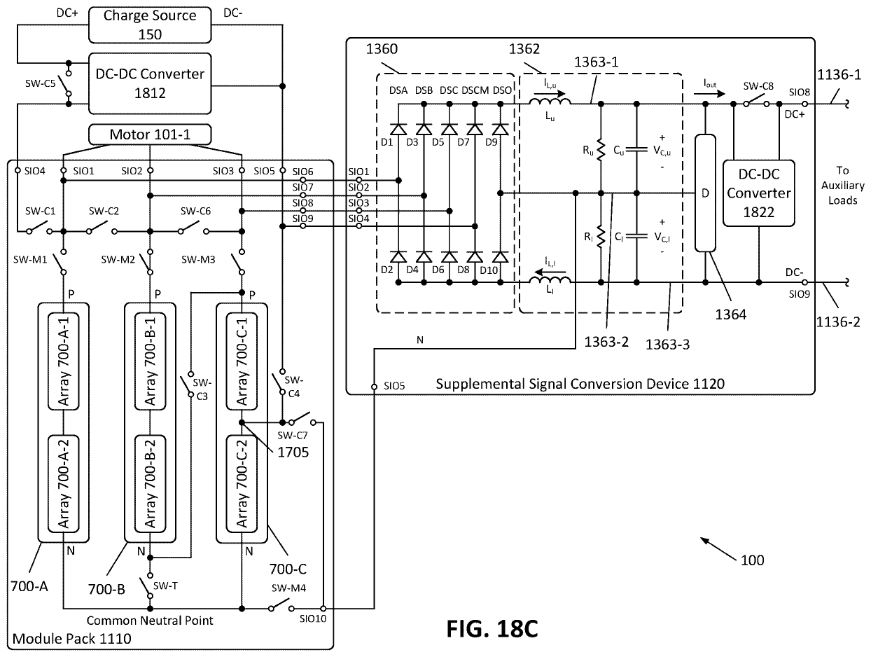

FIGS. 18A-18C are block diagrams of example embodiments of modular energy systems 100 having a module pack 1110 and a SSCD 1120. In particular, FIGS. 18A-18C are example embodiments of modular energy systems 100 with reconfigurable arrays that allow for providing power to Y-connected loads 101 and charging using parallel charging legs, as described above with reference to FIGS. 17A-17C.

Referring to FIG. 18A, system 100 module pack 1110 includes three arrays 700-A to 700-C. Each array 700-A to 700-C are shown as being broken down into two sub-arrays, e.g., array 700-A has sub-arrays 700-A-1 and 700-A-2. Each array 700-A to 700-C is coupled to a motor 101-1 and a charge source 150. In addition, each array 700-A to 700-C is coupled to SSCD 1120.

In particular, the phase ports of arrays 700-A to 700-C are selectively coupled to motor 101-1 via switches SW-M1 to SW-M3 and system I/O ports SIO1 to SIO3, respectively. Charge source 150 is coupled to the phase ports of arrays 700-A and 700-B via switches SW-C1 and SW-C2, respectively, and system I/O port SIO4. In addition, charge source 150 is coupled to connection point 1705 between sub-array 700-C-1 and sub-array 700-C-2 via switch SW-C4 and system I/O port SIO5. The neutral port of array 700-B is selectively coupled to a common neutral point for module pack 1110 via switch SW-T or to the phase port of array 700-C via switch SW-C3. These switches enable arrays 700-A to 700-C to be selectively switched between a first arrangement in which the three arrays 700-A to 700-C provider power to motor 101-1 using a Y-connection, as shown in FIG. 17A, and a second arrangement in which the sub-arrays of each array 700-A to 700-C are coupled together in two charging legs 1710-1 and 1710-2, as shown in FIGS. 17B and 17C. Module pack 1110 also includes a switch SW-M4 that couples the common neutral point of module pack 1110 to intermediate DC line 1363-2 of SSCD 1120 via system I/O port SIO10 of module pack 1110 and system I/O port SIO5 of SSCD 1120.

In particular, control system 102 (e.g., MCD 112) can operate the switches to selectively reconfigure the arrays 700-A and 700-C depending on the mode of operation of system 100. In the charging mode, control system 102 can close switches SW-C1, SW-C2, SW-C3, SW-C4, SW-M1, SW-M2, and SW-M3. Additionally, control system 102 can open switch SW-T disconnecting the neutral port of array 700-B from the common neutral point of module pack 1110. With the switches in this configuration, the phase ports of arrays 700-A and 700-B are coupled to the DC+ port of charge source 150 and connection point 1705 is coupled to the DC− port of charge source 150. Although not shown in this figure, the phase ports of arrays 700-A and 700-B can be coupled to charge source 150 via system I/O port SIO1 of a charge port 1330 (FIG. 13A) and connection point 1705 can be coupled to charge source via system port SIO1 of the charge port 1330. Additionally, the neutral port of array 700-B is coupled to the phase port of array 700-C. This results in the configuration shown in FIGS. 17B and 17C.

In the discharging mode, control system 102 can open switches SW-C1, SW-C2, SW-C3, and SW-C4. Control system 102 can also close switches SW-M1, SW-M2, SW-M3, and SW-T. This disconnects arrays 700-A to 700-C from charge source 150, disconnects the neutral port of array 700-B from the phase port of array 700-C, and connects the neutral port of array 700-B to the common neutral point of module pack 1110. This results in the configuration shown in FIG. 17A.

The SSCD 1120 shown in FIG. 18A can operate in the same or a substantially similar manner as the SSCD 1120 shown in FIG. 14C and described above. Here, the example SSCD 1120 includes four system I/O ports SI01-SIO4 that couple diode segments DSA, DSB, DSC, and DSCM of diode circuit 1360 to module pack 1110. Additionally, SSCD 1120 includes a system I/O port SI05 that couples intermediate DC line 1363-2 of SSCD 1120 to the common neutral point of module pack 1110 via system I/O port SIO8 of module pack 1110.

During charging, charge source 150 can also provide power to auxiliary loads via SSCD 1120. In particular, the DC+ port of charge source 150 is coupled to diode segment segments DSA and DSB via switches SW-C1 and SW-C2, system I/O ports SIO6 and SIO7 of module pack 1110, and system IO ports SIO1 and SIO2 of SSCD 1120. Diodes D1 and D3 pass the positive charge signal output by charge source 150 to DC+ line 1363-1 and on to auxiliary load(s) 301 via DC bus 1136.

The DC− port of charge source 150 is coupled to diode segment DSCM via system I/O port SIO9 of module pack 1110 and system I/O port SIO4 of SSCD 1120. Diode D6 passes the neutral charge signal to DC− line 1363-3 and on to auxiliary load(s) 301 via DC bus 1136.

During discharging, arrays 700-A to 700-C can provide power to motor 101-1 via system I/O ports SIO1 to SIO3 of module pack 1110 and to auxiliary load(s) 301 coupled to SSCD 1120 via system I/O ports SIO6 to SIO8 of module pack 1110 and system I/O ports SIO1 to SIO3 of SSCD 1120. SSC 1120 can convert the AC signals output by arrays 700-A to 700-C to DC power and provide the DC power to auxiliary load(s) 301, as described above with reference to FIG. 14C.

Referring to FIG. 18B, this example embodiment adds a DC-DC converter 1812 and a switch SW-C5 to the embodiment of FIG. 18A. DC-DC converter 1812 enables modules 108 of module pack to be changed using charge sources of different voltage levels by adjusting the voltage level of charge source 150 prior to passing the charge signal to arrays 700-A to 700-B. In one example, module pack 1110 may be configured to charge modules 108 using charge signals of 800 VDC and there may be charge sources 150 that output 400 VDC and charge source 800 VDC. In this example, DC-DC converter 1812 can be configured to convert a 400 VDC charge signal to an 800 VDC charge signal. In another example, arrays 700-A to 700-C may be configured to receive charge signals of 400 VDC and there may be charge sources 150 that output 400 VDC and charge source 800 VDC. In this example, DC-DC converter 1812 can be configured to convert an 800 VDC charge signal to a 400 VDC charge signal. Other voltage levels and corresponding configurations of DC-DC converters can also be used.

DC-DC converter 1812 can be implemented as a unidirectional or bidirectional converter. DC-DC converter 1812 can also be isolated or non-isolated.

Control system 102 can be configured to operate switch SW-C5 depending on the mode of operation of system 100 and depending on the voltage level of the charge signal output by charge source 150. For example, MCD 112 can receive, from an external control device 104 (e.g., a vehicular ECU), data indicating the voltage level of a charge source 150 to which an EV is connected. The MCD 112 can then open or close switch SW-C5 based on the data. For example, if module pack 1110 is configured for 800 VDC charge signals, MCD 112 can close switch SW-C5 to bypass DC-DC converter 1812 when charge source 150 outputs 800 VDC charge signals and to close switch SW-C5 when charge source 150 outputs 400 VDC charge signals. By opening switch SW-C5, DC-DC converter 1812 can also convert the 800 VDC signal to a 400 VDC signal before outputting the 400 VDC signal to arrays 700-A to 700-C.

Referring to FIG. 18C, this example embodiment adds a DC-DC converter 1822 and switches SW-C6 and SE-C7 to the embodiment of FIG. 18B. DC-DC converter 1822 is configured to adjust the output voltage of SSCD 1120 for auxiliary load(s) 301. Although not shown in other embodiments above, any embodiment of SSCD 1120 described herein can include DC-DC converter 1822 arranged in the same or similar manner to adjust the output voltage of SSCD 1120. DC-DC converter 1822 can be configured to increase the voltage level or decrease the voltage level. In some implementations, DC-DC converter 1822 is implemented as a non-isolated, unidirectional DC-DC converter.

During charging, switch SW-C6 can be closed to route the DC+ charge signal to diode segment DSC via system I/O port SIO8 of module pack 1110 and system I/O port SIO3 of SSCD 1120. Switch CD-M3 can be open since switch SW-C3 is closed to couple the phase port of array 700-C to the neutral port of array 700-B. In addition, switch SW-C7 can be closed to route the DC− charge signal to system I/O port SIO10 of module pack 1110 an on to intermediate DC line 1363-2 of SSCD 1120.

Although system I/O ports are shown as coupling module pack 1110 to SSCD 1120 in FIGS. 18A-18C, module pack 1110 can be coupled to SSCD 1120 using a cable 1134 and connectors 1310, as described above. The switches shown in FIGS. 18A to 18C can be implemented as any type of switch, e.g., mechanical switches, relays, contactors, or power semiconductors, unless stated otherwise or logically implausible.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated or taught otherwise.

In many embodiments, a modular energy system comprising includes a plurality of modules connected together in a plurality of arrays. Each array includes a set of modules coupled between a phase port and a neutral port of the array. Each array is configured to output an AC voltage signal comprising a superposition of output voltages from the modules of the array to an AC load. The plurality of arrays include a first array, a second array, and a third array. The energy system includes a first switch that selectively couples the neutral port of the second array to the phase port of third array and a second switch that selectively couples a charge source to a connection point between a first subset of the modules of the third array and a second subset of the modules of the third array.

In some embodiments, each module includes an energy source and switch circuitry controllable to selectively output a positive DC output voltage, zero output voltage, or negative DC output voltage from the energy source.

In some embodiments, the phase port of each array is coupled to the AC load.

In some embodiments, the energy system includes a control system configured to operate the first switch and the second switch based on a mode setting indicating whether the system is in (i) a charging mode in which the charge source charges the modules of each array or (ii) a discharging mode in which the arrays provide AC power to the AC load.

In some embodiments, the control system is configured to close the first switch and the second switch to form two parallel charging legs during the charging mode.

In some embodiments, a first parallel charging leg of the two parallel charging legs includes the first array and the second subset of modules of the third array. A first parallel charging leg of the two parallel charging legs includes the first array and the second subset of modules of the third array.

In some embodiments, the control system is configured to open the first switch and the second switch during the discharging mode.

In some embodiments, the energy system includes a third switch that selectively couples the neutral port of the second array to a common neutral point coupled to the neutral port of the first array and the neutral port of the second array.

In some embodiments, the control system is configured to close the third switch during the discharging mode and open the third switch during the charging mode.

In some embodiments, the energy system includes one or more switches that selectively couple the charge source to the phase port of the first array and the phase port of the second array.

In some embodiments, the control system is configured to close the one or more switches during the charging mode and open the one or more switches during the discharging mode.

In some embodiments, the energy system includes a supplemental signal conversion device coupled to the phase port of each array and configured to convert AC voltage signals output by the arrays to an output DC signal and to provide the output DC signal to supply one or more DC loads.

In some embodiments, the AC load includes one or more electric motors of an electric vehicle and the one or more DC loads include one or more auxiliary loads of the electric vehicle.

In some embodiments, the supplemental signal conversion device includes a rectifier circuit.

In some embodiments, the rectifier circuit includes a plurality of diodes and the phase port of each array is coupled to one or more of the plurality of diodes.

In some embodiments, the phase port of each array is coupled to a respective pair of diodes of the plurality of diodes.

In some embodiments, the rectifier circuit includes a filter circuit.

In some embodiments, the supplemental signal conversion device includes a positive DC line, a negative DC line, and an intermediate DC line. The rectifier circuit includes a first capacitor coupled between the positive DC line and the intermediate DC line and a second capacitor coupled between the negative DC line and the intermediate DC line.

In some embodiments, the positive DC line is coupled to a positive line of a DC power bus coupled to the one or more DC loads and the negative DC line is coupled to a negative line of the DC power bus.

In some embodiments, each pair of diodes is coupled between the positive DC line and the negative DC line.

In some embodiments, the supplemental signal conversion device is configured to regulate a first voltage level across the first capacitor and a second voltage level across the second capacitor.

In some embodiments, the energy system includes a fourth switch that selectively couples a common neutral point of the arrays to the intermediate DC line.

In some embodiments, the energy system includes a fifth switch that selectively couples the connection point between the first subset of the modules of the third array and the second subset of the modules of the third array to one or more diodes of the rectifier circuit.

In some embodiments, the energy system includes a first DC-DC converter coupled between the charge source and the phase ports of the first and second arrays.

In some embodiments, the first DC-DC converter is configured to adjust a voltage level of a DC charge signal received from the charge source and to output he adjusted charge signal to the phase ports of the first and second arrays and to the supplemental signal conversion device.

In some embodiments, the supplemental signal conversion device includes a second DC-DC converter.

In some embodiments, the second DC-DC converter is coupled to the DC bus to adjust a voltage level of a DC signal output on the DC bus.

In some embodiments, the energy system includes a sixth switch that selectively couples the charge source to the phase port of the third array.

In many embodiments, an electric vehicle includes one or more electric motors; and the energy system of any one of the foregoing embodiments where the AC load includes at least one of the one or more motors.

In many embodiments a method includes operating the system of any one of the foregoing embodiments in a charging mode and a discharging mode.

In many embodiments, a method for powering an AC load includes, during a discharging mode, controlling a plurality of modules connected together in a plurality of arrays to output an AC signal to the AC load, wherein each array includes a set of modules coupled between a phase port and a neutral port of the array, wherein each array is configured to output an AC voltage signal comprising a superposition of output voltages from the modules of the array to an AC load, and wherein the plurality of arrays comprise a first array, a second array, and a third array. The method includes opening a first switch that selectively couples the neutral port of the second array to the phase port of third array and opening second switch that selectively couples a charge source to a connection point between a first subset of the modules of the third array and a second subset of the modules of the third array.

In some embodiments, the method includes transitioning from the discharging mode to a charging mode and closing the first switch and the second switch to form two parallel charging legs during the charging mode.

In some embodiments, the method includes closing one or more switches to couple the charge source to the phase ports of the first and second arrays.

In some embodiments, the method includes providing DC power to one or more DC loads by passing a charge signal from the charge source to a supplemental signal conversion device couple to the one or more DC loads.

In some embodiments, the method includes providing DC power to one or more DC loads by passing the AC signal to a supplemental signal conversion device configured to convert the AC signal to a DC signal for powering the one or more DC loads.

The term “module” as used herein refers to one of two or more devices or subsystems within a larger system. The module can be configured to work in conjunction with other modules of similar size, function, and physical arrangement (e.g., location of electrical terminals, connectors, etc.). Modules having the same function and energy source(s) can be configured identical (e.g., size and physical arrangement) to all other modules within the same system (e.g., rack or pack), while modules having different functions or energy source(s) may vary in size and physical arrangement. While each module may be physically removable and replaceable with respect to the other modules of the system (e.g., like wheels on a car, or blades in an information technology (IT) blade server), such is not required. For example, a system may be packaged in a common housing that does not permit the removal and replacement any one module, without the disassembly of the system as a whole. However, any and all embodiments herein can be configured such that each module is removable and replaceable with respect to the other modules in a convenient fashion, such as without disassembly of the system.

The term “output” is used herein in a broad sense, and does not preclude functioning in a bidirectional manner as both an output and an input. Similarly, the term “input” is used herein in a broad sense, and does not preclude functioning in a bidirectional manner as both an input and an output.

The terms “terminal” and “port” are used herein in a broad sense, can be either unidirectional or bidirectional, can be an input or an output, and do not require a specific physical or mechanical structure, such as a female or male configuration.

Processing circuitry can include one or more processors, microprocessors, controllers, and/or microcontrollers, each of which can be a discrete or stand-alone chip or distributed among (or a portion of) a number of different chips. Any type of processing circuitry can be implemented, such as, but not limited to, personal computing architectures (e.g., such as used in desktop PC's, laptops, tablets, etc.), programmable gate array architectures, proprietary architectures, custom architectures, and others. Processing circuitry can include a digital signal processor, which can be implemented in hardware and/or software. Processing circuitry can execute software instructions stored in memory that cause processing circuitry to take a host of different actions and control other components.

Processing circuitry can also perform other software and/or hardware routines. For example, processing circuitry can interface with communication circuitry and perform analog-to-digital conversions, encoding and decoding, other digital signal processing, multimedia functions, conversion of data into a format (e.g., in-phase and quadrature) suitable for provision to communication circuitry, and/or can cause communication circuitry to transmit the data (wired or wirelessly).

Processing circuitry can also be adapted to execute the operating system and any software applications, and perform those other functions not related to the processing of communications transmitted and received.

Computer program instructions for carrying out operations in accordance with the described subject matter may be written in any combination of one or more programming languages, including computer and programming languages. A non-exhaustive list of examples includes hardware description languages (HDLs), SystemC, C, C++, C#, Objective-C, Matlab, Simulink, System Verilog, System VHDL, Handel-C, Python, Java, JavaScript, Ruby, HTML, Smalltalk, Transact-SQL, XML, PHP, Golang (Go), “R” language, and Swift, to name a few.

Memory, storage, and/or computer readable media can be shared by one or more of the various functional units present, or can be distributed amongst two or more of them (e.g., as separate memories present within different chips). Memory can also reside in a separate chip of its own.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory. The terms “non-transitory” and “tangible” as used herein, are intended to describe memory, storage, and/or computer readable media excluding propagating electromagnetic signals, but are not intended to limit the type of memory, storage, and/or computer readable media in terms of the persistency of storage or otherwise. For example, “non-transitory” and/or “tangible” memory, storage, and/or computer readable media encompasses volatile and non-volatile media such as random access media (e.g., RAM, SRAM, DRAM, FRAM, etc.), read-only media (e.g., ROM, PROM, EPROM, EEPROM, flash, etc.) and combinations thereof (e.g., hybrid RAM and ROM, NVRAM, etc.) and variants thereof.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as the antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

As used herein and in the appended claims, the singular forms “a,” “an,” and “the” include plural referents unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A modular energy system comprising:
a plurality of modules connected together in a plurality of arrays, each array comprising a set of modules coupled between a phase port and a neutral port of the array, wherein each array is configured to output an AC voltage signal comprising a superposition of output voltages from the modules of the array to an AC load, the plurality of arrays comprising a first array, a second array, and a third array;
a first switch that selectively couples the neutral port of the second array to the phase port of third array; and
a second switch that selectively couples a charge source to a connection point between a first subset of the modules of the third array and a second subset of the modules of the third array.

2. The system of claim 1, wherein each module comprises an energy source and switch circuitry controllable to selectively output a positive DC output voltage, zero output voltage, or negative DC output voltage from the energy source.

3. The system of claim 1 or 2, wherein the phase port of each array is coupled to the AC load.

4. The system of claim 3, further comprising a control system configured to operate the first switch and the second switch based on a mode setting indicating whether the system is in (i) a charging mode in which the charge source charges the modules of each array or (ii) a discharging mode in which the arrays provide AC power to the AC load.

5. The system of claim 4, wherein the control system is configured to close the first switch and the second switch to form two parallel charging legs during the charging mode.

6. The system of claim 5, wherein a first parallel charging leg of the two parallel charging legs comprises the first array and the second subset of modules of the third array, and wherein a first parallel charging leg of the two parallel charging legs comprises the first array and the second subset of modules of the third array.

7. The system of any preceding claim, wherein the control system is configured to open the first switch and the second switch during the discharging mode.

8. The system of any one of claims 4-7, further comprising a third switch that selectively couples the neutral port of the second array to a common neutral point coupled to the neutral port of the first array and the neutral port of the second array.

9. The system of claim 8, wherein the control system is configured to close the third switch during the discharging mode and open the third switch during the charging mode.

10. The system of any one of claims 4-9, further comprising one or more switches that selectively couple the charge source to the phase port of the first array and the phase port of the second array.

11. The system of claim 10, wherein the control system is configured to close the one or more switches during the charging mode and open the one or more switches during the discharging mode.

12. The system of any preceding claim, further comprising a supplemental signal conversion device coupled to the phase port of each array and configured to convert AC voltage signals output by the arrays to an output DC signal and to provide the output DC signal to supply one or more DC loads.

13. The system of claim 12, wherein the AC load comprises one or more electric motors of an electric vehicle and the one or more DC loads comprise one or more auxiliary loads of the electric vehicle.

14. The system of claim 12 or 13, wherein the supplemental signal conversion device comprises a rectifier circuit.

15. The system of claim 14, wherein the rectifier circuit comprises a plurality of diodes and the phase port of each array is coupled to one or more of the plurality of diodes.

16. The system of claim 15, wherein the phase port of each array is coupled to a respective pair of diodes of the plurality of diodes.

17. The system of any one of claims 12-16, wherein the rectifier circuit comprises a filter circuit.

18. The system of any one of claims 12-17, wherein the supplemental signal conversion device comprises a positive DC line, a negative DC line, and an intermediate DC line, and wherein the rectifier circuit comprises a first capacitor coupled between the positive DC line and the intermediate DC line and a second capacitor coupled between the negative DC line and the intermediate DC line.

19. The system of claim 18, wherein the positive DC line is coupled to a positive line of a DC power bus coupled to the one or more DC loads and the negative DC line is coupled to a negative line of the DC power bus.

20. The system of claim 19 when claim 19 depends on claim 16, wherein each pair of diodes is coupled between the positive DC line and the negative DC line.

21. The system of claim 19 or 20, wherein the supplemental signal conversion device is configured to regulate a first voltage level across the first capacitor and a second voltage level across the second capacitor.

22. The system of any one of claims 19-21, further comprising fourth switch that selectively couples a common neutral point of the arrays to the intermediate DC line.

23. The system of any one of claims 14-22, further comprising a fifth switch that selectively couples the connection point between the first subset of the modules of the third array and the second subset of the modules of the third array to one or more diodes of the rectifier circuit.

24. The system of any one of claims 12-23, further comprising a first DC-DC converter coupled between the charge source and the phase ports of the first and second arrays.

25. The system of claim 24, wherein the first DC-DC converter is configured to adjust a voltage level of a DC charge signal received from the charge source and to output he adjusted charge signal to the phase ports of the first and second arrays and to the supplemental signal conversion device.

26. The system of claim 24 or 25, wherein the supplemental signal conversion device comprises a second DC-DC converter.

27. The system of claim 26 when claim 26 depends on claim 19, wherein the second DC-DC converter is coupled to the DC bus to adjust a voltage level of a DC signal output on the DC bus.

28. The system of claim 26 or 27, further comprising a sixth switch that selectively couples the charge source to the phase port of the third array.

29. An electric vehicle, comprising
one or more electric motors; and
the energy system of any one of claims 1-28, wherein the AC load comprises at least one of the one or more motors.

30. A method comprising operating the system of any one of claims 1-28 in a charging mode and a discharging mode.

31. A method for powering an AC load, the method comprising:
during a discharging mode, controlling a plurality of modules connected together in a plurality of arrays to output an AC signal to the AC load, wherein each array comprises a set of modules coupled between a phase port and a neutral port of the array, wherein each array is configured to output an AC voltage signal comprising a superposition of output voltages from the modules of the array to an AC load, and wherein the plurality of arrays comprise a first array, a second array, and a third array;
opening a first switch that selectively couples the neutral port of the second array to the phase port of third array; and
opening second switch that selectively couples a charge source to a connection point between a first subset of the modules of the third array and a second subset of the modules of the third array.

32. The method of claim 30, further comprising:
transitioning from the discharging mode to a charging mode; and
closing the first switch and the second switch to form two parallel charging legs during the charging mode.

33. The method of claim 31, further comprising closing one or more switches to couple the charge source to the phase ports of the first and second arrays.

34. The method of claim 31 or 32, further comprising providing DC power to one or more DC loads by passing a charge signal from the charge source to a supplemental signal conversion device couple to the one or more DC loads.

35. The method of claim 30, further comprising providing DC power to one or more DC loads by passing the AC signal to a supplemental signal conversion device configured to convert the AC signal to a DC signal for powering the one or more DC loads.
